(19) United States
(12) Patent Application Publication
(10) Pub. No.: US 2026/0313700 A1
(43) Pub. Date: Oct. 8, 2026

(54) METHOD AND DEVICE FOR RANDOM ACCESS PROCEDURE

(71) Applicant: LG ELECTRONICS INC., Seoul (KR)

(72) Inventors: Seokmin SHIN, Seoul (KR); Youngdae LEE, Seoul (KR); Hyunsoo KO, Seoul (KR); Suckchel YANG, Seoul (KR)

(73) Assignee: LG ELECTRONICS INC., Seoul (KR)

(21) Appl. No.: 19/482,509

(22) PCT Filed: Apr. 25, 2024
(86) PCT No.: PCT/KR2024/005594

§ 371 Date: Nov. 7, 2025

(30) Foreign Application Priority Data
May 11, 2023 (KR) 10-2023-0061119

(51) Int. Cl. H04W 74/0833; H04L 27/26; H04W 72/0453

(52) U.S. Cl. CPC H04W 74/0833; H04L 27/2602; H04W 72/0453

(57) ABSTRACT

A method according to one embodiment of the present disclosure comprises the steps of: receiving a RACH configuration; and transmitting a random access preamble on the basis of an RA-RNTI. The RA-RNTI is determined on the basis of i) a first index related to a time domain of a PRACH occasion and ii) a second index related to a frequency domain of the PRACH occasion. The RACH configuration is based on an additional RACH configuration. The first index or the second index is determined on the basis of the additional RACH configuration.

### 1. SUMMARY OF INVENTION

The present disclosure is to propose a method for repeating a PRACH preamble for coverage enhancement in NR and an RA-RNTI collision handling method for the same.

### 2. BACKGROUND AND PRIOR ARTS IN THE SAME FIELD OF THE INVENTION

### <3GPP LTE, 5G Specification>

TS36.101, TS36.211, TS36.212, TS36.213, TS36.214, TS36.321, TS36.331, TS37.213
TS38.101, TS38.211, TS38.212, TS38.213, TS38.214, TS38.215, TS38.321, TS38.331

### [NR]

As larger communication capacities are required for more communication devices, there is a need for mobile broadband communication improved in comparison to the existing radio access technology. Further, massive MTC (Machine Type Communication) that provides various services anytime anywhere by connecting several devices and objects is one of issues that should be considered in the next generation communication. Further, a communication system design considering service/UE that is sensitive to reliability and latency is discussed. As described above, introduction of a next generation radio access technology considering enhanced mobile broadband communication, massive MTC, URLLC (Ultra-Reliable and Low Latency Communication) is discussed, and the technology is referred to as a NR for the convenience in the present invention.

### [Frame Structure for NR]

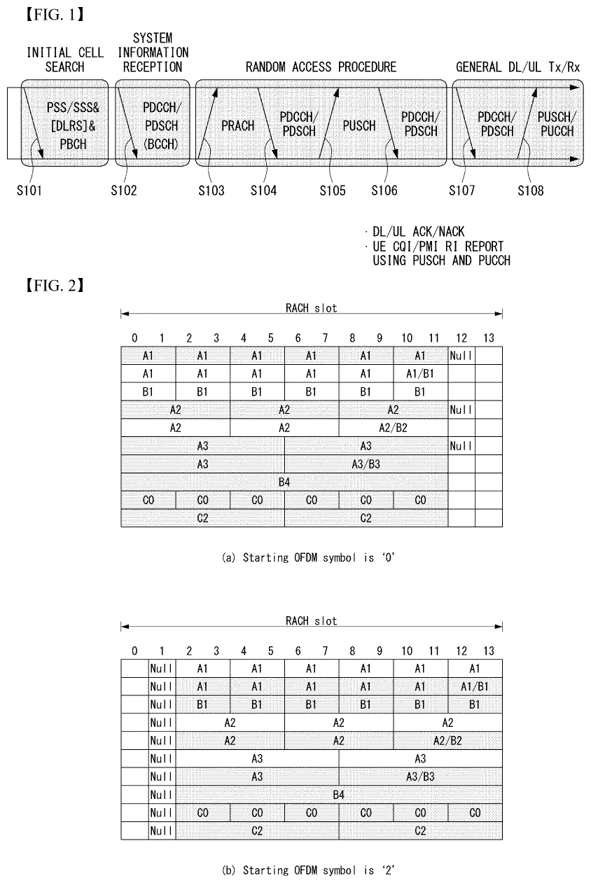

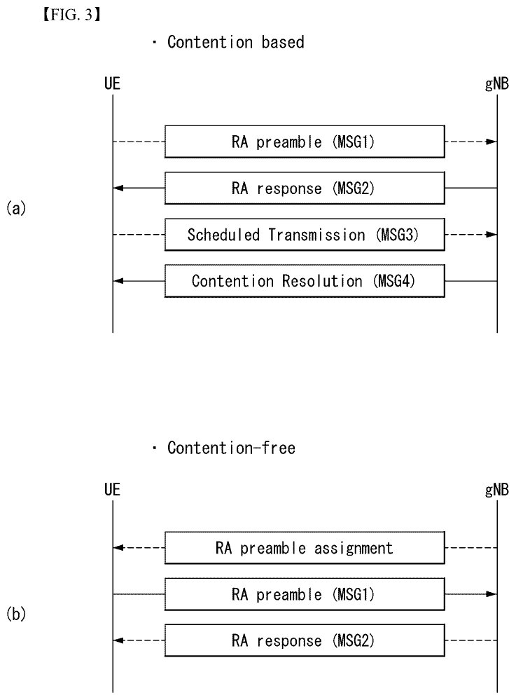

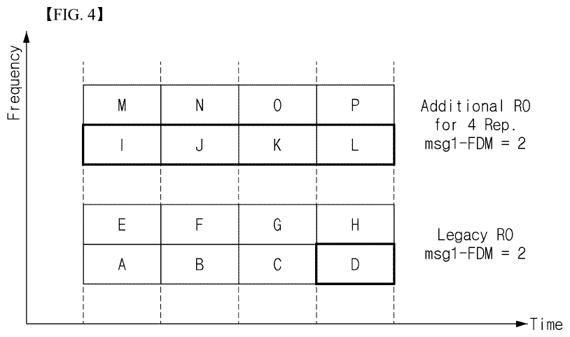

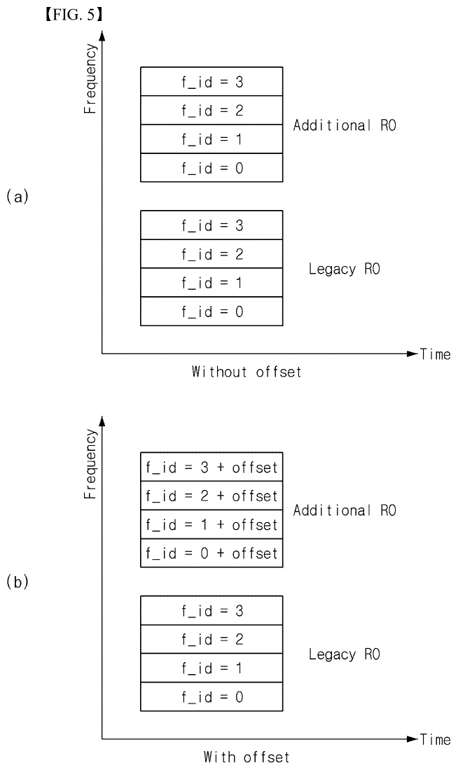

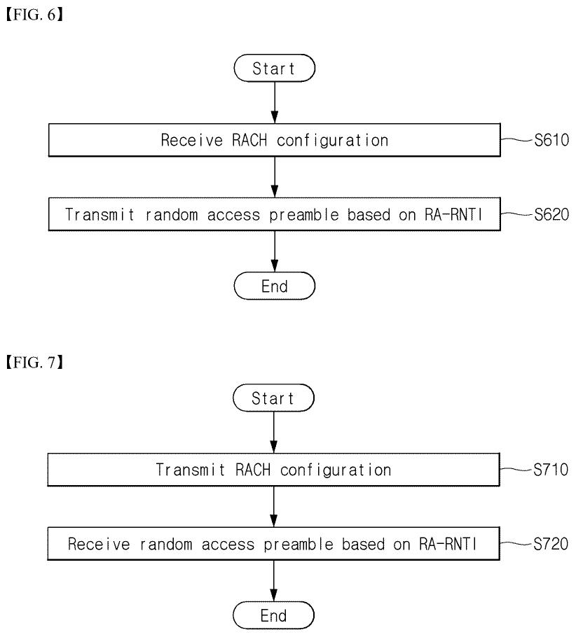

As illustrated in FIG. 2-1, a frame structure of NR is characterized by a self-contained structure in which all of DL control channel, DL or UL data, UL control channel, etc. can be included in one slot. In this instance, DL data scheduling information, UL data scheduling information, etc. may be transmitted on the DL control channel, and ACK/NACK information for DL data, CSI information (modulation and coding scheme information, MIMO transmission related information, etc.), scheduling request, etc. may be transmitted on the UL control channel. In FIG. 2-1, a time gap for DL-to-UL or UL-to-DL switching may exist between a control region and a data region. Further, a part of the DL control channel/DL data/UL data/UL control channel may not be configured within one slot. Alternatively, order of the channels constituting one slot may vary (e.g., DL control/DL data/UL control/UL data or UL control/UL data/DL control/DL data, etc.).

### DISCLOSURE OF INVENTION

The following technology may be used in various radio access system including CDMA, FDMA, TDMA, OFDMA, SC-FDMA, and the like. The CDMA may be implemented as radio technology such as Universal Terrestrial Radio Access (UTRA) or CDMA2000. The TDMA may be implemented as radio technology such as a global system for mobile communications (GSM)/general packet radio service (GPRS)/enhanced data rates for GSM evolution (EDGE). The OFDMA may be implemented as radio technology such as Institute of Electrical and Electronics Engineers (IEEE) 802.11 (Wi-Fi), IEEE 802.16 (WiMAX), IEEE 802.20, Evolved UTRA (E-UTRA), or the like. The UTRA is a part of Universal Mobile Telecommunications System (UMTS). 3rd Generation Partnership Project (3GPP) Long Term Evolution (LTE) is a part of Evolved UMTS (E-UMTS) using the E-UTRA and LTE-Advanced (A)/LTE-A pro is an evolved version of the 3GPP LTE. 3GPP NR (New Radio or New Radio Access Technology) is an evolved version of the 3GPP LTE/LTE-A/LTE-A pro.

For clarity of description, the technical spirit of the present disclosure is described based on the 3GPP communication system (e.g., LTE-A or NR), but the technical spirit of the present disclosure are not limited thereto. LTE means technology after 3GPP TS 36.xxx Release 8. In detail, LTE technology after 3GPP TS 36.xxx Release 10 is referred to as the LTE-A and LTE technology after 3GPP TS 36.xxx Release 13 is referred to as the LTE-A pro. The 3GPP NR means technology after TS 38.xxx Release 15. The LTE/NR may be referred to as a 3GPP system. “xxx” means a detailed standard document number. The LTE/NR may be collectively referred to as the 3GPP system. Matters disclosed in a standard document opened before the present disclosure may be referred to for a background art, terms, omissions, etc., used for describing the present disclosure. For example, the following documents may be referred to.

### 3GPP LTE

36.211: Physical channels and modulation
36.212: Multiplexing and channel coding
36.213: Physical layer procedures
36.300: Overall description
36.331: Radio Resource Control (RRC)

### 3GPP NR

38.211: Physical channels and modulation
38.212: Multiplexing and channel coding
38.213: Physical layer procedures for control
38.214: Physical layer procedures for data
38.300: NR and NG-RAN Overall Description
38.331: Radio Resource Control (RRC) protocol specification

Three major requirement areas of 5G include (1) an enhanced mobile broadband (eMBB) area, (2) a massive machine type communication (mMTC) area and (3) an ultra-reliable and low latency communications (URLLC) area.

FIG. 0 is a diagram showing an example of a 5G scenario to which the present invention can be applied.

Some use cases may require multiple areas for optimization, and other use case may be focused on only one key performance indicator (KPI). 5G support such various use cases in a flexible and reliable manner.

eMBB is far above basic mobile Internet access and covers media and entertainment applications in abundant bidirectional tasks, cloud or augmented reality. Data is one of key motive powers of 5G, and dedicated voice services may not be first seen in the 5G era. In 5G, it is expected that voice will be processed as an application program using a data connection simply provided by a communication system. Major causes for an increased traffic volume include an increase in the content size and an increase in the number of applications that require a high data transfer rate. Streaming service (audio and video), dialogue type video and mobile Internet connections will be used more widely as more devices are connected to the Internet. Such many application programs require connectivity always turned on in order to push real-time information and notification to a user. A cloud storage and application suddenly increases in the mobile communication platform, and this may be applied to both business and entertainment. Furthermore, cloud storage is a special use case that tows the growth of an uplink data transfer rate. 5G is also used for remote business of cloud. When a tactile interface is used, further lower end-to-end latency is required to maintain excellent user experiences. Entertainment, for example, cloud game and video streaming are other key elements which increase a need for the mobile broadband ability. Entertainment is essential in the smartphone and tablet anywhere including high mobility environments, such as a train, a vehicle and an airplane. Another use case is augmented reality and information search for entertainment. In this case, augmented reality requires very low latency and an instant amount of data.

Furthermore, one of the most expected 5G use case relates to a function capable of smoothly connecting embedded sensors in all fields, that is, mMTC. Until 2020, it is expected that potential IoT devices will reach 20.4 billions. The industry IoT is one of areas in which 5G performs major roles enabling smart city, asset tracking, smart utility, agriculture and security infra.

URLLC includes a new service which will change the industry through remote control of major infra and a link having ultra reliability/low available latency, such as a self-driving vehicle. A level of reliability and latency is essential for smart grid control, industry automation, robot engineering, drone control and adjustment.

Multiple use cases are described more specifically.

5G may supplement fiber-to-the-home (FTTH) and cable-based broadband (or DOCSIS) as means for providing a stream evaluated from gigabits per second to several hundreds of mega bits per second. Such fast speed is necessary to deliver TV with resolution of 4K or more (6K, 8K or more) in addition to virtual reality and augmented reality. Virtual reality (VR) and augmented reality (AR) applications include immersive sports games. A specific application program may require a special network configuration. For example, in the case of VR game, in order for game companies to minimize latency, a core server may need to be integrated with the edge network server of a network operator.

An automotive is expected to be an important and new motive power in 5G, along with many use cases for the mobile communication of an automotive. For example, entertainment for a passenger requires a high capacity and a high mobility mobile broadband at the same time. The reason for this is that future users continue to expect a high-quality connection regardless of their location and speed. Another use example of the automotive field is an augmented reality dashboard. The augmented reality dashboard overlaps and displays information, identifying an object in the dark and notifying a driver of the distance and movement of the object, over a thing seen by the driver through a front window. In the future, a wireless module enables communication between automotives, information exchange between an automotive and a supported infrastructure, and information exchange between an automotive and other connected devices (e.g., devices accompanied by a pedestrian). A safety system guides alternative courses of a behavior so that a driver may drive more safely, thereby reducing a danger of an accident. A next step will be a remotely controlled or self-driven vehicle. This requires very reliable, very fast communication between different self-driven vehicles and between an automotive and infra. In the future, a self-driven vehicle may perform all driving activities, and a driver will be focused on things other than traffic, which cannot be identified by an automotive itself. Technical requirements of a self-driven vehicle require ultra-low latency and ultra-high speed reliability so that traffic safety is increased up to a level which cannot be achieved by a person.

A smart city and smart home mentioned as a smart society will be embedded as a high-density radio sensor network. The distributed network of intelligent sensors will identify the cost of a city or home and a condition for energy-efficient maintenance. A similar configuration may be performed for each home. All of a temperature sensor, a window and heating controller, a burglar alarm and home appliances are wirelessly connected. Many of such sensors are typically a low data transfer rate, low energy and a low cost. However, for example, real-time HD video may be required for a specific type of device for surveillance.

The consumption and distribution of energy including heat or gas are highly distributed and thus require automated control of a distributed sensor network. A smart grid collects information, and interconnects such sensors using digital information and a communication technology so that the sensors operate based on the information. The information may include the behaviors of a supplier and consumer, and thus the smart grid may improve the distribution of fuel, such as electricity, in an efficient, reliable, economical, production-sustainable and automated manner. The smart grid may be considered to be another sensor network having small latency.

A health part owns many application programs which reap the benefits of mobile communication. A communication system may support remote treatment providing clinical treatment at a distant place. This helps to reduce a barrier for the distance and may improve access to medical services which are not continuously used at remote farming areas. Furthermore, this is used to save life in important treatment and an emergency condition. A radio sensor network based on mobile communication may provide remote monitoring and sensors for parameters, such as the heart rate and blood pressure.

Radio and mobile communication becomes increasingly important in the industry application field. Wiring requires a high installation and maintenance cost. Accordingly, the possibility that a cable will be replaced with reconfigurable radio links is an attractive opportunity in many industrial fields. However, to achieve the possibility requires that a radio connection operates with latency, reliability and capacity similar to those of the cable and that management is simplified. Low latency and a low error probability is a new requirement for a connection to 5G.

Logistics and freight tracking is an important use case for mobile communication, which enables the tracking inventory and packages anywhere using a location-based information system. The logistics and freight tracking use case typically requires a low data speed, but a wide area and reliable location information.

The present disclosure can be implemented by combining or modifying embodiments described below, so as to meet the above-described requirements of 5G.

The present disclosure will be described in detail below with respect to technical fields described below to which the present disclosure can be applied.

### Artificial Intelligence (AI)

Artificial intelligence means the field in which artificial intelligence or methodology capable of producing artificial intelligence is researched. Machine learning means the field in which various problems handled in the artificial intelligence field are defined and methodology for solving the problems are researched. Machine learning is also defined as an algorithm for improving performance of a task through continuous experiences for the task.

An artificial neural network (ANN) is a model used in machine learning, and is configured with artificial neurons (nodes) forming a network through a combination of synapses, and may mean the entire model having a problem-solving ability. The artificial neural network may be defined by a connection pattern between the neurons of different layers, a learning process of updating a model parameter, and an activation function for generating an output value.

The artificial neural network may include an input layer, an output layer, and optionally one or more hidden layers. Each layer includes one or more neurons. The artificial neural network may include a synapse connecting neurons. In the artificial neural network, each neuron may output a function value of an activation function for input signals, weight, and a bias input through a synapse.

A model parameter means a parameter determined through learning, and includes the weight of a synapse connection and the bias of a neuron. Furthermore, a hyper parameter means a parameter that needs to be configured prior to learning in the machine learning algorithm, and includes a learning rate, the number of times of repetitions, a mini-deployment size, and an initialization function.

An object of learning of the artificial neural network may be considered to determine a model parameter that minimizes a loss function. The loss function may be used as an index for determining an optimal model parameter in the learning process of an artificial neural network.

Machine learning may be classified into supervised learning, unsupervised learning, and reinforcement learning based on a learning method.

Supervised learning means a method of training an artificial neural network in the state in which a label for learning data has been given. The label may mean an answer (or a result value) that must be deduced by an artificial neural network when learning data is input to the artificial neural network. Unsupervised learning may mean a method of training an artificial neural network in the state in which a label for learning data has not been given. Reinforcement learning may mean a learning method in which an agent defined within an environment is trained to select a behavior or behavior sequence that maximizes accumulated compensation in each state.

Machine learning implemented as a deep neural network (DNN) including a plurality of hidden layers, among artificial neural networks, is also called deep learning. Deep learning is part of machine learning. Hereinafter, machine learning is used as a meaning including deep learning.

### Robot

A robot may mean a machine that automatically processes a given task or operates based on an autonomously owned ability. Particularly, a robot having a function for recognizing an environment and autonomously determining and performing an operation may be called an intelligence type robot.

A robot may be classified for industry, medical treatment, home, and military based on its use purpose or field.

A robot includes a driving unit including an actuator or motor, and may perform various physical operations, such as moving a robot joint. Furthermore, a movable robot includes a wheel, a brake, a propeller, etc. in a driving unit, and may run on the ground or fly in the air through the driving unit.

### Self-Driving (Autonomous-Driving)

Self-driving means a technology for autonomous driving. A self-driving vehicle means a vehicle that runs without a user manipulation or by a user's minimum manipulation.

For example, self-driving may include all of a technology for maintaining a driving lane, a technology for automatically controlling speed, such as adaptive cruise control, a technology for automatic driving along a predetermined path, a technology for automatically configuring a path when a destination is set and driving.

A vehicle includes all of a vehicle having only an internal combustion engine, a hybrid vehicle including both an internal combustion engine and an electric motor, and an electric vehicle having only an electric motor, and may include a train, a motorcycle, etc. in addition to the vehicles.

In this case, the self-driving vehicle may be considered to be a robot having a self-driving function.

### Extended Reality (XR)

Extended reality collectively refers to virtual reality (VR), augmented reality (AR), and mixed reality (MR). The VR technology provides an object or background of the real world as a CG image only. The AR technology provides a virtually produced CG image on an actual thing image. The MR technology is a computer graphics technology for mixing and combining virtual objects with the real world and providing them.

The MR technology is similar to the AR technology in that it shows a real object and a virtual object. However, in the AR technology, a virtual object is used in a form to supplement areal object. In contrast, unlike in the AR technology, in the MR technology, a virtual object and a real object are used as the same character.

The XR technology may be applied to a head-mount display (HMD), a head-up display (HUD), a mobile phone, a tablet PC, a laptop, a desktop, TV, and a digital signage. A device to which the XR technology has been applied may be called an XR device.

FIG. 1 illustrates an AI device 100 to which a method proposed by the present specification is applicable.

The AI device 100 may be implemented as a fixed device or mobile device, such as TV, a projector, a mobile phone, a smartphone, a desktop computer, a notebook, a terminal for digital broadcasting, a personal digital assistants (PDA), a portable multimedia player (PMP), a navigator, a tablet PC, a wearable device, a set-top box (STB), a DMB receiver, a radio, a washing machine, a refrigerator, a desktop computer, a digital signage, a robot, and a vehicle.

Referring to FIG. 1, the terminal 100 may include a communication unit 110, an input unit 120, a learning processor 130, a sensing unit 140, an output unit 150, a memory 170 and a processor 180.

The communication unit 110 may transmit and receive data to and from external devices, such as other AI devices 100a to 100er or an AI server 200, using wired and wireless communication technologies. For example, the communication unit 110 may transmit and receive sensor information, a user input, a learning model, and a control signal to and from external devices.

In this case, communication technologies used by the communication unit 110 include a global system for mobile communication (GSM), code division multi access (CDMA), long term evolution (LTE), 5G, a wireless LAN (WLAN), wireless-fidelity (Wi-Fi, Bluetooth™, radio frequency identification (RFID), infrared data association (IrDA), ZigBee, near field communication (NFC), etc.

The input unit 120 may obtain various types of data.

In this case, the input unit 120 may include a camera for an image signal input, a microphone for receiving an audio signal, a user input unit for receiving information from a user, etc. In this case, the camera or the microphone is treated as a sensor, and a signal obtained from the camera or the microphone may be called sensing data or sensor information.

The input unit 120 may obtain learning data for model learning and input data to be used when an output is obtained using a learning model. The input unit 120 may obtain not-processed input data. In this case, the processor 180 or the learning processor 130 may extract an input feature by performing pre-processing on the input data.

The learning processor 130 may be trained by a model configured with an artificial neural network using learning data. In this case, the trained artificial neural network may be called a learning model. The learning model is used to deduce a result value of new input data not learning data. The deduced value may be used as a base for performing a given operation.

In this case, the learning processor 130 may perform AI processing along with the learning processor 240 of the AI server 200.

In this case, the learning processor 130 may include memory integrated or implemented in the AI device 100. Alternatively, the learning processor 130 may be implemented using the memory 170, external memory directly coupled to the AI device 100 or memory maintained in an external device.

The sensing unit 140 may obtain at least one of internal information of the AI device 100, surrounding environment information of the AI device 100, or user information using various sensors.

In this case, sensors included in the sensing unit 140 include a proximity sensor, an illumination sensor, an acceleration sensor, a magnetic sensor, a gyro sensor, an inertia sensor, an RGB sensor, an IR sensor, a fingerprint recognition sensor, an ultrasonic sensor, a photo sensor, a microphone, LIDAR, and a radar.

The output unit 150 may generate an output related to a visual sense, an auditory sense or a tactile sense.

In this case, the output unit 150 may include a display unit for outputting visual information, a speaker for outputting auditory information, and a haptic module for outputting tactile information.

The memory 170 may store data supporting various functions of the AI device 100. For example, the memory 170 may store input data obtained by the input unit 120, learning data, a learning model, a learning history, etc.

The processor 180 may determine at least one executable operation of the AI device 100 based on information, determined or generated using a data analysis algorithm or a machine learning algorithm. Furthermore, the processor 180 may perform the determined operation by controlling elements of the AI device 100.

To this end, the processor 180 may request, search, receive, and use the data of the learning processor 130 or the memory 170, and may control elements of the AI device 100 to execute a predicted operation or an operation determined to be preferred, among the at least one executable operation.

In this case, if association with an external device is necessary to perform the determined operation, the processor 180 may generate a control signal for controlling the corresponding external device and transmit the generated control signal to the corresponding external device.

The processor 180 may obtain intention information for a user input and transmit user requirements based on the obtained intention information.

In this case, the processor 180 may obtain the intention information, corresponding to the user input, using at least one of a speech to text (STT) engine for converting a voice input into a text string or a natural language processing (NLP) engine for obtaining intention information of a natural language.

In this case, at least some of at least one of the STT engine or the NLP engine may be configured as an artificial neural network trained based on a machine learning algorithm. Furthermore, at least one of the STT engine or the NLP engine may have been trained by the learning processor 130, may have been trained by the learning processor 240 of the AI server 200 or may have been trained by distributed processing thereof.

The processor 180 may collect history information including the operation contents of the AI device 100 or the feedback of a user for an operation, may store the history information in the memory 170 or the learning processor 130, or may transmit the history information to an external device, such as the AI server 200. The collected history information may be used to update a learning model.

The processor 18 may control at least some of the elements of the AI device 100 in order to execute an application program stored in the memory 170. Moreover, the processor 180 may combine and drive two or more of the elements included in the AI device 100 in order to execute the application program.

FIG. 2 illustrates the AI server 200 to which a method proposed by the present specification is applicable.

Referring to FIG. 2, the AI server 200 may mean a device which is trained by an artificial neural network using a machine learning algorithm or which uses a trained artificial neural network. In this case, the AI server 200 is configured with a plurality of servers and may perform distributed processing and may be defined as a 5G network. In this case, the AI server 200 may be included as a partial configuration of the AI device 100, and may perform at least some of AI processing.

The AI server 200 may include a communication unit 210, a memory 230, a learning processor 240 and a processor 260.

The communication unit 210 may transmit and receive data to and from an external device, such as the AI device 100.

The memory 230 may include a model storage unit 231. The model storage unit 231 may store a model (or artificial neural network 231a) which is being trained or has been trained through the learning processor 240.

The learning processor 240 may train the artificial neural network 231a using learning data. The learning model may be used in the state in which it has been mounted on the AI server 200 of the artificial neural network or may be mounted on an external device, such as the AI device 100, and used.

The learning model may be implemented as hardware, software or a combination of hardware and software. If some of or the entire learning model is implemented as software, one or more instructions configuring the learning model may be stored in the memory 230.

The processor 260 may deduce a result value of new input data using the learning model, and may generate a response or control command based on the deduced result value.

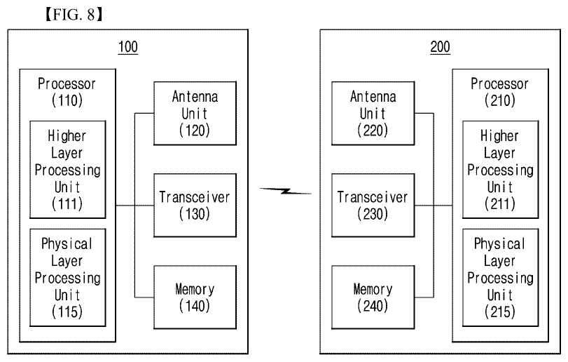

FIG. 3 illustrates an AI system 1 to which a method proposed by the present specification is applicable.

Referring to FIG. 3, the AI system 1 is connected to at least one of the AI server 200, a robot 100a, a self-driving vehicle 100b, an XR device 100c, a smartphone 100d or home appliances 100e over a cloud network 10. In this case, the robot 100a, the self-driving vehicle 100b, the XR device 100c, the smartphone 100d or the home appliances 100e to which the AI technology has been applied may be called AI devices 100a to 100e.

The cloud network 10 may configure part of cloud computing infra or may mean a network present within cloud computing infra. In this case, the cloud network 10 may be configured using the 3G network, the 4G or long term evolution (LTE) network or the 5G network.

That is, the devices 100a to 100e (200) configuring the AI system 1 may be interconnected over the cloud network 10. Particularly, the devices 100a to 100e and 200 may communicate with each other through a base station, but may directly communicate with each other without the intervention of a base station.

The AI server 200 may include a server for performing AI processing and a server for performing calculation on big data.

The AI server 200 is connected to at least one of the robot 100a, the self-driving vehicle 100b, the XR device 100c, the smartphone 100d or the home appliances 100e, that is, AI devices configuring the AI system 1, over the cloud network 10, and may help at least some of the AI processing of the connected AI devices 100a to 100e.

In this case, the AI server 200 may train an artificial neural network based on a machine learning algorithm in place of the AI devices 100a to 100e, may directly store a learning model or may transmit the learning model to the AI devices 100a to 100e.

In this case, the AI server 200 may receive input data from the AI devices 100a to 100e, may deduce a result value of the received input data using the learning model, may generate a response or control command based on the deduced result value, and may transmit the response or control command to the AI devices 100a to 100e.

Alternatively, the AI devices 100a to 100e may directly deduce a result value of input data using a learning model, and may generate a response or control command based on the deduced result value.

Hereinafter, various embodiments of the AI devices 100a to 100e to which the above-described technology is applied are described. In this case, the AI devices 100a to 100e shown in FIG. 3 may be considered to be detailed embodiments of the AI device 100 shown in FIG. 1.

### AI+Robot

An AI technology is applied to the robot 100a, and the robot 100a may be implemented as a guidance robot, a transport robot, a cleaning robot, a wearable robot, an entertainment robot, a pet robot, an unmanned flight robot, etc.

The robot 100a may include a robot control module for controlling an operation. The robot control module may mean a software module or a chip in which a software module has been implemented using hardware.

The robot 100a may obtain state information of the robot 100a, may detect (recognize) a surrounding environment and object, may generate map data, may determine a moving path and a running plan, may determine a response to a user interaction, or may determine an operation using sensor information obtained from various types of sensors.

In this case, the robot 100a may use sensor information obtained by at least one sensor among LIDAR, a radar, and a camera in order to determine the moving path and running plan.

The robot 100a may perform the above operations using a learning model configured with at least one artificial neural network. For example, the robot 100a may recognize a surrounding environment and object using a learning model, and may determine an operation using recognized surrounding environment information or object information. In this case, the learning model may have been directly trained in the robot 100a or may have been trained in an external device, such as the AI server 200.

In this case, the robot 100a may directly generate results using the learning model and perform an operation, but may perform an operation by transmitting sensor information to an external device, such as the AI server 200, and receiving results generated in response thereto.

The robot 100a may determine a moving path and running plan using at least one of map data, object information detected from sensor information, or object information obtained from an external device. The robot 100a may run along the determined moving path and running plan by controlling the driving unit.

The map data may include object identification information for various objects disposed in the space in which the robot 100a moves. For example, the map data may include object identification information for fixed objects, such as a wall and a door, and movable objects, such as a flowport and a desk. Furthermore, the object identification information may include a name, a type, a distance, a location, etc.

Furthermore, the robot 100a may perform an operation or run by controlling the driving unit based on a user's control/interaction. In this case, the robot 100a may obtain intention information of an interaction according to a user's behavior or voice speaking, may determine a response based on the obtained intention information, and may perform an operation.

### AI+Self-Driving

An AI technology is applied to the self-driving vehicle 100b, and the self-driving vehicle 100b may be implemented as a movable type robot, a vehicle, an unmanned flight body, etc.

The self-driving vehicle 100b may include a self-driving control module for controlling a self-driving function. The self-driving control module may mean a software module or a chip in which a software module has been implemented using hardware. The self-driving control module may be included in the self-driving vehicle 100b as an element of the self-driving vehicle 100b, but may be configured as separate hardware outside the self-driving vehicle 100b and connected to the self-driving vehicle 100b.

The self-driving vehicle 100b may obtain state information of the self-driving vehicle 100b, may detect (recognize) a surrounding environment and object, may generate map data, may determine a moving path and running plan, or may determine an operation using sensor information obtained from various types of sensors.

In this case, in order to determine the moving path and running plan, like the robot 100a, the self-driving vehicle 100b may use sensor information obtained from at least one sensor among LIDAR, a radar and a camera.

Particularly, the self-driving vehicle 100b may recognize an environment or object in an area whose view is blocked or an area of a given distance or more by receiving sensor information for the environment or object from external devices, or may directly receive recognized information for the environment or object from external devices.

The self-driving vehicle 100b may perform the above operations using a learning model configured with at least one artificial neural network. For example, the self-driving vehicle 100b may recognize a surrounding environment and object using a learning model, and may determine the flow of running using recognized surrounding environment information or object information. In this case, the learning model may have been directly trained in the self-driving vehicle 100b or may have been trained in an external device, such as the AI server 200.

In this case, the self-driving vehicle 100b may directly generate results using the learning model and perform an operation, but may perform an operation by transmitting sensor information to an external device, such as the AI server 200, and receiving results generated in response thereto.

The self-driving vehicle 100b may determine a moving path and running plan using at least one of map data, object information detected from sensor information or object information obtained from an external device. The self-driving vehicle 100b may run based on the determined moving path and running plan by controlling the driving unit.

The map data may include object identification information for various objects disposed in the space (e.g., road) in which the self-driving vehicle 100b runs. For example, the map data may include object identification information for fixed objects, such as a streetlight, a rock, and a building, etc., and movable objects, such as a vehicle and a pedestrian. Furthermore, the object identification information may include a name, a type, a distance, a location, etc.

Furthermore, the self-driving vehicle 100b may perform an operation or may run by controlling the driving unit based on a user's control/interaction. In this case, the self-driving vehicle 100b may obtain intention information of an interaction according to a user' behavior or voice speaking, may determine a response based on the obtained intention information, and may perform an operation.

### AI+XR

An AI technology is applied to the XR device 100c, and the XR device 100c may be implemented as a head-mount display, a head-up display provided in a vehicle, television, a mobile phone, a smartphone, a computer, a wearable device, home appliances, a digital signage, a vehicle, a fixed type robot or a movable type robot.

The XR device 100c may generate location data and attributes data for three-dimensional points by analyzing three-dimensional point cloud data or image data obtained through various sensors or from an external device, may obtain information on a surrounding space or real object based on the generated location data and attributes data, and may output an XR object by rendering the XR object. For example, the XR device 100c may output an XR object, including additional information for a recognized object, by making the XR object correspond to the corresponding recognized object.

The XR device 100c may perform the above operations using a learning model configured with at least one artificial neural network. For example, the XR device 100c may recognize a real object in three-dimensional point cloud data or image data using a learning model, and may provide information corresponding to the recognized real object. In this case, the learning model may have been directly trained in the XR device 100c or may have been trained in an external device, such as the AI server 200.

In this case, the XR device 100c may directly generate results using a learning model and perform an operation, but may perform an operation by transmitting sensor information to an external device, such as the AI server 200, and receiving results generated in response thereto.

### AI+Robot+Self-Driving

An AI technology and a self-driving technology are applied to the robot 100a, and the robot 100a may be implemented as a guidance robot, a transport robot, a cleaning robot, a wearable robot, an entertainment robot, a pet robot, an unmanned flight robot, etc.

The robot 100a to which the AI technology and the self-driving technology have been applied may mean a robot itself having a self-driving function or may mean the robot 100a interacting with the self-driving vehicle 100b.

The robot 100a having the self-driving function may collectively refer to devices that autonomously move along a given flow without control of a user or autonomously determine a flow and move.

The robot 100a and the self-driving vehicle 100b having the self-driving function may use a common sensing method in order to determine one or more of a moving path or a running plan. For example, the robot 100a and the self-driving vehicle 100b having the self-driving function may determine one or more of a moving path or a running plan using information sensed through LIDAR, a radar, a camera, etc.

The robot 100a interacting with the self-driving vehicle 100b is present separately from the self-driving vehicle 100b, and may perform an operation associated with a self-driving function inside or outside the self-driving vehicle 100b or associated with a user got in the self-driving vehicle 100b.

In this case, the robot 100a interacting with the self-driving vehicle 100b may control or assist the self-driving function of the self-driving vehicle 100b by obtaining sensor information in place of the self-driving vehicle 100b and providing the sensor information to the self-driving vehicle 100b, or by obtaining sensor information, generating surrounding environment information or object information, and providing the surrounding environment information or object information to the self-driving vehicle 100b.

Alternatively, the robot 100a interacting with the self-driving vehicle 100b may control the function of the self-driving vehicle 100b by monitoring a user got in the self-driving vehicle 100b or through an interaction with a user. For example, if a driver is determined to be a drowsiness state, the robot 100a may activate the self-driving function of the self-driving vehicle 100b or assist control of the driving unit of the self-driving vehicle 100b. In this case, the function of the self-driving vehicle 100b controlled by the robot 100a may include a function provided by a navigation system or audio system provided within the self-driving vehicle 100b, in addition to a self-driving function simply.

Alternatively, the robot 100a interacting with the self-driving vehicle 100b may provide information to the self-driving vehicle 100b or may assist a function outside the self-driving vehicle 100b. For example, the robot 100a may provide the self-driving vehicle 100b with traffic information, including signal information, as in a smart traffic light, and may automatically connect an electric charger to a filling inlet through an interaction with the self-driving vehicle 100b as in the automatic electric charger of an electric vehicle.

### AI+Robot+XR

An AI technology and an XR technology are applied to the robot 100a, and the robot 100a may be implemented as a guidance robot, a transport robot, a cleaning robot, a wearable robot, an entertainment robot, a pet robot, an unmanned flight robot, a drone, etc.

The robot 100a to which the XR technology has been applied may mean a robot, that is, a target of control/interaction within an XR image. In this case, the robot 100a is different from the XR device 100c, and they may operate in conjunction with each other.

When the robot 100a, that is, a target of control/interaction within an XR image, obtains sensor information from sensors including a camera, the robot 100a or the XR device 100c may generate an XR image based on the sensor information, and the XR device 100c may output the generated XR image. Furthermore, the robot 100a may operate based on a control signal received through the XR device 100c or a user's interaction.

For example, a user may identify a corresponding XR image at timing of the robot 100a, remotely operating in conjunction through an external device, such as the XR device 100c, may adjust the self-driving path of the robot 100a through an interaction, may control an operation or driving, or may identify information of a surrounding object.

### AI+Self-Driving+XR

An AI technology and an XR technology are applied to the self-driving vehicle 100b, and the self-driving vehicle 100b may be implemented as a movable type robot, a vehicle, an unmanned flight body, etc.

The self-driving vehicle 100b to which the XR technology has been applied may mean a self-driving vehicle equipped with means for providing an XR image or a self-driving vehicle, that is, a target of control/interaction within an XR image. Particularly, the self-driving vehicle 100b, that is, a target of control/interaction within an XR image, is different from the XR device 100c, and they may operate in conjunction with each other.

The self-driving vehicle 100b equipped with the means for providing an XR image may obtain sensor information from sensors including a camera, and may output an XR image generated based on the obtained sensor information. For example, the self-driving vehicle 100b includes an HUD, and may provide a passenger with an XR object corresponding to a real object or an object within a screen by outputting an XR image.

In this case, when the XR object is output to the HUD, at least some of the XR object may be output with it overlapping a real object toward which a passenger's view is directed. In contrast, when the XR object is displayed on a display included within the self-driving vehicle 100b, at least some of the XR object may be output so that it overlaps an object within a screen. For example, the self-driving vehicle 100b may output XR objects corresponding to objects, such as a carriageway, another vehicle, a traffic light, a signpost, a two-wheeled vehicle, a pedestrian, and a building.

When the self-driving vehicle 100b, that is, a target of control/interaction within an XR image, obtains sensor information from sensors including a camera, the self-driving vehicle 100b or the XR device 100c may generate an XR image based on the sensor information. The XR device 100c may output the generated XR image. Furthermore, the self-driving vehicle 100b may operate based on a control signal received through an external device, such as the XR device 100c, or a user's interaction.

### A. Physical Channel and Frame Structure

### Physical Channels and Normal Signal Transmission

FIG. A1 illustrates physical channels and normal signal transmission used in a 3GPP system. In a wireless communication system, a UE receives information from a base station via downlink (DL), and the UE transmits information to the base station via uplink (UL). The information that the base station and the UE transmit and receive includes data and various control information, and various physical channels exist depending on the type/use of the information that the base station and the UE transmit and receive.

### FIG. A1: Physical Channels and Normal Signal Transmission Using the Same

In a state in which the power is turned off, the power is turned on again, or a UE newly entering a cell performs an initial cell search operation such as synchronizing with the base station (S11). To this end, the UE receives, from the base station, a Primary Synchronization Channel (PSCH) and a Secondary Synchronization Channel (SSCH), synchronizes with the base station, and acquires information such as a cell identity (ID). In addition, the UE may receive a Physical Broadcast Channel (PBCH) from the base station to acquire broadcast information in the cell. In addition, the UE may receive a Downlink Reference Signal (DL RS) in the initial cell search step to check a downlink channel state.

After completing the initial cell search, the UE may receive a Physical Downlink Control Channel (PDCCH) and a corresponding Physical Downlink Control Channel (PDSCH) to acquire more detailed system information (S12).

Thereafter, the UE may perform a random access procedure to complete access to the base station (S13 to S16). Specifically, the UE may transmit a preamble on a Physical Random Access Channel (PRACH) (S13), and receive a Random Access Response (RAR) for the preamble on the PDCCH and a PDSCH corresponding to this (S14). Thereafter, the UE may transmit a Physical Uplink Shared Channel (PUSCH) using scheduling information in the RAR (S15), and may perform a contention resolution procedure such as the PDCCH and the corresponding PDSCH (S16).

The UE performing the procedure described above may perform PDCCH/PDSCH reception (S17) and PUSCH/Physical Uplink Control Channel (PUCCH) transmission (S18) as a subsequent general uplink/downlink signal transmission procedure. Control information that the UE transmits to the base station is referred to as uplink control information (UCI). The UCI includes HARQ ACK/Hybrid Automatic Repeat and reQuest Acknowledgment/Negative-ACK (NACK), Scheduling Request (SR), Channel State Information (CSI), and the like. The CSI includes a Channel Quality Indicator (CQI), a Precoding Matrix Indicator (PMI), and a Rank Indication (RI), and the like. The UCI is generally transmitted on the PUCCH, but may be transmitted on the PUSCH when control information and data have to be transmitted simultaneously. In addition, according to a request/instruction of the network, the UE may aperiodically transmit the UCI on the PUSCH.

### Radio Frame Structure

FIGS. A2 and A3 illustrate LTE radio frame structure. LTE supports frame type 1 for frequency division duplex (FDD), frame type 2 for time division duplex (TDD), and frame type 3 for unlicensed cell (UCell). In addition to primary cell (PCell), up to 31 secondary cells (SCells) may be aggregated. Unless otherwise stated, operations described below may be independently applied for each cell. In multi-cell aggregation, different frame structures may be used in different cells. In addition, time resources (e.g., subframes, slots, subslots) in the frame structure may be collectively referred to as a time unit (TU).

FIG. A2(a) illustrates frame type 1. A downlink radio frame is defined as ten 1 ms subframes (SFs). The subframe includes 14 or 12 symbols according to a cyclic prefix (CP). When a normal CP is used, the subframe includes 14 symbols. When an extended CP is used, the subframe includes 12 symbols. The symbol may mean an OFDM(A) symbol or an SC-FDM(A) symbol according to a multiple access scheme. For example, the symbol may mean an OFDM(A) symbol in downlink and mean an SC-FDM(A) symbol in uplink. The OFDM(A) symbol may be referred to as a cyclic prefix (CP)-OFDM(A) symbol, and the SC-FDM(A) symbol may be referred to as Discrete Fourier Transform (DFT)-spread (s)-OFDM(A) (DFT-s-OFDM(A)) symbol.

The subframe may be defined as one or more slots as below depending on a subcarrier spacing (SCS).
If SCS=7.5 kHz or 15 kHz, subframe #i is defined as two 0.5 ms slots #2i and #2i+1, where i is 0 to 9.
If SCS=1.25 kHz, subframe #i is defined as one 1 ms slot #2i.
if SCS=15 kHz, subframe #i may be defined as six subslots as shown in Table A1.

Table AI shows a subslot configuration in the subframe (normal CP).

TABLE A1

| | Subslot number | | | | | |
|---|---|---|---|---|---|---|
| | 0 | 1 | 2 | 3 | 4 | 5 |
| | Slot number | | | | | |
| | 2i | | | 2i + 1 | | |
| Uplink subslot pattern | 0, 1, 2 | 3, 4 | 5, 6 | 0, 1 | 2, 3 | 4, 5, 6 |
| (Symbol number) | | | | | | |
| Downlink subslot | 0, 1, 2 | 3, 4 | 5, 6 | 0, 1 | 2, 3 | 4, 5, 6 |
| pattern 1 | | | | | | |
| (Symbol number) | | | | | | |
| Downlink subslot | 0, 1 | 2, 3, 4 | 5, 6 | 0, 1 | 2, 3 | 4, 5, 6 |
| pattern 2 | | | | | | |
| (Symbol number) | | | | | | |

FIG. A2(b) illustrates frame type 2. The frame type 2 consists of two half frames. The half frame includes 4 (or 5) normal subframes and 1 (or 0) special subframe. The normal subframe is used for uplink or downlink according to uplink-downlink (UL-DL) configuration. The subframe consists of two slots.

Table A2 shows subframe configuration in a radio frame according to the UL-DL configuration.

TABLE A2

| Uplink-downlink | Downlink-to-Uplink | Subframe number | | | | | | | | | |
|---|---|---|---|---|---|---|---|---|---|---|---|
| configuration | Switch point periodicity | 0 | 1 | 2 | 3 | 4 | 5 | 6 | 7 | 8 | 9 |
| 0 | 5 ms | D | S | U | U | U | D | S | U | U | U |
| 1 | 5 ms | D | S | U | U | D | D | S | U | U | D |
| 2 | 5 ms | D | S | U | D | D | D | S | U | D | D |
| 3 | 10 ms | D | S | U | U | U | D | D | D | D | D |
| 4 | 10 ms | D | S | U | U | D | D | D | D | D | D |
| 5 | 10 ms | D | S | U | D | D | D | D | D | D | D |
| 6 | 5 ms | D | S | U | U | U | D | S | U | U | D |

Here, D denotes a DL subframe, U denotes a UL subframe, and S denotes a special subframe. The special subframe includes a Downlink Pilot TimeSlot (DwPTS), a Guard Period (GP), and an Uplink Pilot TimeSlot (UpPTS). The DwPTS is used for initial cell search, synchronization, or channel estimation in a UE. The UpPTS is used to match the channel estimation at a base station and uplink transmission synchronization of the UE. The GP is a period for eliminating interference caused in the uplink due to a multi-path latency of a downlink signal between the uplink and the downlink.

Table A3 shows configuration of the special subframe.

TABLE A3

| | Normal cyclic prefix in downlink | | | Extended cyclic prefix in downlink | | |
|---|---|---|---|---|---|---|
| | | UpPTS | | | UpPTS | |
| | | Normal cyclic | Extended cyclic | | Normal cyclic | Extended cyclic |
| Special subframe | | prefix | prefix | | prefix | prefix |
| configuration | DwPTS | in uplink | in uplink | DwPTS | in uplink | in uplink |
| 0 | 6592 · Tₛ | (1 + X) · 2192 · Tₛ | (1 + X) · 2560 · Tₛ | 7680 · Tₛ | (1 + X) · 2192 · Tₛ | (1 + X) · 2560 · Tₛ |
| 1 | 19760 · Tₛ | | | 20480 · Tₛ | | |
| 2 | 21952 · Tₛ | | | 23040 · Tₛ | | |
| 3 | 24144 · Tₛ | | | 25600 · Tₛ | | |
| 4 | 26336 · Tₛ | | | 7680 · Tₛ | (2 + X) · 2192 · Tₛ | (2 + X) · 2560 · Tₛ |
| 5 | 6592 · Tₛ | (2 + X) · 2192 · Tₛ | (2 + X) · 2560 · Tₛ | 20480 · Tₛ | | |
| 6 | 19760 · Tₛ | | | 23040 · Tₛ | | |
| 7 | 21952 · Tₛ | | | 12800 · Tₛ | | |
| 8 | 24144 · Tₛ | | | — | — | — |
| 9 | 13168 · Tₛ | | | — | — | — |
| 10 | 13168 · Tₛ | 13152 · Tₛ | 12800 · Tₛ | — | — | — |

Here, X is configured by higher layer (e.g., RRC) signal or given as 0.

FIG. A3 illustrates frame type 3. Frame type 3 may be applied to an UCell operation. Although not limited thereto, frame type 3 may be applied only to an operation of Licensed Assisted Access (LAA) SCell with the normal CP. The frame has a length of 10 ms and is defined as 10 1 ms subframes. Subframe #i is defined as two consecutive slots #2i and #2i+1. Each subframe in the frame may be used for downlink or uplink transmission or may be empty. The downlink transmission occupies one or more consecutive subframes, and starts from any time of the subframe and ends at a subframe boundary or DwPTS of Table A3. The uplink transmission occupies one or more consecutive subframes.

FIG. A4 illustrates a slot structure of LTE frame.

Referring to FIG. A4, a slot includes a plurality of symbols in a time domain and a plurality of resource blocks (RBs) in a frequency domain. The symbol may mean a symbol period. The structure of the slot may be expressed by a resource grid consisting of N^{DL/UL}_{RB}×N^{RB}_{sc} subcarriers and N^{DL/UL}_{symb} symbols, where N^{DL}_{RB} denotes the number of RBs in a downlink slot, and N^{UL}_{RB} denotes the number of RBs in an uplink slot. N^{DL}_{RB} and N^{UL}_{RB} depend on a DL bandwidth and an UL bandwidth, respectively. N^{DL}_{symb} denotes the number of symbols in the DL slot, and N^{UL}_{symb} denotes the number of symbols in the UL slot. N^{RB}_{sc} denotes the number of subcarriers constituting the RB. The number of symbols in the slot may be variously changed depending on the SCS and the CP length (see Table A1). For example, one slot includes 7 symbols in the case of normal CP, while one slot includes 6 symbols in the case of extended CP.

The RB is defined by N^{DL/UL}_{symb} (e.g., 7) consecutive symbols in the time domain and is defined by N^{RB}_{sc} (e.g., 12) consecutive subcarriers in the frequency domain. Here, the RB may mean a physical resource block (PRB) or a virtual resource block (VRB), and the PRB and the VRB may be mapped 1:1. Two RBs respectively located in two slots of the subframe are referred to as an RB pair. Two RBs constituting the RB pair have the same RB number (or also referred to as an RB index). A resource consisting of one symbol and one subcarrier is referred to as a resource element (RE) or tone. Each RE in the resource grid may be uniquely defined by an in-slot index pair (k, l), where k denotes an index given from 0 to N^{DL/UL}_{RB}XN^{RB}_{sc}−1 in the frequency domain, and l denotes an index given from 0 to N^{DL/UL}_{symb}−1 in the time domain.

FIG. A5 illustrates a structure of a downlink subframe of an LTE system.

Referring to FIG. A5, up to three (or four) OFDM (A) symbols located in front of a first slot within a subframe correspond to a control region to which a downlink control channel is allocated. The remaining OFDM (A) symbols correspond to a data region to which a physical downlink shared chancel (PDSCH) is allocated, and a basic unit of the data region is RB. The downlink control channel includes a physical control format indicator channel (PCFICH), a physical downlink control channel (PDCCH), a physical hybrid ARQ indicator channel (PHICH), etc. The PCFICH is transmitted on a first OFDM symbol of a subframe and carries information on the number of OFDM symbols used for transmission of the control channel within the subframe. The PHICH is a response to uplink transmission and carries an HARQ acknowledgment (ACK)/negative-acknowledgment (NACK) signal. Control information transmitted on the PDCCH is referred to as downlink control information (DCI). The DCI includes uplink or downlink scheduling information or includes an uplink transmit power control command for any UE group.

FIG. A6 illustrates a structure of an uplink subframe used in LTE.

Referring to FIG. A6, a subframe 500 consists of two 0.5 ms slots 501. Each slot consists of a plurality of symbols 502, and one symbol corresponds to one SC-FDMA symbol. An RB 503 is a resource allocation unit corresponding to 12 subcarriers in a frequency domain and one slot in a time domain. The structure of the uplink subframe of LTE is roughly divided into a data region 504 and a control region 505. The data region refers to a communication resource used to transmit data such as voice and packet transmitted to each UE and includes a physical uplink shared channel (PUSCH). The control region refers to a communication resource used to transmit an uplink control signal, for example, a downlink channel quality report from each UE, a reception ACK/NACK for a downlink signal, an uplink scheduling request, etc., and includes a physical uplink control channel (PUCCH). A sounding reference signal (SRS) is transmitted on an SC-FDMA symbol that is located last on a time axis in one subframe.

FIG. A7 illustrates a structure of a radio frame used in NR.

Uplink and downlink transmissions consist of frames in NR. The radio frame has a length of 10 ms and is defined as two 5 ms half-frames (HF). The half-frame is defined as 5 1 ms subframes (SF). The subframe is divided into one or more slots, and the number of slots in the subframe depends on a subcarrier spacing (SCS). Each slot includes 12 or 14 OFDM (A) symbols according to a cyclic prefix (CP). When the normal CP is used, each slot includes 14 symbols. When an extended CP is used, each slot includes 12 symbols. Here, the symbol may include an OFDM symbol (or a CP-OFDM symbol) and an SC-FDMA symbol (or a DFT-s-OFDM symbol).

Table A4 illustrates that when the normal CP is used, the number of symbols per slot, the number of slots per frame, and the number of slots per subframe vary depending on the SCS.

TABLE A4

| SCS (15*2\hat{ }u) | N^{slot}_{symb} | N^{frame, u}ₛₗₒₜ | N^{subframe, u}ₛₗₒₜ |
|---|---|---|---|
| 15 KHz (u = 0) | 14 | 10 | 1 |
| 30 KHz (u = 1) | 14 | 20 | 2 |
| 60 KHz (u = 2) | 14 | 40 | 4 |
| 120 KHz (u = 3) | 14 | 80 | 8 |
| | | 2 min | |
| | | 10 min | |
| | | 15 sec | |
| | | 1 min | |
| 240 KHz (u = 4) | 14 | 160 | 16 |

N^{slot}_{symb}: the number of symbols in slot
N^{frame, u}ₛₗₒₜ: the number of slots in frame
N^{subframe, u}ₛₗₒₜ: the number of slots in subframe

Table A5 illustrates that when the extended CP is used, the number of symbols per slot, the number of slots per frame, and the number of slots per subframe vary depending on the SCS.

TABLE A5

| SCS (15*2\hat{ }u) | N^{slot}_{symb} | N^{frame, u}ₛₗₒₜ | N^{subframe, u}ₛₗₒₜ |
|---|---|---|---|
| 60 KHz (u = 2) | 12 | 40 | 4 |

In the NR system, OFDM (A) numerology (e.g., SCS, CP length, etc.) may be differently configured between a plurality of cells merged into one UE. Hence, an (absolute time) interval of a time resource (e.g. SF, slot, or TTI) (commonly referred to as TU (Time Unit) for convenience) consisting of the same number of symbols may be differently configured between the merged cells.

FIG. A8 illustrates a slot structure of a NR frame.

The slot includes a plurality of symbols in the time domain. For example, in the case of a normal CP, one slot includes 7 symbols, but in the case of the extended CP, one slot includes 6 symbols. A carrier includes a plurality of subcarriers in the frequency domain. A resource block (RB) is defined as a plurality (e.g., 12) of consecutive subcarriers in the frequency domain. A bandwidth part (BWP) may be defined as a plurality of consecutive (P) RBs in the frequency domain, and may correspond to one numerology (e.g., SCS, CP length, etc.). The carrier may include a maximum of N (e.g., five) BWPs. Data communication may be performed through an activated BWP, and only one BWP may be activated for one UE. Each element in the resource grid may be referred to as a resource element (RE) and may be mapped to one complex symbol.

FIG. A9 illustrates a structure of a self-contained slot.

In the NR system, the frame is characterized by a self-contained structure in which all of DL control channel, DL or UL data, UL control channel, etc. can be included in one slot. For example, first N symbols in a slot may be used to transmit a DL control channel (hereinafter, DL control region), and last M symbols in a slot may be used to transmit a UL control channel (hereinafter, UL control region), where N and M each are an integer greater than or equal to 0. A resource region (hereinafter, a data region) between the DL control region and the UL control region may be used for DL data transmission or UL data transmission. As an example, the following configuration may be considered. Each section is listed in chronological order.
1. DL only configuration
2. UL only configuration
3. Mixed UL-DL configuration
   DL region+GP (Guard Period)+UL control region
   DL control region+GP+UL region
   DL region: (i) DL data region, (ii) DL control region+DL data region
   UL region: (i) UL data region, (ii) UL data region+UL control region

The PDCCH may be transmitted in the DL control region, and the PDSCH may be transmitted in the DL data region. The PUCCH may be transmitted in the UL control region, and the PUSCH may be transmitted in the UL data region. In the PDCCH, downlink control information (DCI), for example, DL data scheduling information, UL data scheduling information, etc. may be transmitted. In the PUCCH, Uplink Control Information (UCI), for example, Positive Acknowledgment/Negative Acknowledgment (ACK/NACK) information for DL data, Channel State Information (CSI) information, Scheduling Request (SR), etc. may be transmitted. A GP provides a time gap in the process of the base station and the UE converting from the transmission mode to the reception mode or from the reception mode to the transmission mode. Some symbols at time of converting from DL to UL in the subframe may be configured as the GP.

### B. Wireless Communication System Supporting Unlicensed Band

FIG. B1 illustrates an example of a wireless communication system supporting an unlicensed band applicable to the present disclosure.

In the following description, a cell operating in a licensed band (hereinafter, L-band) is defined as an L-cell, and a carrier of the L-cell is defined as (DL/UL) LCC. In addition, a cell operating in an unlicensed band (hereinafter, U-band) is defined as a U-cell, and a carrier of the U-cell is defined as (DL/UL) UCC. The carrier/carrier-frequency of the cell may mean the operating frequency (e.g., center frequency) of the cell. The cell/carrier (e.g., CC) is collectively referred to as a cell.

As illustrated in FIG. B1(a), when the UE and the base station transmit and receive signals via carrier-coupled LCC and UCC, the LCC may be configured as a primary CC (PCC) and the UCC may be configured as secondary CC (SCC). As illustrated in FIG. B1(b), the UE and the base station may transmit and receive signals via one UCC or a plurality of carrier-coupled UCCs. That is, the UE and the base station may transmit and receive signals via only the UCC(s) without the LCC.

Hereinafter, the signal transmission/reception operation (unless otherwise stated) in the unlicensed band above described in the present disclosure may be performed based on all the above-described deployment scenarios.

### Radio Frame Structure for Unlicensed Band

For an operation in an unlicensed band, frame type 3 of LTE (see FIG. A3) or NR frame structure (see FIG. A7) may be used. The configuration of OFDM symbols occupied for uplink/downlink signal transmission in the frame structure for the unlicensed band may be configured by the base station. The OFDM symbol may be replaced with an SC-FDM (A) symbol.

In order to transmit the downlink signal through the unlicensed band, the base station may inform the UE of the configuration of the OFDM symbols used in subframe #n via the signaling. The subframe may be replaced with a slot or a time unit (TU).

Specifically, in the LTE system supporting the unlicensed band, the UE may assume (or identify) the configuration of the OFDM symbol occupied in subframe #n through a specific field (e.g., subframe configuration for LAA field, etc.) in DCI received from the base station in subframe #n−1 or subframe #n.

Table B1 shows a method in which the subframe configuration for the LAA field in the LTE system represents the configuration of the OFDM symbols used for transmission of the downlink physical channel and/or the physical signal in a current subframe and/or a next subframe.

TABLE B1

| Value of ‘subframe | Configuration of occupied |
|---|---|
| configuration for LAA’ | OFDM symbols (current |
| field in current subframe | subframe, next subframe) |
| 0000 | (—, 14) |
| 0001 | (—, 12) |
| 0010 | (—, 11) |
| 0011 | (—, 10) |
| 0100 | (—, 9) |
| 0101 | (—, 6) |
| 0110 | (—, 3) |
| 0111 | (14, *) |
| 1000 | (12, —) |
| 1001 | (11, —) |
| 1010 | (10, —) |
| 1011 | (9, —) |
| 1100 | (6, —) |
| 1101 | (3, —) |
| 1110 | reserved |
| 1111 | reserved |

NOTE:
(—, Y) means UE may assume the first Y symbols are occupied in next subframe and other symbols in the next subframe are not occupied.
(X, —) means UE may assume the first X symbols are occupied in current subframe and other symbols in the current subframe are not occupied.
(X, *) means UE may assume the first X symbols are occupied in current subframe, and at least the first OFDM symbol of the next subframe is not occupied.

In order to transmit the uplink signal through the unlicensed band, the base station may inform the UE of information on the uplink transmission period via the signaling.

Specifically, in the LTE system supporting the unlicensed band, the UE may obtain ‘UL duration’ and ‘UL offset’ information for subframe #n through the ‘UL duration and offset’ field in the detected DCI.

Table B2 shows a method in which the UL duration and offset field represents the UL offset and UL duration configuration in the LTE system.

TABLE B2

| Value of | UL offset, l | UL duration, d |
|---|---|---|
| ‘UL duration and offset’ field | (in subframes) | (in subframes) |
| 00000 | Not configured | Not configured |
| 00001 | 1 | 1 |
| 00010 | 1 | 2 |
| 00011 | 1 | 3 |
| 00100 | 1 | 4 |
| 00101 | 1 | 5 |
| 00110 | 1 | 6 |
| 00111 | 2 | 1 |
| 01000 | 2 | 2 |
| 01001 | 2 | 3 |
| 01010 | 2 | 4 |
| 01011 | 2 | 5 |
| 01100 | 2 | 6 |
| 01101 | 3 | 1 |
| 01110 | 3 | 2 |
| 01111 | 3 | 3 |
| 10000 | 3 | 4 |
| 10001 | 3 | 5 |
| 10010 | 3 | 6 |
| 10011 | 4 | 1 |
| 10100 | 4 | 2 |
| 10101 | 4 | 3 |
| 10110 | 4 | 4 |
| 10111 | 4 | 5 |
| 11000 | 4 | 6 |
| 11001 | 6 | 1 |
| 11010 | 6 | 2 |
| 11011 | 6 | 3 |
| 11100 | 6 | 4 |
| 11101 | 6 | 5 |
| 11110 | 6 | 6 |
| 11111 | reserved | reserved |

For example, if the UL duration and offset field configures (or indicates) UL offset 1 and UL duration d for subframe #n, the UE does not need to receive a downlink physical channel and/or a physical signal within subframe #n+1+i (where i=0, 1, . . . , d−1).

### Downlink Signal Transmission Method Through Unlicensed Band

The base station may perform one of the following unlicensed band access procedures (e.g., Channel Access Procedure (CAP)) for downlink signal transmission in the unlicensed band.

### (1) First Downlink CAP Method

FIG. B2 is a flowchart illustrating a CAP operation for transmitting a downlink signal through an unlicensed band of a base station.

The base station may initiate a channel access procedure (CAP) for downlink signal transmission (e.g., signal transmission including PDSCH/PDCCH/EPDCCH) through an unlicensed band (S1210). The base station may randomly select a backoff counter N within a contention window (CW) according to step 1. In this instance, the N value is set to an initial value Nᵢₙᵢₜ (S1220). Nᵢₙᵢₜ is selected as a random value among values between 0 and CWₚ. Subsequently, if the backoff counter value N is 0 according to step 4 (S1230; Y), the base station ends the CAP process (S1232). Subsequently, the base station may perform Tx burst transmission including PDSCH/PDCCH/EPDCCH (S1234). On the other hand, if the backoff counter value is not 0 (S1230; N), the base station decreases the backoff counter value by 1 according to step 2 (S1240). Subsequently, the base station checks whether a channel of a U-cell(s) is in an idle state (S1250), and if the channel is in the idle state (S1250; Y), the base station checks whether the backoff counter value is 0 (S1230). Conversely, if the channel is not in the idle state in S1250, that is, if the channel is in a busy state (S1250; N), the base station checks whether the corresponding channel is in the idle state during a defer duration (T_{d}; 25 μsec or more) longer than a slot time (e.g., 9 μsec) according to step 5 (S1260). If the channel is in the idle state in the defer duration (S1270; Y), the base station may resume the CAP process. The defer duration may consist of a 16 μsec duration and mₚ consecutive slot times (e.g., 9 μsec) immediately following. On the other hand, if the channel is in the busy state during the defer duration (S1270; N), the base station performs step S1260 again to check whether the channel of the U-cell(s) is in the idle state during a new defer duration.

Table B3 shows that mₚ, minimum CW, maximum CW, maximum channel occupancy time (MCOT), and allowed CW sizes that are applied to the CAP vary depending on a channel access priority class.

TABLE B3

| Channel | | | | | | |
|---|---|---|---|---|---|---|
| Access | | | | | | allowed |
| Priority | | | | | | CWₚ |
| Class (p) | mₚ | CWₘᵢₙₚ | CW_{max, p} | T_{mcot, p} | | sizes |
| 1 | 1 | 3 | 7 | 2 | ms | {3, 7} |
| 2 | 1 | 7 | 15 | 3 | ms | {7, 15} |
| 3 | 3 | 15 | 63 | 8 or 10 | ms | {15, 31, 63} |
| 4 | 7 | 15 | 1023 | 8 or 10 | ms | {15, 31, 63, 127, |
| | | | | | | 255, 511, 1023} |

The contention window size applied to the first downlink CAP may be determined based on various methods. As an example, the contention window size may be adjusted based on a probability that HARQ-ACK values corresponding to PDSCH transmission(s) within a certain time duration (e.g., a reference TU) are determined as NACK. When the base station transmits a downlink signal including a PDSCH related to a channel access priority class p on a carrier, and when the probability that the HARQ-ACK values corresponding to the PDSCH transmission(s) in a reference subframe k (or reference slot k) are determined as NACK is at least Z=80%, the base station increases CW values set for each priority class to the next higher priority allowed, respectively. Alternatively, the base station maintains the CW values set for each priority class as initial values. The reference subframe (or reference slot) may be defined as a start subframe (or start slot) in which the most recent signal transmission on a corresponding carrier, in which at least some of the HARQ-ACK feedback is available, is performed.

### (2) Second Downlink CAP Method

The base station may perform downlink signal transmission (e.g., signal transmission including discovery signal transmission and not including PDSCH) through an unlicensed band based on the second downlink CAP method to be described later.

When a length of a signal transmission duration of the base station is less than 1 ms, the base station may transmit a downlink signal (e.g., signal transmission including discovery signal transmission and not including PDSCH) through the unlicensed band immediately after the corresponding channel is sensed as idle at least during a sensing duration T_{drs}=25 us. Here, T_{drs} consists of a duration T_{f} (=16 μs) immediately following one slot duration Tₛₗ=9 μs.

### (3) Third Downlink CAP Method

The base station may perform the following CAP to transmit a downlink signal on multiple carriers in an unlicensed band.
1) Type A: The base station performs the CAP on multiple carriers based on a counter N (counter N considered in the CAP) defined for each carrier and performs downlink signal transmission based on this.
   Type A1: Counter N for each carrier is determined independently of each other, and downlink signal transmission on each carrier is performed based on the counter N for each carrier.
   Type A2: Counter N for each carrier is determined as an N value for a carrier with the largest contention window size, and downlink signal transmission on the carrier is performed based on the counter N for each carrier.
2) Type B: The base station performs a CAP based on the counter N only on a specific carrier of a plurality of carriers, and determines whether channel for the remaining carriers is idle before signal transmission on the specific carrier and performs the downlink signal transmission.
   Type B1: A single contention window size is defined for the plurality of carriers, and the base station utilizes the single contention window size when performing the CAP based on counter N for the specific carrier.
   Type B2: The contention window size is defined for each carrier, and the largest contention window size among the contention window sizes is used when determining the Nᵢₙᵢₜ value for the specific carrier.

### Downlink Signal Transmission Method Through Unlicensed Band

A UE performs a contention-based CAP for uplink signal transmission in an unlicensed band. The UE performs a Type 1 or Type 2 CAP for uplink signal transmission in the unlicensed band. In general, the UE may perform a CAP (e.g., Type 1 or Type 2) for uplink signal transmission configured by a base station.

### (1) Type 1 Uplink CAP Method

FIG. B3 is a flowchart illustrating a Type 1 CAP operation of a UE for uplink signal transmission.

The UE may initiate a channel access procedure (CAP) for signal transmission through an unlicensed band (S1510). The UE may randomly select a backoff counter N within a contention window (CW) according to step 1. In this instance, the N value is set to an initial value Nᵢₙᵢₜ (S1520). Nᵢₙᵢₜ is selected as any value among values between 0 and CWₚ. Subsequently, if the backoff counter value N is 0 according to step 4 (S1530; Y), the UE ends the CAP process (S1532). Subsequently, the UE may perform Tx burst transmission (S1534). On the other hand, if the backoff counter value is not 0 (S1530; N), the UE decreases the backoff counter value by 1 according to step 2 (S1540). Subsequently, the UE checks whether a channel of a U-cell(s) is in an idle state (S1550), and if the channel is in the idle state (S1550; Y), the UE checks whether the backoff counter value is 0 (S1530). Conversely, if the channel is not in the idle state in step S1550, that is, if the channel is in a busy state (S1550; N), the UE checks whether the corresponding channel is in the idle state during a defer duration (T_{d}; 25 μsec or more) longer than a slot time (e.g., 9 μsec) according to step 5 (S1560). If the channel is in the idle state in the defer duration (S1570; Y), the UE may resume the CAP process. The defer duration may consist of a 16 μsec duration and mₚ consecutive slot times (e.g., 9 μsec) immediately following. On the other hand, if the channel is in the busy state during the defer duration (S1570; N), the UE performs step S1560 again to check whether the channel is in the idle state during a new defer duration.

Table B4 shows that mₚ, minimum CW, maximum CW, maximum channel occupancy time (MCOT), and allowed CW sizes that are applied to the CAP vary depending on a channel access priority class.

TABLE B4

| Channel Access | | | | | |
|---|---|---|---|---|---|
| Priority Class | | | | | |
| (p) | mₚ | CWₘᵢₙₚ | CW_{max, p} | T_{ulmcot, p} | allowed CWₚ sizes |
| 1 | 2 | 3 | 7 | 2 ms | {3, 7} |
| 2 | 2 | 7 | 15 | 4 ms | {7, 15} |
| 3 | 3 | 15 | 1023 | 6 ms or 10 ms | {15, 31, 63, 127, 255, 511, 1023} |
| 4 | 7 | 15 | 1023 | 6 ms or 10 ms | {15, 31, 63, 127, 255, 511, 1023} |

NOTE1:
For p = 3, 4, T_{ulmcot, p} = 10 ms if the higher layer parameter ‘absenceOfAnyOtherTechnology-r14’ indicates TRUE, otherwise, T_{ulmcot, p} = 6 ms.
NOTE 2:
When T_{ulmcot, p} = 6 ms it may be increased to 8 ms by inserting one or more gaps. The minimum duration of a gap shall be 100 μs. The maximum duration before including any such gap shall be 6 ms.

The contention window size applied to the Type 1 uplink CAP may be determined based on various methods. As an example, the contention window size may be adjusted based on whether to toggle a New Data Indicator (NDI) value for at least one HARQ process related to HARQ_ID_ref which is a HARQ process ID of UL-SCH within a certain time duration (e.g., a reference TU). When the UE performs signal transmission using the Type 1 channel access procedure related to the channel access priority class p on the carrier, the UE configures CWₚ=CW_{min,p} for all the priority classes p∈{1,2,3,4} if the NDI value for at least one HARQ process related to HARQ_ID_ref is toggled, and the UE increases CWₚ for all the priority classes p∈{1,2,3,4} to a next higher allowed value if the NDI value is not toggled.

The reference subframe n_{ref} (or reference slot n_{ref}) is determined as follows.

When the UE receives a UL grant in a subframe (or slot) n_{g} and performs transmission including UL-SCH without a gap, starting from a subframe (or slot) n₀ within subframes (or slots) n₀, n₁ . . . , n_{w} (where the subframe (or slot) n_{w} is a most recent subframe (or slot) before a subframe (or slot) n_{g}−3 in which the UE transmits the UL-SCH based on the Type 1 CAP), the reference subframe (or slot) n_{ref} is the subframe (or slot) n₀.

### (2) Type 2 Uplink CAP Method

When the UE uses a Type 2 CAP to transmit an uplink signal (e.g., a signal including PUSCH) through an unlicensed band, the UE may transmit the uplink signal (e.g., signal including the PUSCH) through the unlicensed band immediately after sensing that a channel is in an idle state at least during a sensing duration T_{short_ul}=25 us. T_{short_ul} consists of a duration T_{f}=16 us immediately following one slot duration Tₛₗ=9 us. T_{f} includes an idle slot duration Tₛₗ at a start point of the T_{f}.

### C. Structure of Uplink and Downlink Channels

### Downlink Channel Structure

A base station transmits a related signal to a UE via a downlink channel described below, and the UE receives the related signal from the base station via the downlink channel described below.

### (1) Physical Downlink Shared Channel (PDSCH)

The PDSCH carries downlink data (e.g., DL-shared channel transport block, DL-SCH TB), and modulation methods such as Quadrature Phase Shift Keying (QPSK), 16 Quadrature Amplitude Modulation (QAM), 64 QAM, and 256 QAM are applied. A codeword is generated by encoding TB. The PDSCH can carry up to two codewords. Scrambling and modulation mapping are performed per codeword, and modulation symbols generated from each codeword are mapped to one or more layers (layer mapping). Each layer is mapped to a resource along with a demodulation reference signal (DMRS) to generate an OFDM symbol signal and is transmitted through a corresponding antenna port.

### (2) Physical Downlink Control Channel (PDCCH)

The PDCCH carries downlink control information (DCI), and a QPSK modulation method is applied. One PDCCH consists of 1, 2, 4, 8, and 16 control channel elements (CCEs) based on an aggregation level (AL). One CCE consists of six resource element groups (REGs). One REG is defined as one OFDM symbol and one (P)RB. FIG. C1 illustrates a structure of one REG. In FIG. C1, D represents a resource element (RE) to which DCI is mapped, and R represents an RE to which DMRS is mapped. The DMRS is mapped to first, fifth, and ninth REs in a frequency domain direction within one symbol.

The PDCCH is transmitted through a control resource set (CORESET). The CORESET is defined as a REG set with a given numerology (e.g., SCS, CP length, etc.). A plurality of CORESETs for one UE may be overlapped in the time/frequency domain. The CORESET may be configured via system information (e.g., MIB) or UE-specific higher layer (e.g., radio resource control, RRC, layer) signaling. Specifically, the number of RBs and the number of symbols (maximum 3) configuring the CORESET may be configured by higher layer signaling.

The precoder granularity in the frequency domain for each CORESET is configured to one of the following by higher layer signaling:
sameAsREG-bundle: same as REG bundle size in frequency domain
allContiguousRBs: same as the number of consecutive RBs in the frequency domain in CORESET

REGs in CORESET are numbered based on a time-first mapping manner. That is, the REGs are sequentially numbered starting with 0 for the first OFDM symbol in the lowest-numbered resource block in the CORESET.

A mapping type from CCE to REG is configured to one of a non-interleaved CCE-REG mapping type or an interleaved CCE-REG mapping type. FIG. C2 illustrates a non-interleaved CCE-REG mapping type, and FIG. C3 illustrates an interleaved CCE-REG mapping type.
Non-interleaved CCE-REG mapping type (or localized mapping type): 6 REGs for a given CCE construct one REG bundle, and all REGs for the given CCE are consecutive. One REG bundle corresponds to one CCE.
Interleaved CCE-REG mapping type (or distributed mapping type): 2, 3, or 6 REGs for a given CCE constructs one REG bundle, and the REG bundle is interleaved in the CORESET. An REG bundle in the CORESET consisting of 1 OFDM symbol or 2 OFDM symbols consists of 2 or 6 REGs, and an REG bundle in the CORESET consisting of 3 OFDM symbols consists of 3 or 6 REGs. The size of the REG bundle is configured per CORESET.

FIG. C4 illustrates a block interleaver. The number of rows (A) of the (block) interleaver for the above interleaving operation is set to one of 2, 3, and 6. If the number of interleaving units for a given CORESET is P, the number of columns of the block interleaver is equal to P/A. A write operation for the block interleaver is performed in a row-first direction as illustrated in FIG. C4, and a read operation is performed in a column-first direction. The cyclic shift (CS) in the interleaving unit is applied based on an ID that can be configured independently of an ID that can be configured for the DMRS.

The UE acquires DCI transmitted on the PDCCH by performing decoding (alias, blind decoding) on a set of PDCCH candidates. The set of PDCCH candidates decoded by the UE is defined as a PDCCH search space set. The search space set may be a common search space or a UE-specific search space. The UE may acquire DCI by monitoring PDCCH candidates in one or more search space sets configured by MIB or higher layer signaling. Each CORESET configuration is associated with one or more search space sets, and each search space set is associated with one COREST configuration. One search space set is determined based on the following parameters.
controlResourceSetId: It represents a set of control resources related to a search space set.
monitoringSlotPeriodicityAndOffset: It represents a PDCCH monitoring period duration (slot units) and a PDCCH monitoring duration offset (slot units).
monitoringSymbolsWithinSlot: It represents a PDCCH monitoring pattern in a slot for PDCCH monitoring (e.g., it represents first symbol(s) of the control resource set).
nrofCandidates: It represents the number of PDCCH candidates (one of 0, 1, 2, 3, 4, 5, 6, 8) per AL={1, 2, 4, 8, 16}.

Table C1 shows features of each search space type.

TABLE C1

| | Search | | |
|---|---|---|---|
| Type | Space | RNTI | Use Case |
| Type0- | Common | SI-RNTI on a primary cell | SIB Decoding |
| PDCCH | | | |
| Type0A- | Common | SI-RNTI on a primary cell | SIB Decoding |
| PDCCH | | | |
| Type1- | Common | RA-RNTI or TC-RNTI on a primary | Msg2, Msg4 |
| PDCCH | | cell | decoding in |
| | | | RACH |
| Type2- | Common | P-RNTI on a primary cell | Paging Decoding |
| PDCCH | | | |
| Type3- | Common | INT-RNTI, SFI-RNTI, TPC-PUSCH- | |
| PDCCH | | RNTI, TPC-PUCCH-RNTI, TPC-SRS- | |
| | | RNTI, C-RNTI, MCS-C-RNTI, or CS- | |
| | | RNTI(s) | |
| | UE | C-RNTI, or MCS-C-RNTI, or CS- | User specific |
| | Specific | RNTI(s) | PDSCH decoding |

Table C2 shows DCI formats transmitted on PDCCH.

TABLE C2

| DCI format | Usage |
|---|---|
| 0_0 | Scheduling of PUSCH in one cell |
| 0_1 | Scheduling of PUSCH in one cell |
| 1_0 | Scheduling of PDSCH in one cell |
| 1_1 | Scheduling of PDSCH in one cell |
| 2_0 | Notifying a group of UEs of the slot format |
| 2_1 | Notifying a group of UEs of the PRB(s) and |
| | OFDM symbol(s) where UE may assume no |
| | transmission is intended for the UE |
| 2_2 | Transmission of TPC commands for |
| | PUCCH and PUSCH |
| 2_3 | Transmission of a group of TPC commands for |
| | SRS transmissions by one or more UEs |

DCI format 0_0 may be used to schedule TB-based (or TB-level) PUSCH, and DCI format 0_1 may be used to schedule TB-based (or TB-level) PUSCH or CBG (Code Block Group)-based (or CBG-level) PUSCH. DCI format 1_0 may be used to schedule TB-based (or TB-level) PDSCH, and DCI format 1_1 may be used to schedule TB-based (or TB-level) PDSCH or CBG-based (or CBG-level) PDSCH. DCI format 2_0 is used to transmit dynamic slot format information (e.g., dynamic SFI) to the UE, and DCI format 2_1 is used to transmit downlink pre-emption information to the UE. DCI format 2_0 and/or DCI format 2_1 may be transmitted to UEs in a corresponding group via a group common PDCCH which is a PDCCH transmitted to UEs defined as one group.

### Uplink Channel Structure

A UE transmits a related signal to a base station on an uplink channel to be described later, and the base station receives a related signal from the UE on an uplink channel to be described later.

### (1) Physical Uplink Shared Channel (PUSCH)

The PUSCH carries uplink data (e.g., UL-shared channel transport block, UL-SCH TB) and/or uplink control information (UCI), and is transmitted based on a CP-OFDM (Cyclic Prefix-Orthogonal Frequency Division Multiplexing) waveform or DFT-s-OFDM (Discrete Fourier Transform-spread-Orthogonal Frequency Division Multiplexing) waveform. When the PUSCH is transmitted based on the DFT-s-OFDM waveform, the UE transmits the PUSCH by applying transform precoding. For example, when the transform precoding is impossible (e.g., transform precoding is disabled), the UE may transmit the PUSCH based on the CP-OFDM waveform, and when the transform precoding is possible (e.g., transform precoding is enabled), the UE may transmit the PUSCH based on the CP-OFDM waveform or the DFT-s-OFDM waveform. The PUSCH transmission may be dynamically scheduled by a UL grant in the DCI, or may be semi-statically scheduled based on higher layer (e.g., RRC) signaling (and/or Layer 1 (L1) signaling (e.g., PDCCH)) (configured grant). The PUSCH transmission may be performed based on a codebook or a non-codebook.

### (2) Physical Uplink Control Channel (PUCCH)

The PUCCH carries uplink control information, HARQ-ACK and/or scheduling request (SR), and is divided into a short PUCCH and a long PUCCH depending on a PUCCH transmission length. Table C3 illustrates PUCCH formats.

TABLE C3

| | Length in | | | |
|---|---|---|---|---|
| PUCCH | OFDM symbols | Number | | |
| format | N_{symb}^{PUCCH} | of bits | Usage | Etc |
| 0 | 1-2 | ≤2 | HARQ, SR | Sequence selection |
| 1 | 4-14 | ≤2 | HARQ, [SR] | Sequence modulation |
| 2 | 1-2 | >2 | HARQ, CSI, [SR] | CP-OFDM |
| 3 | 4-14 | >2 | HARQ, CSI, [SR] | DFT-s-OFDM |
| | | | | (no UE multiplexing) |
| 4 | 4-14 | >2 | HARQ, CSI, [SR] | DFT-s-OFDM |
| | | | | (Pre DFT OCC) |

PUCCH format 0 carries UCI having a maximum size of 2 bits, and is mapped and transmitted based on a sequence. Specifically, the UE transmits a specific UCI to the base station by transmitting one of the plurality of sequences through PUCCH of the PUCCH format 0. The UE transmits the PUCCH of PUCCH format 0 in a PUCCH resource for configuring a corresponding SR only when transmitting a positive SR.

PUCCH format 1 carries UCI having a maximum size of 2 bits, and a modulation symbol is spread by an orthogonal cover code (OCC) (differently configured depending on whether there is frequency hopping) in the time domain. DMRS is transmitted in a symbol in which a modulation symbol is not transmitted (i.e. the DMRS is time division multiplexed (TDM) and transmitted).

PUCCH format 2 carries UCI having a bit size greater than 2 bits, and a modulation symbol is frequency division multiplexed (FDMed) with the DMRS and transmitted. DMRS is located at symbol indexes #1, #4, #7, and #10 in a given resource block with a density of ⅓. A pseudo noise (PN) sequence is used for a DMRS sequence. For 2-symbol PUCCH format 2, the frequency hopping may be activated.

PUCCH format 3 is not UE-multiplexed within the same physical resource blocks, and carries UCI with a bit size greater than 2 bits. In other words, a PUCCH resource of the PUCCH format 3 does not include an orthogonal cover code. The modulation symbol is time division multiplexed (TDMed) with DMRS and is transmitted.

PUCCH format 4 supports multiplexing up to 4 UEs in the same physical resource blocks, and carries UCI having a bit size greater than 2 bits. In other words, the PUCCH resource of the PUCCH format 3 includes an orthogonal cover code. The modulation symbol is time division multiplexed (TDMed) with DMRS and is transmitted.

### D. Synchronization Signal Block (SSB) Transmission and Related Operation

FIG. D1 illustrates a structure of an SSB. A UE can perform cell search, system information acquisition, beam alignment for initial access, DL measurement, etc. based on an SSB. The SSB is interchangeably used with a synchronization signal/physical broadcast channel (SS/PBCH) block.

Referring to FIG. D1, the SSB includes a PSS, an SSS and a PBCH. The SSB consists of four consecutive OFDM symbols, and the PSS, the PBCH, the SSS/PBCH and the PBCH are transmitted per OFDM symbol. Each of the PSS and the SSS consists of one OFDM symbol and 127 subcarriers, and the PBCH consists of 3 OFDM symbols and 576 subcarriers. Polar coding and quadrature phase shift keying (QPSK) are applied to the PBCH. The PBCH consists of a data resource element (RE) and a demodulation reference signal (DMRS) RE per OFDM symbol. Three DMRS REs are present per RB, and three data REs are present between the DMRS REs.

### Cell Search

The cell search refers to a process in which a UE acquires time/frequency synchronization of a cell and detects a cell identifier (ID) (e.g., physical layer cell ID (PCID)) of the cell. The PSS is used to detect a cell ID from a cell ID group, and the SSS is used to detect a cell ID group. The PBCH is used to detect an SSB (time) index and a half-frame.

A cell search procedure of the UE can be summarized as in Table D1 below.

TABLE D1

| | Type of | |
|---|---|---|
| | Signals | Operations |
| 1^{st} step | PSS | SS/PBCH block (SSB) symbol |
| | | timing acquisition |
| | | Cell ID detection within a cell ID group |
| | | (3 hypothesis) |
| 2^{nd} Step | SSS | Cell ID group detection (336 hypothesis) |
| 3^{rd} Step | PBCH | SSB index and Half frame (HF) index |
| | DMRS | (Slot and frame boundary detection) |
| 4^{th} Step | PBCH | Time information (80 ms, |
| | | System Frame Number |
| | | (SFN), SSB index, HF) |
| | | Remaining Minimum System Information |
| | | (RMSI) Control resource set |
| | | (CORESET)/Search space configuration |
| 5^{th} Step | PDCCH and | Cell access information |
| | PDSCH | RACH configuration |

There are 336 cell ID groups, and there are 3 cell IDs per cell ID group. A total of 1008 cell IDs are present, and the cell ID can be defined by Equation D1 below.

$$[ Equation D1 ]$$

$${N}_{ID}^{cell} = 3 {N}_{ID}^{( 1 )} + {N}_{ID}^{( 2 )} where {N}_{ID}^{( 1 )} ∈ \{ 0 , 1 , … , 335 \} and {N}_{ID}^{( 2 )} ∈ \{ 0 , 1 , 2 \}$$

Here, N^{cell}_{ID} represent a cell ID (e.g., PCID). N⁽¹⁾_{ID} represents a cell ID group and is provided/obtained via the SSS. N⁽²⁾_{ID} represents a cell ID in a cell ID group and is provided/obtained via the PSS.

PSS sequence d_{PSS}(n) can be defined to satisfy Equation D2.

$$\begin{matrix}{d}_{P S S} ( n ) = 1 - 2 x ( m ) \\ m = ( n + 43 {N}_{I D}^{( 2 )} ) mod 127 \\ 0 \leq n < 127\end{matrix} \qquad [ Equation D 2 ]$$

$$where x ( i + 7 ) = ( x ( i + 4 ) + x ( i ) ) mod 2 ,$$

$$[ \begin{matrix}x ( 6 ) & x ( 5 ) & x ( 4 ) & x ( 3 ) & x ( 2 ) & x ( 1 ) & x ( 0 )\end{matrix} ] = [ \begin{matrix}1 & 1 & 1 & 0 & 1 & 1 & 0\end{matrix} ]$$

SSS sequence d_{SSS}(n) can be defined to satisfy Equation D3.

$$[ Equation D 3 ]$$

$$\begin{matrix}{d}_{S S S} ( n ) = [ 1 - 2 {x}_{0} ( ( n + {m}_{0} ) mod 127 ) ] [ 1 - 2 {x}_{1} ( ( n + {m}_{1} ) mod 127 ) ] \\ {m}_{0} = 15 ⌊ \frac{{N}_{I D}^{( 1 )}}{112} ⌋ + 5 {N}_{ID}^{( 2 )} \\ {m}_{1} = {N}_{ID}^{( 1 )} mod 112 \\ 0 \leq n < 127\end{matrix}$$

$$where$$

$${x}_{0} ( i + 7 ) = ( {x}_{0} ( i + 4 ) + {x}_{0} ( i ) ) mod 2$$

$${x}_{1} ( i + 7 ) = ( {x}_{1} ( i + 1 ) + {x}_{1} ( i ) ) mod 2 ,$$

$$[ \begin{matrix}{x}_{0} ( 6 ) & {x}_{0} ( 5 ) & {x}_{0} ( 4 ) & {x}_{0} ( 3 ) & {x}_{0} ( 2 ) & {x}_{0} ( 1 ) & {x}_{0} ( 0 )\end{matrix} ] = [ \begin{matrix}0 & 0 & 0 & 0 & 0 & 0 & 1\end{matrix} ]$$

$$[ \begin{matrix}{x}_{1} ( 6 ) & {x}_{1} ( 5 ) & {x}_{1} ( 4 ) & {x}_{1} ( 3 ) & {x}_{1} ( 2 ) & {x}_{1} ( 1 ) & {x}_{1} ( 0 )\end{matrix} ] = [ \begin{matrix}0 & 0 & 0 & 0 & 0 & 0 & 1\end{matrix} ]$$

FIG. D2 illustrates SSB transmission.

The SSB is periodically transmitted according to an SSB periodicity. An SSB basic periodicity assumed by the UE in initial cell search is defined as 20 ms. After cell access, the SSB periodicity may be configured by one of {5 ms, 10 ms, 20 ms, 40 ms, 80 ms, 160 ms} by the network (e.g., eNB). At a beginning part of the SSB periodicity, a set of SSB bursts is configured. The SSB burst set may be configured by a 5-ms time window (i.e., half-frame) and the SSB may be transmitted up to L times within the SS burst set. L which is the maximum number of transmissions of the SSB may be given as follows according to a frequency band of a carrier. One slot includes up to two SSBs.
For frequency range up to 3 GHZ, L=4
For frequency range from 3 GHz to 6 GHz, L=8
For frequency range from 6 GHz to 52.6 GHZ, L=64

A time location of a SSB candidate within SS burst set may be defined as follows according to SCS. The time location of the SSB candidate is indexed (SSB index) from 0 to L−1 according to time order within the SS burst set (i.e., half-frame).
Case A—15 kHz SCS: The index of starting symbol of SSB candidate is given as {2, 8}+14*n. When carrier frequency is 3 GHz or less, n=0, 1. When carrier frequency is 3 GHZ~6 GHZ, n=0, 1, 2, 3.
Case B—30 kHz SCS: The index of starting symbol of SSB candidate is given as {4, 8, 16, 20}+28*n. When carrier frequency is 3 GHz or less, n=0. When carrier frequency is 3 GHZ~6 GHZ, n=0, 1.
Case C—30 kHz SCS: The index of starting symbol of SSB candidate is given as {2, 8}+14*n. When carrier frequency is 3 GHz or less, n=0, 1. When carrier frequency is 3 GHZ~6 GHZ, n=0, 1, 2, 3.
Case D—120 kHz SCS: The index of starting symbol of SSB candidate is given as {4, 8, 16, 20}+28*n. When carrier frequency is greater than 6 GHZ, n=0, 1, 2, 3, 5, 6, 7, 8, 10, 11, 12, 13, 15, 16, 17, 18.
Case E—240 kHz SCS: The index of starting symbol of SSB candidate is given as {8, 12, 16, 20, 32, 36, 40, 44}+56*n. When carrier frequency is greater than 6 GHZ, n=0, 1, 2, 3, 5, 6, 7, 8.

FIG. D3 illustrates that a UE acquires information on DL time synchronization.

The UE may acquire DL synchronization by detecting the SSB. The UE may identify the structure of the SSB burst set based on the detected SSB index, and thus detect a symbol/slot/half-frame boundary. The number of the frame/half-frame to which the detected SSB belongs may be identified using SFN information and half-frame indication information.

Specifically, the UE may acquire 10-bit System Frame Number (SFN) information from the PBCH (s0 to s9). 6 bits of the 10-bit SFN information are obtained from a Master Information Block (MIB), and the remaining 4 bits are obtained from a PBCH Transport Block (TB).

Next, the UE may acquire 1-bit half-frame indication information (c0). When a carrier frequency is 3 GHz or less, the half-frame indication information may be implicitly signaled using PBCH DMRS. The PBCH DMRS indicates 3-bit information by using one of eight PBCH DMRS sequences. Accordingly, in the case of L=4, 1 bit which remains after indicating the SSB index among 3 bits which may be indicated by using eight PBCH DRMS sequences may be used for half frame indication.

Last, the UE may acquire the SSB index based on a DMRS sequence and a PBCH payload. SSB candidates are indexed from 0 to L−1 in chronological order within the SSB burst set (i.e., half-frame). In the case of L=8 or 64, Least Significant Bit (LSB) 3 bits of the SSB index may be indicated using eight different PBCH DMRS sequences (b0 to b2). In the case of L=64, Most Significant Bit (MSB) 3 bits of the SSB index are indicated through the PBCH (b3 to b5). In the case of L=2, LSB 2 bits of the SSB index may be indicated using four different PBCH DMRS sequences (b0 and b1). In the case of L=4, 1 bit which remain after indicating the SSB index among 3 bits which may be indicated by using eight PBCH DRMS sequences may be used for the half frame indication (b2).

### System Information Acquisition

FIG. D4 illustrates a procedure of acquiring system information (SI). A UE may acquire AS-/NAS-information through an SI acquisition procedure. The SI acquisition procedure may be applied to a UE of RRC_IDLE state, RRC_INACTIVE state, and RRC_CONNECTED state.

SI is divided into a master information block (MIB) and a plurality of system information blocks (SIBs). SI other than the MIB may be referred to as remaining minimum system information (RMSI). This will be described in detail below.
MIB includes information/parameters related to SIB1 (SystemInformationBlockType1) reception and is transmitted on PBCH of SSB. Information of the MIB may refer to 3GPP TS 38.331 and include the following fields.

| | |
|---|---|
| - subCarrierSpacingCommon | ENUMERATED {scs15or60, |
| | scs30or120}, |
| - ssb-SubcarrierOffset | INTEGER (0..15), |
| - pdcch-ConfigSIB1 | INTEGER (0..255), |

Each field is described with reference to Table below.

pdcch-ConfigSIB1
Determines a common ControlResourceSet (CORESET), a common search space and necessary PDCCH
parameters. If the field ssb-SubcarrierOffset indicates that SIB1 is absent, the field pdcch-ConfigSIB1 indicates the
frequency positions where the UE may find SS/PBCH block with SIB1 or the frequency range where the network
does not provide SS/PBCH block with SIB1 (see TS 38.213, clause 13).
ssb-SubcarrierOffset
Corresponds to k_{SSB} (see TS 38.213), which is the frequency domain offset between SSB and the overall resource
block grid in number of subcarriers. (See TS 38.211, clause 7.4.3.1).
The value range of this field may be extended by an additional most significant bit encoded within PBCH as
specified in TS 38.213.
This field may indicate that this cell does not provide SIB1 and that there is hence no CORESET#0 configured in
MIB (see TS 38.213, clause 13). In this case, the field pdcch-ConfigSIB1 may indicate the frequency positions
where the UE may (not) find a SS/PBCH with a control resource set and search space for SIB1 (see TS 38.213,
clause 13).
subCarrierSpacingCommon
Subcarrier spacing for SIB1, Msg.2/4 for initial access, paging and broadcast SI-messages. If the UE acquires this
MIB on an FR1 carrier frequency, the value scs15or60 corresponds to 15 kHz and the value scs30or120
corresponds to 30 kHz. If the UE acquires this MIB on an FR2 carrier frequency, the value scs15or60 corresponds
to 60 kHz and the value scs30or 120 corresponds to 120 KHz.

In the initial cell selection, the UE assumes that a half frame with the SSB is repeated with a periodicity of 20 ms. The UE may check whether a control resource set (CORESET) for a Type0-PDCCH common search space exists based on the MIB. The Type0-PDCCH common search space is a kind of PDCCH search space and is used to transmit a PDCCH for scheduling an SI message. If the Type0-PDCCH common search space exists, the UE may determine, based on information (e.g., pdcch-ConfigSIB1)) within the MIB, (i) a plurality of consecutive RBs and one or more consecutive symbols constituting the CORESET and (ii) a PDCCH occasion (i.e., a time domain location for PDCCH reception). Specifically, pdcch-ConfigSIB1 is 8-bit information, the (i) is determined based on MSB (Most Significant Bit) 4 bits (see 3GPP TS 38.213 Table 13-1~13-10), and the (ii) is determined based on LSB (Least Significant Bit) 4 bits (see 3GPP TS 38.213 Table 13-11~13-15). For example, information indicated by 4 bits of pdcch-ConfigSIB1 is shown below.

If there is no Type0-PDCCH common search space, pdcch-ConfigSIB1 provides information for a frequency location where SSB/SIB1 exists and a frequency range where the SSB/SIB1 does not exist.

For initial cell selection, a UE may assume that half frames with SS/PBCH blocks occur with a periodicity of 2 frames. Upon detection of a SS/PBCH block, the UE determines that a control resource set for Type0-PDCCH common search space is present if k_{SSB}≤23 for FR1 (Frequency Range 1; Sub-6 GHz; 450 to 6000 MHz) and if k_{SSB}≤11 for FR2 (Frequency Range 2; mm-Wave; 24250 to 52600 MHz). The UE determines that a control resource set for Type0-PDCCH common search space is not present if k_{SSB}>23 for FR1 and if k_{SSB}>11 for FR2. k_{SSB} represents a frequency/subcarrier offset between subcarrier 0 of SS/PBCH block to subcarrier 0 of common resource block for SSB. For FR2 only values up to 11 are applicable. k_{SSB} may be signalled via MIB.
The SIB1 contains information related to availability and scheduling (e.g., transmission periodicity, SI-window size) of the remaining SIBs (hereinafter, referred to as SIBx, where x is an integer of 2 or more). For example, the SIB1 may indicate whether the SIBx is periodically broadcasted or whether the SIBx is provided by a request of the UE according to an on-demand scheme. If the SIBx is provided by the on-demand scheme, the SIB1 may include information that the UE requires to perform an SI request. The SIB1 is transmitted on the PDSCH, the PDCCH scheduling the SIB1 is transmitted through the Type0-PDCCH common search space, and the SIB1 is transmitted on the PDSCH indicated by the PDCCH.
The SIBx is included in the SI message and is transmitted on the PDSCH. Each SI message is sent within a time window (i.e., SI-window) which periodically occurs.

### Beam Alignment

FIG. D5 illustrates multi-beam transmission of SSB.

Beam sweeping means that a transmission reception point (TRP) (e.g. a base station/cell) makes a beam (direction) of a radio signal different with time (hereinafter, a beam and a beam direction may be used interchangeably). The SSB may be transmitted periodically using the beam sweeping. In this case, the SSB index is implicitly linked with the SSB beam. The SSB beam may be changed in units of SSB (index) or may be changed in units of SSB (index) groups. In the latter case, the SSB beam remains the same within the SSB (index) group. That is, the reflection of the transmission beam of the SSB is repeated in a plurality of consecutive SSBs. The maximum number of SSB transmissions L in the SSB burst set has a value of 4, 8, or 64 depending on the frequency band to which the carrier belongs. Accordingly, the maximum number of SSB beams in the SSB burst set may also be given as follows depending on the frequency band of the carrier.
For frequency range up to 3 GHZ, Max number of beams=4
For frequency range from 3 GHz to 6 GHZ, Max number of beams=8
For frequency range from 6 GHz to 52.6 GHz, Max number of beams=64
When multi-beam transmission is not applied, the number of SSB beams is one.

When the UE attempts to initially access the base station, the UE may align the beam with the base station based on the SSB. For example, the UE identifies the best SSB after performing SSB detection. Thereafter, the UE may transmit the RACH preamble to the base station using the PRACH resource linked/corresponding to the index (i.e. beam) of the best SSB. The SSB may be used to align beams between the base station and the UE even after initial access.

### Channel Measurement and Rate-Matching

FIG. D6 illustrates a method of informing an actually transmitted SSB (SSB_tx).

Up to L SSBs may be transmitted within an SSB burst set, and the number/location of SSBs which are actually transmitted may vary per base station (BS)/cell. The number/location of SSBs which are actually transmitted is used for rate-matching and measurement, and information on the actually transmitted SSBs is indicated as follows.
In case related to rate-matching: it may be indicated via UE-specific RRC signaling or RMSI. The UE-specific RRC signaling includes a full (e.g., length L) bitmap in both below 6 GHz and above 6 GHz frequency ranges. The RMSI includes the full bitmap below 6 GHz and includes a compression type bitmap above 6 GHz as illustrated. Specifically, information on the actually transmitted SSBs may be indicated using group-bitmap (8 bits)+in-group bitmap (8 bits). Here, resources (e.g., REs) indicated via UE-specific RRC signaling or RMSI may be reserved for SSB transmission, and the PDSCH/PUSCH may be rate-matched considering SSB resources.
In case related to measurement: when the network is in an RRC connected mode, the network (e.g., base station) may indicate an SSB set to be measured in a measurement duration. The SSB set may be indicated for each frequency layer. When there is no indication for the SSB set, a default SSB set is used. The default SSB set includes all SSBs in the measurement duration. The SSB set may be indicated using the full (e.g., length L) bitmap of the RRC signaling. When the network is in an RRC idle, the default SSB set is used.

### E. Examples of Operation Flowchart of UE and Signaling Between BS and UE

FIG. 3-0A illustrates an example of an operation flowchart of a UE performing NR FR1, FR2, or FR2-2 transmission of one or more physical channels/signals to which a method proposed in the present disclosure can be applied. FIG. 3-0A is merely for convenience of explanation and does not limit the scope of the present disclosure.

FIG. 3-OB illustrates an example of an operation flowchart of a base station (BS) performing NR FR1, FR2, or FR2-2 transmission of one or more physical channels/signals to which a method proposed in the present disclosure can be applied. FIG. 3-OB is merely for convenience of explanation and does not limit the scope of the present disclosure.

FIG. 3-0C illustrates an example of signalling between a BS and a UE performing NR FR1, FR2, or FR2-2 transmission/reception of one or more physical channels/signals to which a method proposed in the present disclosure can be applied. FIG. 3-0C is merely for convenience of explanation and does not limit the scope of the present disclosure.

### F. PRACH Configuration Table (38.211)

The following shows examples of PRACH configuration tables for methods proposed through the present disclosure.

TABLE 6.3.3.2-2
Random access configurations for FR1 and paired spectrum/supplementary uplink.

| | | | | | | | Nₜ^{RA, slot}, | |
|---|---|---|---|---|---|---|---|---|
| | | | | | | | number of | |
| | | | | | | | time- | |
| | | | | | | | domain | |
| | | | | | | Number of | PRACH | |
| PRACH | | | | | | PRACH slots | occasions | N_{dur}^{RA}, |
| Configuration | Preamble | n_{SFN} mod x = y | | Subframe | Starting | within a | within a | PRACH |
| Index | format | x | y | number | symbol | subframe | PRACH slot | duration |
| 0 | 0 | 16 | 1 | 1 | 0 | — | — | 0 |
| 1 | 0 | 16 | 1 | 4 | 0 | — | — | 0 |
| 2 | 0 | 16 | 1 | 7 | 0 | — | — | 0 |
| 3 | 0 | 16 | 1 | 9 | 0 | — | — | 0 |
| 4 | 0 | 8 | 1 | 1 | 0 | — | — | 0 |
| 5 | 0 | 8 | 1 | 4 | 0 | — | — | 0 |
| 6 | 0 | 8 | 1 | 7 | 0 | — | — | 0 |
| 7 | 0 | 8 | 1 | 9 | 0 | — | — | 0 |
| 8 | 0 | 4 | 1 | 1 | 0 | — | — | 0 |
| 9 | 0 | 4 | 1 | 4 | 0 | — | — | 0 |
| 10 | 0 | 4 | 1 | 7 | 0 | — | — | 0 |
| 11 | 0 | 4 | 1 | 9 | 0 | — | — | 0 |
| 12 | 0 | 2 | 1 | 1 | 0 | — | — | 0 |
| 13 | 0 | 2 | 1 | 4 | 0 | — | — | 0 |
| 14 | 0 | 2 | 1 | 7 | 0 | — | — | 0 |
| 15 | 0 | 2 | 1 | 9 | 0 | — | — | 0 |
| 16 | 0 | 1 | 0 | 1 | 0 | — | — | 0 |
| 17 | 0 | 1 | 0 | 4 | 0 | — | — | 0 |
| 18 | 0 | 1 | 0 | 7 | 0 | — | — | 0 |
| 19 | 0 | 1 | 0 | 1, 6 | 0 | — | — | 0 |
| 20 | 0 | 1 | 0 | 2, 7 | 0 | — | — | 0 |
| 21 | 0 | 1 | 0 | 3, 8 | 0 | — | — | 0 |
| 22 | 0 | 1 | 0 | 1, 4, 7 | 0 | — | — | 0 |
| 23 | 0 | 1 | 0 | 2, 5, 8 | 0 | — | — | 0 |
| 24 | 0 | 1 | 0 | 3, 6, 9 | 0 | — | — | 0 |
| 25 | 0 | 1 | 0 | 0, 2, 4, 6, 8 | 0 | — | — | 0 |
| 26 | 0 | 1 | 0 | 1, 3, 5, 7, 9 | 0 | — | — | 0 |
| 27 | 0 | 1 | 0 | 0, 1, 2, 3, 4, | 0 | — | — | 0 |
| | | | | 5, 6, 7, 8, 9 | | | | |
| 28 | 1 | 16 | 1 | 1 | 0 | — | — | 0 |
| 29 | 1 | 16 | 1 | 4 | 0 | — | — | 0 |
| 30 | 1 | 16 | 1 | 7 | 0 | — | — | 0 |
| 31 | 1 | 16 | 1 | 9 | 0 | — | — | 0 |
| 32 | 1 | 8 | 1 | 1 | 0 | — | — | 0 |
| 33 | 1 | 8 | 1 | 4 | 0 | — | — | 0 |
| 34 | 1 | 8 | 1 | 7 | 0 | — | — | 0 |
| 35 | 1 | 8 | 1 | 9 | 0 | — | — | 0 |
| 36 | 1 | 4 | 1 | 1 | 0 | — | — | 0 |
| 37 | 1 | 4 | 1 | 4 | 0 | — | — | 0 |
| 38 | 1 | 4 | 1 | 7 | 0 | — | — | 0 |
| 39 | 1 | 4 | 1 | 9 | 0 | — | — | 0 |
| 40 | 1 | 2 | 1 | 1 | 0 | — | — | 0 |
| 41 | 1 | 2 | 1 | 4 | 0 | — | — | 0 |
| 42 | 1 | 2 | 1 | 7 | 0 | — | — | 0 |
| 43 | 1 | 2 | 1 | 9 | 0 | — | — | 0 |
| 44 | 1 | 1 | 0 | 1 | 0 | — | — | 0 |
| 45 | 1 | 1 | 0 | 4 | 0 | — | — | 0 |
| 46 | 1 | 1 | 0 | 7 | 0 | — | — | 0 |
| 47 | 1 | 1 | 0 | 1, 6 | 0 | — | — | 0 |
| 48 | 1 | 1 | 0 | 2, 7 | 0 | — | — | 0 |
| 49 | 1 | 1 | 0 | 3, 8 | 0 | — | — | 0 |
| 50 | 1 | 1 | 0 | 1, 4, 7 | 0 | — | — | 0 |
| 51 | 1 | 1 | 0 | 2, 5, 8 | 0 | — | — | 0 |
| 52 | 1 | 1 | 0 | 3, 6, 9 | 0 | — | — | 0 |
| 53 | 2 | 16 | 1 | 1 | 0 | — | — | 0 |
| 54 | 2 | 8 | 1 | 1 | 0 | — | — | 0 |
| 55 | 2 | 4 | 0 | 1 | 0 | — | — | 0 |
| 56 | 2 | 2 | 0 | 1 | 0 | — | — | 0 |
| 57 | 2 | 2 | 0 | 5 | 0 | — | — | 0 |
| 58 | 2 | 1 | 0 | 1 | 0 | — | — | 0 |
| 59 | 2 | 1 | 0 | 5 | 0 | — | — | 0 |
| 60 | 3 | 16 | 1 | 1 | 0 | — | — | 0 |
| 61 | 3 | 16 | 1 | 4 | 0 | — | — | 0 |
| 62 | 3 | 16 | 1 | 7 | 0 | — | — | 0 |
| 63 | 3 | 16 | 1 | 9 | 0 | — | — | 0 |
| 64 | 3 | 8 | 1 | 1 | 0 | — | — | 0 |
| 65 | 3 | 8 | 1 | 4 | 0 | — | — | 0 |
| 66 | 3 | 8 | 1 | 7 | 0 | — | — | 0 |
| 67 | 3 | 4 | 1 | 1 | 0 | — | — | 0 |
| 68 | 3 | 4 | 1 | 4 | 0 | — | — | 0 |
| 69 | 3 | 4 | 1 | 7 | 0 | — | — | 0 |
| 70 | 3 | 4 | 1 | 9 | 0 | — | — | 0 |
| 71 | 3 | 2 | 1 | 1 | 0 | — | — | 0 |
| 72 | 3 | 2 | 1 | 4 | 0 | — | — | 0 |
| 73 | 3 | 2 | 1 | 7 | 0 | — | — | 0 |
| 74 | 3 | 2 | 1 | 9 | 0 | — | — | 0 |
| 75 | 3 | 1 | 0 | 1 | 0 | — | — | 0 |
| 76 | 3 | 1 | 0 | 4 | 0 | — | — | 0 |
| 77 | 3 | 1 | 0 | 7 | 0 | — | — | 0 |
| 78 | 3 | 1 | 0 | 1, 6 | 0 | — | — | 0 |
| 79 | 3 | 1 | 0 | 2, 7 | 0 | — | — | 0 |
| 80 | 3 | 1 | 0 | 3, 8 | 0 | — | — | 0 |
| 81 | 3 | 1 | 0 | 1, 4, 7 | 0 | — | — | 0 |
| 82 | 3 | 1 | 0 | 2, 5, 8 | 0 | — | — | 0 |
| 83 | 3 | 1 | 0 | 3, 6, 9 | 0 | — | — | 0 |
| 84 | 3 | 1 | 0 | 0, 2, 4, | 0 | — | — | 0 |
| | | | | 6, 8 | | | | |
| 85 | 3 | 1 | 0 | 1, 3, 5, | 0 | — | — | 0 |
| | | | | 7, 9 | | | | |
| 86 | 3 | 1 | 0 | 0, 1, 2, 3, 4, | 0 | — | — | 0 |
| | | | | 5, 6, 7, 8, 9 | | | | |
| 87 | A1 | 16 | 0 | 4, 9 | 0 | 1 | 6 | 2 |
| 88 | A1 | 16 | 1 | 4 | 0 | 2 | 6 | 2 |
| 89 | A1 | 8 | 0 | 4, 9 | 0 | 1 | 6 | 2 |
| 90 | A1 | 8 | 1 | 4 | 0 | 2 | 6 | 2 |
| 91 | A1 | 4 | 0 | 4, 9 | 0 | 1 | 6 | 2 |
| 92 | A1 | 4 | 1 | 4, 9 | 0 | 1 | 6 | 2 |
| 93 | A1 | 4 | 0 | 4 | 0 | 2 | 6 | 2 |
| 94 | A1 | 2 | 0 | 4, 9 | 0 | 1 | 6 | 2 |
| 95 | A1 | 2 | 0 | 1 | 0 | 2 | 6 | 2 |
| 96 | A1 | 2 | 0 | 4 | 0 | 2 | 6 | 2 |
| 97 | A1 | 2 | 0 | 7 | 0 | 2 | 6 | 2 |
| 98 | A1 | 1 | 0 | 4 | 0 | 1 | 6 | 2 |
| 99 | A1 | 1 | 0 | 1, 6 | 0 | 1 | 6 | 2 |
| 100 | A1 | 1 | 0 | 4, 9 | 0 | 1 | 6 | 2 |
| 101 | A1 | 1 | 0 | 1 | 0 | 2 | 6 | 2 |
| 102 | A1 | 1 | 0 | 7 | 0 | 2 | 6 | 2 |
| 103 | A1 | 1 | 0 | 2, 7 | 0 | 2 | 6 | 2 |
| 104 | A1 | 1 | 0 | 1, 4, 7 | 0 | 2 | 6 | 2 |
| 105 | A1 | 1 | 0 | 0, 2, 4, 6, 8 | 0 | 2 | 6 | 2 |
| 106 | A1 | 1 | 0 | 0, 1, 2, 3, 4, | 0 | 2 | 6 | 2 |
| | | | | 5, 6, 7, 8, 9 | | | | |
| 107 | A1 | 1 | 0 | 1, 3, 5, | 0 | 2 | 6 | 2 |
| | | | | 7, 9 | | | | |
| 108 | A1/B1 | 2 | 0 | 4, 9 | 0 | 1 | 7 | 2 |
| 109 | A1/B1 | 2 | 0 | 4 | 0 | 2 | 7 | 2 |
| 110 | A1/B1 | 1 | 0 | 4 | 0 | 1 | 7 | 2 |
| 111 | A1/B1 | 1 | 0 | 1, 6 | 0 | 1 | 7 | 2 |
| 112 | A1/B1 | 1 | 0 | 4, 9 | 0 | 1 | 7 | 2 |
| 113 | A1/B1 | 1 | 0 | 1 | 0 | 2 | 7 | 2 |
| 114 | A1/B1 | 1 | 0 | 7 | 0 | 2 | 7 | 2 |
| 115 | A1/B1 | 1 | 0 | 1, 4, 7 | 0 | 2 | 7 | 2 |
| 116 | A1/B1 | 1 | 0 | 0, 2, 4, | 0 | 2 | 7 | 2 |
| | | | | 6, 8 | | | | |
| 117 | A2 | 16 | 1 | 2, 6, 9 | 0 | 1 | 3 | 4 |
| 118 | A2 | 16 | 1 | 4 | 0 | 2 | 3 | 4 |
| 119 | A2 | 8 | 1 | 2, 6, 9 | 0 | 1 | 3 | 4 |
| 120 | A2 | 8 | 1 | 4 | 0 | 2 | 3 | 4 |
| 121 | A2 | 4 | 0 | 2, 6, 9 | 0 | 1 | 3 | 4 |
| 122 | A2 | 4 | 0 | 4 | 0 | 2 | 3 | 4 |
| 123 | A2 | 2 | 1 | 2, 6, 9 | 0 | 1 | 3 | 4 |
| 124 | A2 | 2 | 0 | 1 | 0 | 2 | 3 | 4 |
| 125 | A2 | 2 | 0 | 4 | 0 | 2 | 3 | 4 |
| 126 | A2 | 2 | 0 | 7 | 0 | 2 | 3 | 4 |
| 127 | A2 | 1 | 0 | 4 | 0 | 1 | 3 | 4 |
| 128 | A2 | 1 | 0 | 1, 6 | 0 | 1 | 3 | 4 |
| 129 | A2 | 1 | 0 | 4, 9 | 0 | 1 | 3 | 4 |
| 130 | A2 | 1 | 0 | 1 | 0 | 2 | 3 | 4 |
| 131 | A2 | 1 | 0 | 7 | 0 | 2 | 3 | 4 |
| 132 | A2 | 1 | 0 | 2, 7 | 0 | 2 | 3 | 4 |
| 133 | A2 | 1 | 0 | 1, 4, 7 | 0 | 2 | 3 | 4 |
| 134 | A2 | 1 | 0 | 0, 2, 4, | 0 | 2 | 3 | 4 |
| | | | | 6, 8 | | | | |
| 135 | A2 | 1 | 0 | 0, 1, 2, 3, 4, | 0 | 2 | 3 | 4 |
| | | | | 5, 6, 7, 8, 9 | | | | |
| 136 | A2 | 1 | 0 | 1, 3, 5, | 0 | 2 | 3 | 4 |
| | | | | 7, 9 | | | | |
| 137 | A2/B2 | 2 | 1 | 2, 6, 9 | 0 | 1 | 3 | 4 |
| 138 | A2/B2 | 2 | 0 | 4 | 0 | 2 | 3 | 4 |
| 139 | A2/B2 | 1 | 0 | 4 | 0 | 1 | 3 | 4 |
| 140 | A2/B2 | 1 | 0 | 1, 6 | 0 | 1 | 3 | 4 |
| 141 | A2/B2 | 1 | 0 | 4, 9 | 0 | 1 | 3 | 4 |
| 142 | A2/B2 | 1 | 0 | 1 | 0 | 2 | 3 | 4 |
| 143 | A2/B2 | 1 | 0 | 7 | 0 | 2 | 3 | 4 |
| 144 | A2/B2 | 1 | 0 | 1, 4, 7 | 0 | 2 | 3 | 4 |
| 145 | A2/B2 | 1 | 0 | 0, 2, 4, | 0 | 2 | 3 | 4 |
| | | | | 6, 8 | | | | |
| 146 | A2/B2 | 1 | 0 | 0, 1, 2, 3, 4, | 0 | 2 | 3 | 4 |
| | | | | 5, 6, 7, 8, 9 | | | | |
| 147 | A3 | 16 | 1 | 4, 9 | 0 | 1 | 2 | 6 |
| 148 | A3 | 16 | 1 | 4 | 0 | 2 | 2 | 6 |
| 149 | A3 | 8 | 1 | 4, 9 | 0 | 1 | 2 | 6 |
| 150 | A3 | 8 | 1 | 4 | 0 | 2 | 2 | 6 |
| 151 | A3 | 4 | 0 | 4, 9 | 0 | 1 | 2 | 6 |
| 152 | A3 | 4 | 0 | 4 | 0 | 2 | 2 | 6 |
| 153 | A3 | 2 | 1 | 2, 6, 9 | 0 | 2 | 2 | 6 |
| 154 | A3 | 2 | 0 | 1 | 0 | 2 | 2 | 6 |
| 155 | A3 | 2 | 0 | 4 | 0 | 2 | 2 | 6 |
| 156 | A3 | 2 | 0 | 7 | 0 | 2 | 2 | 6 |
| 157 | A3 | 1 | 0 | 4 | 0 | 1 | 2 | 6 |
| 158 | A3 | 1 | 0 | 1, 6 | 0 | 1 | 2 | 6 |
| 159 | A3 | 1 | 0 | 4, 9 | 0 | 1 | 2 | 6 |
| 160 | A3 | 1 | 0 | 1 | 0 | 2 | 2 | 6 |
| 161 | A3 | 1 | 0 | 7 | 0 | 2 | 2 | 6 |
| 162 | A3 | 1 | 0 | 2, 7 | 0 | 2 | 2 | 6 |
| 163 | A3 | 1 | 0 | 1, 4, 7 | 0 | 2 | 2 | 6 |
| 164 | A3 | 1 | 0 | 0, 2, 4, | 0 | 2 | 2 | 6 |
| | | | | 6, 8 | | | | |
| 165 | A3 | 1 | 0 | 0, 1, 2, 3, 4, | 0 | 2 | 2 | 6 |
| | | | | 5, 6, 7, 8, 9 | | | | |
| 166 | A3 | 1 | 0 | 1, 3, 5, | 0 | 2 | 2 | 6 |
| | | | | 7, 9 | | | | |
| 167 | A3/B3 | 2 | 1 | 2, 6, 9 | 0 | 2 | 2 | 6 |
| 168 | A3/B3 | 2 | 0 | 4 | 0 | 2 | 2 | 6 |
| 169 | A3/B3 | 1 | 0 | 4 | 0 | 1 | 2 | 6 |
| 170 | A3/B3 | 1 | 0 | 1, 6 | 0 | 1 | 2 | 6 |
| 171 | A3/B3 | 1 | 0 | 4, 9 | 0 | 1 | 2 | 6 |
| 172 | A3/B3 | 1 | 0 | 1 | 0 | 2 | 2 | 6 |
| 173 | A3/B3 | 1 | 0 | 7 | 0 | 2 | 2 | 6 |
| 174 | A3/B3 | 1 | 0 | 1, 4, 7 | 0 | 2 | 2 | 6 |
| 175 | A3/B3 | 1 | 0 | 0, 2, 4, | 0 | 2 | 2 | 6 |
| | | | | 6, 8 | | | | |
| 176 | A3/B3 | 1 | 0 | 0, 1, 2, 3, 4, | 0 | 2 | 2 | 6 |
| | | | | 5, 6, 7, 8, 9 | | | | |
| 177 | B1 | 16 | 0 | 4, 9 | 0 | 1 | 7 | 2 |
| 178 | B1 | 16 | 1 | 4 | 0 | 2 | 7 | 2 |
| 179 | B1 | 8 | 0 | 4, 9 | 0 | 1 | 7 | 2 |
| 180 | B1 | 8 | 1 | 4 | 0 | 2 | 7 | 2 |
| 181 | B1 | 4 | 0 | 4, 9 | 0 | 1 | 7 | 2 |
| 182 | B1 | 4 | 1 | 4, 9 | 0 | 1 | 7 | 2 |
| 183 | B1 | 4 | 0 | 4 | 0 | 2 | 7 | 2 |
| 184 | B1 | 2 | 0 | 4, 9 | 0 | 1 | 7 | 2 |
| 185 | B1 | 2 | 0 | 1 | 0 | 2 | 7 | 2 |
| 186 | B1 | 2 | 0 | 4 | 0 | 2 | 7 | 2 |
| 187 | B1 | 2 | 0 | 7 | 0 | 2 | 7 | 2 |
| 188 | B1 | 1 | 0 | 4 | 0 | 1 | 7 | 2 |
| 189 | B1 | 1 | 0 | 1, 6 | 0 | 1 | 7 | 2 |
| 190 | B1 | 1 | 0 | 4, 9 | 0 | 1 | 7 | 2 |
| 191 | B1 | 1 | 0 | 1 | 0 | 2 | 7 | 2 |
| 192 | B1 | 1 | 0 | 7 | 0 | 2 | 7 | 2 |
| 193 | B1 | 1 | 0 | 2, 7 | 0 | 2 | 7 | 2 |
| 194 | B1 | 1 | 0 | 1, 4, 7 | 0 | 2 | 7 | 2 |
| 195 | B1 | 1 | 0 | 0, 2, 4, | 0 | 2 | 7 | 2 |
| | | | | 6, 8 | | | | |
| 196 | B1 | 1 | 0 | 0, 1, 2, 3, 4, | 0 | 2 | 7 | 2 |
| | | | | 5, 6, 7, 8, 9 | | | | |
| 197 | B1 | 1 | 0 | 1, 3, 5, | 0 | 2 | 7 | 2 |
| | | | | 7, 9 | | | | |
| 198 | B4 | 16 | 0 | 4, 9 | 0 | 2 | 1 | 12 |
| 199 | B4 | 16 | 1 | 4 | 0 | 2 | 1 | 12 |
| 200 | B4 | 8 | 0 | 4, 9 | 0 | 2 | 1 | 12 |
| 201 | B4 | 8 | 1 | 4 | 0 | 2 | 1 | 12 |
| 202 | B4 | 4 | 0 | 4, 9 | 0 | 2 | 1 | 12 |
| 203 | B4 | 4 | 0 | 4 | 0 | 2 | 1 | 12 |
| 204 | B4 | 4 | 1 | 4, 9 | 0 | 2 | 1 | 12 |
| 205 | B4 | 2 | 0 | 4, 9 | 0 | 2 | 1 | 12 |
| 206 | B4 | 2 | 0 | 1 | 0 | 2 | 1 | 12 |
| 207 | B4 | 2 | 0 | 4 | 0 | 2 | 1 | 12 |
| 208 | B4 | 2 | 0 | 7 | 0 | 2 | 1 | 12 |
| 209 | B4 | 1 | 0 | 1 | 0 | 2 | 1 | 12 |
| 210 | B4 | 1 | 0 | 4 | 0 | 2 | 1 | 12 |
| 211 | B4 | 1 | 0 | 7 | 0 | 2 | 1 | 12 |
| 212 | B4 | 1 | 0 | 1, 6 | 0 | 2 | 1 | 12 |
| 213 | B4 | 1 | 0 | 2, 7 | 0 | 2 | 1 | 12 |
| 214 | B4 | 1 | 0 | 4, 9 | 0 | 2 | 1 | 12 |
| 215 | B4 | 1 | 0 | 1, 4, 7 | 0 | 2 | 1 | 12 |
| 216 | B4 | 1 | 0 | 0, 2, 4, | 0 | 2 | 1 | 12 |
| | | | | 6, 8 | | | | |
| 217 | B4 | 1 | 0 | 0, 1, 2, 3, 4, | 0 | 2 | 1 | 12 |
| | | | | 5, 6, 7, 8, 9 | | | | |
| 218 | B4 | 1 | 0 | 1, 3, 5, | 0 | 2 | 1 | 12 |
| | | | | 7, 9 | | | | |
| 219 | C0 | 8 | 1 | 4 | 0 | 2 | 7 | 2 |
| 220 | C0 | 4 | 1 | 4, 9 | 0 | 1 | 7 | 2 |
| 221 | C0 | 4 | 0 | 4 | 0 | 2 | 7 | 2 |
| 222 | C0 | 2 | 0 | 4, 9 | 0 | 1 | 7 | 2 |
| 223 | C0 | 2 | 0 | 1 | 0 | 2 | 7 | 2 |
| 224 | C0 | 2 | 0 | 4 | 0 | 2 | 7 | 2 |
| 225 | C0 | 2 | 0 | 7 | 0 | 2 | 7 | 2 |
| 226 | C0 | 1 | 0 | 4 | 0 | 1 | 7 | 2 |
| 227 | C0 | 1 | 0 | 1, 6 | 0 | 1 | 7 | 2 |
| 228 | C0 | 1 | 0 | 4, 9 | 0 | 1 | 7 | 2 |
| 229 | C0 | 1 | 0 | 1 | 0 | 2 | 7 | 2 |
| 230 | C0 | 1 | 0 | 7 | 0 | 2 | 7 | 2 |
| 231 | C0 | 1 | 0 | 2, 7 | 0 | 2 | 7 | 2 |
| 232 | C0 | 1 | 0 | 1, 4, 7 | 0 | 2 | 7 | 2 |
| 233 | C0 | 1 | 0 | 0, 2, 4, | 0 | 2 | 7 | 2 |
| | | | | 6, 8 | | | | |
| 234 | C0 | 1 | 0 | 0, 1, 2, 3, 4, | 0 | 2 | 7 | 2 |
| | | | | 5, 6, 7, 8, 9 | | | | |
| 235 | C0 | 1 | 0 | 1, 3, 5, | 0 | 2 | 7 | 2 |
| | | | | 7, 9 | | | | |
| 236 | C2 | 16 | 1 | 4, 9 | 0 | 1 | 2 | 6 |
| 237 | C2 | 16 | 1 | 4 | 0 | 2 | 2 | 6 |
| 238 | C2 | 8 | 1 | 4, 9 | 0 | 1 | 2 | 6 |
| 239 | C2 | 8 | 1 | 4 | 0 | 2 | 2 | 6 |
| 240 | C2 | 4 | 0 | 4, 9 | 0 | 1 | 2 | 6 |
| 241 | C2 | 4 | 0 | 4 | 0 | 2 | 2 | 6 |
| 242 | C2 | 2 | 1 | 2, 6, 9 | 0 | 2 | 2 | 6 |
| 243 | C2 | 2 | 0 | 1 | 0 | 2 | 2 | 6 |
| 244 | C2 | 2 | 0 | 4 | 0 | 2 | 2 | 6 |
| 245 | C2 | 2 | 0 | 7 | 0 | 2 | 2 | 6 |
| 246 | C2 | 1 | 0 | 4 | 0 | 1 | 2 | 6 |
| 247 | C2 | 1 | 0 | 1, 6 | 0 | 1 | 2 | 6 |
| 248 | C2 | 1 | 0 | 4, 9 | 0 | 1 | 2 | 6 |
| 249 | C2 | 1 | 0 | 1 | 0 | 2 | 2 | 6 |
| 250 | C2 | 1 | 0 | 7 | 0 | 2 | 2 | 6 |
| 251 | C2 | 1 | 0 | 2, 7 | 0 | 2 | 2 | 6 |
| 252 | C2 | 1 | 0 | 1, 4, 7 | 0 | 2 | 2 | 6 |
| 253 | C2 | 1 | 0 | 0, 2, 4, | 0 | 2 | 2 | 6 |
| | | | | 6, 8 | | | | |
| 254 | C2 | 1 | 0 | 0, 1, 2, 3, 4, | 0 | 2 | 2 | 6 |
| | | | | 5, 6, 7, 8, 9 | | | | |
| 255 | C2 | 1 | 0 | 1, 3, 5, | 0 | 2 | 2 | 6 |
| | | | | 7, 9 | | | | |

TABLE 6.3.3.2-3
Random access configurations for FR1 and unpaired spectrum.

| | | | | | | | Nₜ^{RA, slot}, | |
|---|---|---|---|---|---|---|---|---|
| | | | | | | | number of | |
| | | | | | | | time- | |
| | | | | | | | domain | |
| | | | | | | Number of | PRACH | |
| PRACH | | | | | | PRACH slots | occasions | N_{dur}^{RA}, |
| Configuration | Preamble | N_{SFN} mod x = y | | Subframe | Starting | within a | within a | PRACH |
| Index | format | x | y | number | symbol | subframe | PRACH slot | duration |
| 0 | 0 | 16 | 1 | 9 | 0 | — | — | 0 |
| 1 | 0 | 8 | 1 | 9 | 0 | — | — | 0 |
| 2 | 0 | 4 | 1 | 9 | 0 | — | — | 0 |
| 3 | 0 | 2 | 0 | 9 | 0 | — | — | 0 |
| 4 | 0 | 2 | 1 | 9 | 0 | — | — | 0 |
| 5 | 0 | 2 | 0 | 4 | 0 | — | — | 0 |
| 6 | 0 | 2 | 1 | 4 | 0 | — | — | 0 |
| 7 | 0 | 1 | 0 | 9 | 0 | — | — | 0 |
| 8 | 0 | 1 | 0 | 8 | 0 | — | — | 0 |
| 9 | 0 | 1 | 0 | 7 | 0 | — | — | 0 |
| 10 | 0 | 1 | 0 | 6 | 0 | — | — | 0 |
| 11 | 0 | 1 | 0 | 5 | 0 | — | — | 0 |
| 12 | 0 | 1 | 0 | 4 | 0 | — | — | 0 |
| 13 | 0 | 1 | 0 | 3 | 0 | — | — | 0 |
| 14 | 0 | 1 | 0 | 2 | 0 | — | — | 0 |
| 15 | 0 | 1 | 0 | 1, 6 | 0 | — | — | 0 |
| 16 | 0 | 1 | 0 | 1, 6 | 7 | — | — | 0 |
| 17 | 0 | 1 | 0 | 4, 9 | 0 | — | — | 0 |
| 18 | 0 | 1 | 0 | 3, 8 | 0 | — | — | 0 |
| 19 | 0 | 1 | 0 | 2, 7 | 0 | — | — | 0 |
| 20 | 0 | 1 | 0 | 8, 9 | 0 | — | — | 0 |
| 21 | 0 | 1 | 0 | 4, 8, 9 | 0 | — | — | 0 |
| 22 | 0 | 1 | 0 | 3, 4, 9 | 0 | — | — | 0 |
| 23 | 0 | 1 | 0 | 7, 8, 9 | 0 | — | — | 0 |
| 24 | 0 | 1 | 0 | 3, 4, 8, 9 | 0 | — | — | 0 |
| 25 | 0 | 1 | 0 | 6, 7, 8, 9 | 0 | — | — | 0 |
| 26 | 0 | 1 | 0 | 1, 4, 6, 9 | 0 | — | — | 0 |
| 27 | 0 | 1 | 0 | 1, 3, 5, | 0 | — | — | 0 |
| | | | | 7, 9 | | | | |
| 28 | 1 | 16 | 1 | 7 | 0 | — | — | 0 |
| 29 | 1 | 8 | 1 | 7 | 0 | — | — | 0 |
| 30 | 1 | 4 | 1 | 7 | 0 | — | — | 0 |
| 31 | 1 | 2 | 0 | 7 | 0 | — | — | 0 |
| 32 | 1 | 2 | 1 | 7 | 0 | — | — | 0 |
| 33 | 1 | 1 | 0 | 7 | 0 | — | — | 0 |
| 34 | 2 | 16 | 1 | 6 | 0 | — | — | 0 |
| 35 | 2 | 8 | 1 | 6 | 0 | — | — | 0 |
| 36 | 2 | 4 | 1 | 6 | 0 | — | — | 0 |
| 37 | 2 | 2 | 0 | 6 | 7 | — | — | 0 |
| 38 | 2 | 2 | 1 | 6 | 7 | — | — | 0 |
| 39 | 2 | 1 | 0 | 6 | 7 | — | — | 0 |
| 40 | 3 | 16 | 1 | 9 | 0 | — | — | 0 |
| 41 | 3 | 8 | 1 | 9 | 0 | — | — | 0 |
| 42 | 3 | 4 | 1 | 9 | 0 | — | — | 0 |
| 43 | 3 | 2 | 0 | 9 | 0 | — | — | 0 |
| 44 | 3 | 2 | 1 | 9 | 0 | — | — | 0 |
| 45 | 3 | 2 | 0 | 4 | 0 | — | — | 0 |
| 46 | 3 | 2 | 1 | 4 | 0 | — | — | 0 |
| 47 | 3 | 1 | 0 | 9 | 0 | — | — | 0 |
| 48 | 3 | 1 | 0 | 8 | 0 | — | — | 0 |
| 49 | 3 | 1 | 0 | 7 | 0 | — | — | 0 |
| 50 | 3 | 1 | 0 | 6 | 0 | — | — | 0 |
| 51 | 3 | 1 | 0 | 5 | 0 | — | — | 0 |
| 52 | 3 | 1 | 0 | 4 | 0 | — | — | 0 |
| 53 | 3 | 1 | 0 | 3 | 0 | — | — | 0 |
| 54 | 3 | 1 | 0 | 2 | 0 | — | — | 0 |
| 55 | 3 | 1 | 0 | 1, 6 | 0 | — | — | 0 |
| 56 | 3 | 1 | 0 | 1, 6 | 7 | — | — | 0 |
| 57 | 3 | 1 | 0 | 4, 9 | 0 | — | — | 0 |
| 58 | 3 | 1 | 0 | 3, 8 | 0 | — | — | 0 |
| 59 | 3 | 1 | 0 | 2, 7 | 0 | — | — | 0 |
| 60 | 3 | 1 | 0 | 8, 9 | 0 | — | — | 0 |
| 61 | 3 | 1 | 0 | 4, 8, 9 | 0 | — | — | 0 |
| 62 | 3 | 1 | 0 | 3, 4, 9 | 0 | — | — | 0 |
| 63 | 3 | 1 | 0 | 7, 8, 9 | 0 | — | — | 0 |
| 64 | 3 | 1 | 0 | 3, 4, 8, 9 | 0 | — | — | 0 |
| 65 | 3 | 1 | 0 | 1, 4, 6, 9 | 0 | — | — | 0 |
| 66 | 3 | 1 | 0 | 1, 3, 5, | 0 | — | — | 0 |
| | | | | 7, 9 | | | | |
| 67 | A1 | 16 | 1 | 9 | 0 | 2 | 6 | 2 |
| 68 | A1 | 8 | 1 | 9 | 0 | 2 | 6 | 2 |
| 69 | A1 | 4 | 1 | 9 | 0 | 1 | 6 | 2 |
| 70 | A1 | 2 | 1 | 9 | 0 | 1 | 6 | 2 |
| 71 | A1 | 2 | 1 | 4, 9 | 7 | 1 | 3 | 2 |
| 72 | A1 | 2 | 1 | 7, 9 | 7 | 1 | 3 | 2 |
| 73 | A1 | 2 | 1 | 7, 9 | 0 | 1 | 6 | 2 |
| 74 | A1 | 2 | 1 | 8, 9 | 0 | 2 | 6 | 2 |
| 75 | A1 | 2 | 1 | 4, 9 | 0 | 2 | 6 | 2 |
| 76 | A1 | 2 | 1 | 2, 3, 4, | 0 | 1 | 6 | 2 |
| | | | | 7, 8, 9 | | | | |
| 77 | A1 | 1 | 0 | 9 | 0 | 2 | 6 | 2 |
| 78 | A1 | 1 | 0 | 9 | 7 | 1 | 3 | 2 |
| 79 | A1 | 1 | 0 | 9 | 0 | 1 | 6 | 2 |
| 80 | A1 | 1 | 0 | 8, 9 | 0 | 2 | 6 | 2 |
| 81 | A1 | 1 | 0 | 4, 9 | 0 | 1 | 6 | 2 |
| 82 | A1 | 1 | 0 | 7, 9 | 7 | 1 | 3 | 2 |
| 83 | A1 | 1 | 0 | 3, 4, 8, 9 | 0 | 1 | 6 | 2 |
| 84 | A1 | 1 | 0 | 3, 4, 8, 9 | 0 | 2 | 6 | 2 |
| 85 | A1 | 1 | 0 | 1, 3, 5, | 0 | 1 | 6 | 2 |
| | | | | 7, 9 | | | | |
| 86 | A1 | 1 | 0 | 0, 1, 2, 3, 4, | 7 | 1 | 3 | 2 |
| | | | | 5, 6, 7, 8, 9 | | | | |
| 87 | A2 | 16 | 1 | 9 | 0 | 2 | 3 | 4 |
| 88 | A2 | 8 | 1 | 9 | 0 | 2 | 3 | 4 |
| 89 | A2 | 4 | 1 | 9 | 0 | 1 | 3 | 4 |
| 90 | A2 | 2 | 1 | 7, 9 | 0 | 1 | 3 | 4 |
| 91 | A2 | 2 | 1 | 8, 9 | 0 | 2 | 3 | 4 |
| 92 | A2 | 2 | 1 | 7, 9 | 9 | 1 | 1 | 4 |
| 93 | A2 | 2 | 1 | 4, 9 | 9 | 1 | 1 | 4 |
| 94 | A2 | 2 | 1 | 4, 9 | 0 | 2 | 3 | 4 |
| 95 | A2 | 2 | 1 | 2, 3, 4, | 0 | 1 | 3 | 4 |
| | | | | 7, 8, 9 | | | | |
| 96 | A2 | 1 | 0 | 2 | 0 | 1 | 3 | 4 |
| 97 | A2 | 1 | 0 | 7 | 0 | 1 | 3 | 4 |
| 98 | A2 | 2 | 1 | 9 | 0 | 1 | 3 | 4 |
| 99 | A2 | 1 | 0 | 9 | 0 | 2 | 3 | 4 |
| 100 | A2 | 1 | 0 | 9 | 9 | 1 | 1 | 4 |
| 101 | A2 | 1 | 0 | 9 | 0 | 1 | 3 | 4 |
| 102 | A2 | 1 | 0 | 2, 7 | 0 | 1 | 3 | 4 |
| 103 | A2 | 1 | 0 | 8, 9 | 0 | 2 | 3 | 4 |
| 104 | A2 | 1 | 0 | 4, 9 | 0 | 1 | 3 | 4 |
| 105 | A2 | 1 | 0 | 7, 9 | 9 | 1 | 1 | 4 |
| 106 | A2 | 1 | 0 | 3, 4, 8, 9 | 0 | 1 | 3 | 4 |
| 107 | A2 | 1 | 0 | 3, 4, 8, 9 | 0 | 2 | 3 | 4 |
| 108 | A2 | 1 | 0 | 1, 3, 5, | 0 | 1 | 3 | 4 |
| | | | | 7, 9 | | | | |
| 109 | A2 | 1 | 0 | 0, 1, 2, 3, 4, | 9 | 1 | 1 | 4 |
| | | | | 5, 6, 7, 8, 9 | | | | |
| 110 | A3 | 16 | 1 | 9 | 0 | 2 | 2 | 6 |
| 111 | A3 | 8 | 1 | 9 | 0 | 2 | 2 | 6 |
| 112 | A3 | 4 | 1 | 9 | 0 | 1 | 2 | 6 |
| 113 | A3 | 2 | 1 | 4, 9 | 7 | 1 | 1 | 6 |
| 114 | A3 | 2 | 1 | 7, 9 | 7 | 1 | 1 | 6 |
| 115 | A3 | 2 | 1 | 7, 9 | 0 | 1 | 2 | 6 |
| 116 | A3 | 2 | 1 | 4, 9 | 0 | 2 | 2 | 6 |
| 117 | A3 | 2 | 1 | 8, 9 | 0 | 2 | 2 | 6 |
| 118 | A3 | 2 | 1 | 2, 3, 4, | 0 | 1 | 2 | 6 |
| | | | | 7, 8, 9 | | | | |
| 119 | A3 | 1 | 0 | 2 | 0 | 1 | 2 | 6 |
| 120 | A3 | 1 | 0 | 7 | 0 | 1 | 2 | 6 |
| 121 | A3 | 2 | 1 | 9 | 0 | 1 | 2 | 6 |
| 122 | A3 | 1 | 0 | 9 | 0 | 2 | 2 | 6 |
| 123 | A3 | 1 | 0 | 9 | 7 | 1 | 1 | 6 |
| 124 | A3 | 1 | 0 | 9 | 0 | 1 | 2 | 6 |
| 125 | A3 | 1 | 0 | 2, 7 | 0 | 1 | 2 | 6 |
| 126 | A3 | 1 | 0 | 8, 9 | 0 | 2 | 2 | 6 |
| 127 | A3 | 1 | 0 | 4, 9 | 0 | 1 | 2 | 6 |
| 128 | A3 | 1 | 0 | 7, 9 | 7 | 1 | 1 | 6 |
| 129 | A3 | 1 | 0 | 3, 4, 8, 9 | 0 | 1 | 2 | 6 |
| 130 | A3 | 1 | 0 | 3, 4, 8, 9 | 0 | 2 | 2 | 6 |
| 131 | A3 | 1 | 0 | 1, 3, 5, | 0 | 1 | 2 | 6 |
| | | | | 7, 9 | | | | |
| 132 | A3 | 1 | 0 | 0, 1, 2, 3, 4, | 7 | 1 | 1 | 6 |
| | | | | 5, 6, 7, 8, 9 | | | | |
| 133 | B1 | 4 | 1 | 9 | 2 | 1 | 6 | 2 |
| 134 | B1 | 2 | 1 | 9 | 2 | 1 | 6 | 2 |
| 135 | B1 | 2 | 1 | 7, 9 | 2 | 1 | 6 | 2 |
| 136 | B1 | 2 | 1 | 4, 9 | 8 | 1 | 3 | 2 |
| 137 | B1 | 2 | 1 | 4, 9 | 2 | 2 | 6 | 2 |
| 138 | B1 | 1 | 0 | 9 | 2 | 2 | 6 | 2 |
| 139 | B1 | 1 | 0 | 9 | 8 | 1 | 3 | 2 |
| 140 | B1 | 1 | 0 | 9 | 2 | 1 | 6 | 2 |
| 141 | B1 | 1 | 0 | 8, 9 | 2 | 2 | 6 | 2 |
| 142 | B1 | 1 | 0 | 4, 9 | 2 | 1 | 6 | 2 |
| 143 | B1 | 1 | 0 | 7, 9 | 8 | 1 | 3 | 2 |
| 144 | B1 | 1 | 0 | 1, 3, 5, | 2 | 1 | 6 | 2 |
| | | | | 7, 9 | | | | |
| 145 | B4 | 16 | 1 | 9 | 0 | 2 | 1 | 12 |
| 146 | B4 | 8 | 1 | 9 | 0 | 2 | 1 | 12 |
| 147 | B4 | 4 | 1 | 9 | 2 | 1 | 1 | 12 |
| 148 | B4 | 2 | 1 | 9 | 0 | 1 | 1 | 12 |
| 149 | B4 | 2 | 1 | 9 | 2 | 1 | 1 | 12 |
| 150 | B4 | 2 | 1 | 7, 9 | 2 | 1 | 1 | 12 |
| 151 | B4 | 2 | 1 | 4, 9 | 2 | 1 | 1 | 12 |
| 152 | B4 | 2 | 1 | 4, 9 | 0 | 2 | 1 | 12 |
| 153 | B4 | 2 | 1 | 8, 9 | 0 | 2 | 1 | 12 |
| 154 | B4 | 2 | 1 | 2, 3, 4, | 0 | 1 | 1 | 12 |
| | | | | 7, 8, 9 | | | | |
| 155 | B4 | 1 | 0 | 1 | 0 | 1 | 1 | 12 |
| 156 | B4 | 1 | 0 | 2 | 0 | 1 | 1 | 12 |
| 157 | B4 | 1 | 0 | 4 | 0 | 1 | 1 | 12 |
| 158 | B4 | 1 | 0 | 7 | 0 | 1 | 1 | 12 |
| 159 | B4 | 1 | 0 | 9 | 0 | 1 | 1 | 12 |
| 160 | B4 | 1 | 0 | 9 | 2 | 1 | 1 | 12 |
| 161 | B4 | 1 | 0 | 9 | 0 | 2 | 1 | 12 |
| 162 | B4 | 1 | 0 | 4, 9 | 2 | 1 | 1 | 12 |
| 163 | B4 | 1 | 0 | 7, 9 | 2 | 1 | 1 | 12 |
| 164 | B4 | 1 | 0 | 8, 9 | 0 | 2 | 1 | 12 |
| 165 | B4 | 1 | 0 | 3, 4, 8, 9 | 2 | 1 | 1 | 12 |
| 166 | B4 | 1 | 0 | 1, 3, 5, | 2 | 1 | 1 | 12 |
| | | | | 7, 9 | | | | |
| 167 | B4 | 1 | 0 | 0, 1, 2, 3, 4, | 0 | 2 | 1 | 12 |
| | | | | 5, 6, 7, 8, 9 | | | | |
| 168 | B4 | 1 | 0 | 0, 1, 2, 3, 4, | 2 | 1 | 1 | 12 |
| | | | | 5, 6, 7, 8, 9 | | | | |
| 169 | C0 | 16 | 1 | 9 | 2 | 2 | 6 | 2 |
| 170 | C0 | 8 | 1 | 9 | 2 | 2 | 6 | 2 |
| 171 | C0 | 4 | 1 | 9 | 2 | 1 | 6 | 2 |
| 172 | C0 | 2 | 1 | 9 | 2 | 1 | 6 | 2 |
| 173 | C0 | 2 | 1 | 8, 9 | 2 | 2 | 6 | 2 |
| 174 | C0 | 2 | 1 | 7, 9 | 2 | 1 | 6 | 2 |
| 175 | C0 | 2 | 1 | 7, 9 | 8 | 1 | 3 | 2 |
| 176 | C0 | 2 | 1 | 4, 9 | 8 | 1 | 3 | 2 |
| 177 | C0 | 2 | 1 | 4, 9 | 2 | 2 | 6 | 2 |
| 178 | C0 | 2 | 1 | 2, 3, 4, | 2 | 1 | 6 | 2 |
| | | | | 7, 8, 9 | | | | |
| 179 | C0 | 1 | 0 | 9 | 2 | 2 | 6 | 2 |
| 180 | C0 | 1 | 0 | 9 | 8 | 1 | 3 | 2 |
| 181 | C0 | 1 | 0 | 9 | 2 | 1 | 6 | 2 |
| 182 | C0 | 1 | 0 | 8, 9 | 2 | 2 | 6 | 2 |
| 183 | C0 | 1 | 0 | 4, 9 | 2 | 1 | 6 | 2 |
| 184 | C0 | 1 | 0 | 7, 9 | 8 | 1 | 3 | 2 |
| 185 | C0 | 1 | 0 | 3, 4, 8, 9 | 2 | 1 | 6 | 2 |
| 186 | C0 | 1 | 0 | 3, 4, 8, 9 | 2 | 2 | 6 | 2 |
| 187 | C0 | 1 | 0 | 1, 3, 5, | 2 | 1 | 6 | 2 |
| | | | | 7, 9 | | | | |
| 188 | C0 | 1 | 0 | 0, 1, 2, 3, 4, | 8 | 1 | 3 | 2 |
| | | | | 5, 6, 7, 8, 9 | | | | |
| 189 | C2 | 16 | 1 | 9 | 2 | 2 | 2 | 6 |
| 190 | C2 | 8 | 1 | 9 | 2 | 2 | 2 | 6 |
| 191 | C2 | 4 | 1 | 9 | 2 | 1 | 2 | 6 |
| 192 | C2 | 2 | 1 | 9 | 2 | 1 | 2 | 6 |
| 193 | C2 | 2 | 1 | 8, 9 | 2 | 2 | 2 | 6 |
| 194 | C2 | 2 | 1 | 7, 9 | 2 | 1 | 2 | 6 |
| 195 | C2 | 2 | 1 | 7, 9 | 8 | 1 | 1 | 6 |
| 196 | C2 | 2 | 1 | 4, 9 | 8 | 1 | 1 | 6 |
| 197 | C2 | 2 | 1 | 4, 9 | 2 | 2 | 2 | 6 |
| 198 | C2 | 2 | 1 | 2, 3, 4, | 2 | 1 | 2 | 6 |
| | | | | 7, 8, 9 | | | | |
| 199 | C2 | 8 | 1 | 9 | 8 | 2 | 1 | 6 |
| 200 | C2 | 4 | 1 | 9 | 8 | 1 | 1 | 6 |
| 201 | C2 | 1 | 0 | 9 | 2 | 2 | 2 | 6 |
| 202 | C2 | 1 | 0 | 9 | 8 | 1 | 1 | 6 |
| 203 | C2 | 1 | 0 | 9 | 2 | 1 | 2 | 6 |
| 204 | C2 | 1 | 0 | 8, 9 | 2 | 2 | 2 | 6 |
| 205 | C2 | 1 | 0 | 4, 9 | 2 | 1 | 2 | 6 |
| 206 | C2 | 1 | 0 | 7, 9 | 8 | 1 | 1 | 6 |
| 207 | C2 | 1 | 0 | 3, 4, 8, 9 | 2 | 1 | 2 | 6 |
| 208 | C2 | 1 | 0 | 3, 4, 8, 9 | 2 | 2 | 2 | 6 |
| 209 | C2 | 1 | 0 | 1, 3, 5, | 2 | 1 | 2 | 6 |
| | | | | 7, 9 | | | | |
| 210 | C2 | 1 | 0 | 0, 1, 2, 3, 4, | 8 | 1 | 1 | 6 |
| | | | | 5, 6, 7, 8, 9 | | | | |
| 211 | A1/B1 | 2 | 1 | 9 | 2 | 1 | 6 | 2 |
| 212 | A1/B1 | 2 | 1 | 4, 9 | 8 | 1 | 3 | 2 |
| 213 | A1/B1 | 2 | 1 | 7, 9 | 8 | 1 | 3 | 2 |
| 214 | A1/B1 | 2 | 1 | 7, 9 | 2 | 1 | 6 | 2 |
| 215 | A1/B1 | 2 | 1 | 4, 9 | 2 | 2 | 6 | 2 |
| 216 | A1/B1 | 2 | 1 | 8, 9 | 2 | 2 | 6 | 2 |
| 217 | A1/B1 | 1 | 0 | 9 | 2 | 2 | 6 | 2 |
| 218 | A1/B1 | 1 | 0 | 9 | 8 | 1 | 3 | 2 |
| 219 | A1/B1 | 1 | 0 | 9 | 2 | 1 | 6 | 2 |
| 220 | A1/B1 | 1 | 0 | 8, 9 | 2 | 2 | 6 | 2 |
| 221 | A1/B1 | 1 | 0 | 4, 9 | 2 | 1 | 6 | 2 |
| 222 | A1/B1 | 1 | 0 | 7, 9 | 8 | 1 | 3 | 2 |
| 223 | A1/B1 | 1 | 0 | 3, 4, 8, 9 | 2 | 2 | 6 | 2 |
| 224 | A1/B1 | 1 | 0 | 1, 3, 5, | 2 | 1 | 6 | 2 |
| | | | | 7, 9 | | | | |
| 225 | A1/B1 | 1 | 0 | 0, 1, 2, 3, 4, | 8 | 1 | 3 | 2 |
| | | | | 5, 6, 7, 8, 9 | | | | |
| 226 | A2/B2 | 2 | 1 | 9 | 0 | 1 | 3 | 4 |
| 227 | A2/B2 | 2 | 1 | 4, 9 | 6 | 1 | 2 | 4 |
| 228 | A2/B2 | 2 | 1 | 7, 9 | 6 | 1 | 2 | 4 |
| 229 | A2/B2 | 2 | 1 | 4, 9 | 0 | 2 | 3 | 4 |
| 230 | A2/B2 | 2 | 1 | 8, 9 | 0 | 2 | 3 | 4 |
| 231 | A2/B2 | 1 | 0 | 9 | 0 | 2 | 3 | 4 |
| 232 | A2/B2 | 1 | 0 | 9 | 6 | 1 | 2 | 4 |
| 233 | A2/B2 | 1 | 0 | 9 | 0 | 1 | 3 | 4 |
| 234 | A2/B2 | 1 | 0 | 8, 9 | 0 | 2 | 3 | 4 |
| 235 | A2/B2 | 1 | 0 | 4, 9 | 0 | 1 | 3 | 4 |
| 236 | A2/B2 | 1 | 0 | 7, 9 | 6 | 1 | 2 | 4 |
| 237 | A2/B2 | 1 | 0 | 3, 4, 8, 9 | 0 | 1 | 3 | 4 |
| 238 | A2/B2 | 1 | 0 | 3, 4, 8, 9 | 0 | 2 | 3 | 4 |
| 239 | A2/B2 | 1 | 0 | 1, 3, 5, | 0 | 1 | 3 | 4 |
| | | | | 7, 9 | | | | |
| 240 | A2/B2 | 1 | 0 | 0, 1, 2, 3, 4, | 6 | 1 | 2 | 4 |
| | | | | 5, 6, 7, 8, 9 | | | | |
| 241 | A3/B3 | 2 | 1 | 9 | 0 | 1 | 2 | 6 |
| 242 | A3/B3 | 2 | 1 | 4, 9 | 2 | 1 | 2 | 6 |
| 243 | A3/B3 | 2 | 1 | 7, 9 | 0 | 1 | 2 | 6 |
| 244 | A3/B3 | 2 | 1 | 7, 9 | 2 | 1 | 2 | 6 |
| 245 | A3/B3 | 2 | 1 | 4, 9 | 0 | 2 | 2 | 6 |
| 246 | A3/B3 | 2 | 1 | 8, 9 | 0 | 2 | 2 | 6 |
| 247 | A3/B3 | 1 | 0 | 9 | 0 | 2 | 2 | 6 |
| 248 | A3/B3 | 1 | 0 | 9 | 2 | 1 | 2 | 6 |
| 249 | A3/B3 | 1 | 0 | 9 | 0 | 1 | 2 | 6 |
| 250 | A3/B3 | 1 | 0 | 8, 9 | 0 | 2 | 2 | 6 |
| 251 | A3/B3 | 1 | 0 | 4, 9 | 0 | 1 | 2 | 6 |
| 252 | A3/B3 | 1 | 0 | 7, 9 | 2 | 1 | 2 | 6 |
| 253 | A3/B3 | 1 | 0 | 3, 4, 8, 9 | 0 | 2 | 2 | 6 |
| 254 | A3/B3 | 1 | 0 | 1, 3, 5, | 0 | 1 | 2 | 6 |
| | | | | 7, 9 | | | | |
| 255 | A3/B3 | 1 | 0 | 0, 1, 2, 3, 4, | 2 | 1 | 2 | 6 |
| | | | | 5, 6, 7, 8, 9 | | | | |
| 256 | 0 | 16 | 1 | 7 | 0 | — | — | 0 |
| 257 | 0 | 8 | 1 | 7 | 0 | — | — | 0 |
| 258 | 0 | 4 | 1 | 7 | 0 | — | — | 0 |
| 259 | 0 | 2 | 0 | 7 | 0 | — | — | 0 |
| 260 | 0 | 2 | 1 | 7 | 0 | — | — | 0 |
| 261 | 0 | 2 | 0 | 2 | 0 | — | — | 0 |
| 262 | 0 | 2 | 1 | 2 | 0 | — | — | 0 |

TABLE 6.3.3.2-4
Random access configurations for FR2 and unpaired spectrum.

| | | | | | | | Nₜ^{RA, slot}, | |
|---|---|---|---|---|---|---|---|---|
| | | | | | | | number of | |
| | | | | | | | time- | |
| | | | | | | Number of | domain | |
| | | | | | | PRACH slots | PRACH | |
| PRACH | | | | | | within a | occasions | N_{dur}^{RA}, |
| Config. | Preamble | n_{SFN} mod x = y | | Slot | Starting | 60 kHz | within a | PRACH |
| Index | format | x | y | number | symbol | slot | PRACH slot | duration |
| 0 | A1 | 16 | 1 | 4, 9, 14, 19, 24, | 0 | 2 | 6 | 2 |
| | | | | 29, 34, 39 | | | | |
| 1 | A1 | 16 | 1 | 3, 7, 11, 15, 19, | 0 | 1 | 6 | 2 |
| | | | | 23, 27, 31, 35, 39 | | | | |
| 2 | A1 | 8 | 1, 2 | 9, 19, 29, 39 | 0 | 2 | 6 | 2 |
| 3 | A1 | 8 | 1 | 4, 9, 14, 19, 24, | 0 | 2 | 6 | 2 |
| | | | | 29, 34, 39 | | | | |
| 4 | A1 | 8 | 1 | 3, 7, 11, 15, 19, | 0 | 1 | 6 | 2 |
| | | | | 23, 27, 31, 35, 39 | | | | |
| 5 | A1 | 4 | 1 | 4, 9, 14, 19, 24, | 0 | 1 | 6 | 2 |
| | | | | 29, 34, 39 | | | | |
| 6 | A1 | 4 | 1 | 4, 9, 14, 19, 24, | 0 | 2 | 6 | 2 |
| | | | | 29, 34, 39 | | | | |
| 7 | A1 | 4 | 1 | 3, 7, 11, 15, 19, | 0 | 1 | 6 | 2 |
| | | | | 23, 27, 31, 35, 39 | | | | |
| 8 | A1 | 2 | 1 | 7, 15, 23, 31, 39 | 0 | 2 | 6 | 2 |
| 9 | A1 | 2 | 1 | 4, 9, 14, 19, 24, | 0 | 1 | 6 | 2 |
| | | | | 29, 34, 39 | | | | |
| 10 | A1 | 2 | 1 | 4, 9, 14, 19, 24, | 0 | 2 | 6 | 2 |
| | | | | 29, 34, 39 | | | | |
| 11 | A1 | 2 | 1 | 3, 7, 11, 15, 19, | 0 | 1 | 6 | 2 |
| | | | | 23, 27, 31, 35, 39 | | | | |
| 12 | A1 | 1 | 0 | 19, 39 | 7 | 1 | 3 | 2 |
| 13 | A1 | 1 | 0 | 3, 5, 7 | 0 | 1 | 6 | 2 |
| 14 | A1 | 1 | 0 | 24, 29, 34, 39 | 7 | 1 | 3 | 2 |
| 15 | A1 | 1 | 0 | 9, 19, 29, 39 | 7 | 2 | 3 | 2 |
| 16 | A1 | 1 | 0 | 17, 19, 37, 39 | 0 | 1 | 6 | 2 |
| 17 | A1 | 1 | 0 | 9, 19, 29, 39 | 0 | 2 | 6 | 2 |
| 18 | A1 | 1 | 0 | 4, 9, 14, 19, 24, | 0 | 1 | 6 | 2 |
| | | | | 29, 34, 39 | | | | |
| 19 | A1 | 1 | 0 | 4, 9, 14, 19, 24, | 7 | 1 | 3 | 2 |
| | | | | 29, 34, 39 | | | | |
| 20 | A1 | 1 | 0 | 3, 5, 7, 9, | 7 | 1 | 3 | 2 |
| | | | | 11, 13 | | | | |
| 21 | A1 | 1 | 0 | 23, 27, 31, | 7 | 1 | 3 | 2 |
| | | | | 35, 39 | | | | |
| 22 | A1 | 1 | 0 | 7, 15, 23, | 0 | 1 | 6 | 2 |
| | | | | 31, 39 | | | | |
| 23 | A1 | 1 | 0 | 23, 27, 31, | 0 | 1 | 6 | 2 |
| | | | | 35, 39 | | | | |
| 24 | A1 | 1 | 0 | 13, 14, 15, 29, 30, | 7 | 2 | 3 | 2 |
| | | | | 31, 37, 38, 39 | | | | |
| 25 | A1 | 1 | 0 | 3, 7, 11, 15, 19, | 7 | 1 | 3 | 2 |
| | | | | 23, 27, 31, 35, 39 | | | | |
| 26 | A1 | 1 | 0 | 3, 7, 11, 15, 19, | 0 | 1 | 6 | 2 |
| | | | | 23, 27, 31, 35, 39 | | | | |
| 27 | A1 | 1 | 0 | 1, 3, 5, 7, . . . , | 0 | 1 | 6 | 2 |
| | | | | 37, 39 | | | | |
| 28 | A1 | 1 | 0 | 0, 1, 2, . . . , 39 | 7 | 1 | 3 | 2 |
| 29 | A2 | 16 | 1 | 4, 9, 14, 19, 24, | 0 | 2 | 3 | 4 |
| | | | | 29, 34, 39 | | | | |
| 30 | A2 | 16 | 1 | 3, 7, 11, 15, 19, | 0 | 1 | 3 | 4 |
| | | | | 23, 27, 31, 35, 39 | | | | |
| 31 | A2 | 8 | 1 | 4, 9, 14, 19, 24, | 0 | 2 | 3 | 4 |
| | | | | 29, 34, 39 | | | | |
| 32 | A2 | 8 | 1 | 3, 7, 11, 15, 19, | 0 | 1 | 3 | 4 |
| | | | | 23, 27, 31, 35, 39 | | | | |
| 33 | A2 | 8 | 1, 2 | 9, 19, 29, 39 | 0 | 2 | 3 | 4 |
| 34 | A2 | 4 | 1 | 4, 9, 14, 19, 24, | 0 | 1 | 3 | 4 |
| | | | | 29, 34, 39 | | | | |
| 35 | A2 | 4 | 1 | 4, 9, 14, 19, 24, | 0 | 2 | 3 | 4 |
| | | | | 29, 34, 39 | | | | |
| 36 | A2 | 4 | 1 | 3, 7, 11, 15, 19, | 0 | 1 | 3 | 4 |
| | | | | 23, 27, 31, 35, 39 | | | | |
| 37 | A2 | 2 | 1 | 7, 15, 23, | 0 | 2 | 3 | 4 |
| | | | | 31, 39 | | | | |
| 38 | A2 | 2 | 1 | 4, 9, 14, 19, 24, | 0 | 1 | 3 | 4 |
| | | | | 29, 34, 39 | | | | |
| 39 | A2 | 2 | 1 | 4, 9, 14, 19, 24, | 0 | 2 | 3 | 4 |
| | | | | 29, 34, 39 | | | | |
| 40 | A2 | 2 | 1 | 3, 7, 11, 15, 19, | 0 | 1 | 3 | 4 |
| | | | | 23, 27, 31, 35, 39 | | | | |
| 41 | A2 | 1 | 0 | 19, 39 | 5 | 1 | 2 | 4 |
| 42 | A2 | 1 | 0 | 3, 5, 7 | 0 | 1 | 3 | 4 |
| 43 | A2 | 1 | 0 | 24, 29, 34, 39 | 5 | 1 | 2 | 4 |
| 44 | A2 | 1 | 0 | 9, 19, 29, 39 | 5 | 2 | 2 | 4 |
| 45 | A2 | 1 | 0 | 17, 19, 37, 39 | 0 | 1 | 3 | 4 |
| 46 | A2 | 1 | 0 | 9, 19, 29, 39 | 0 | 2 | 3 | 4 |
| 47 | A2 | 1 | 0 | 7, 15, 23, | 0 | 1 | 3 | 4 |
| | | | | 31, 39 | | | | |
| 48 | A2 | 1 | 0 | 23, 27, 31, | 5 | 1 | 2 | 4 |
| | | | | 35, 39 | | | | |
| 49 | A2 | 1 | 0 | 23, 27, 31, | 0 | 1 | 3 | 4 |
| | | | | 35, 39 | | | | |
| 50 | A2 | 1 | 0 | 3, 5, 7, 9, | 5 | 1 | 2 | 4 |
| | | | | 11, 13 | | | | |
| 51 | A2 | 1 | 0 | 3, 5, 7, 9, | 0 | 1 | 3 | 4 |
| | | | | 11, 13 | | | | |
| 52 | A2 | 1 | 0 | 4, 9, 14, 19, 24, | 5 | 1 | 2 | 4 |
| | | | | 29, 34, 39 | | | | |
| 53 | A2 | 1 | 0 | 4, 9, 14, 19, 24, | 0 | 1 | 3 | 4 |
| | | | | 29, 34, 39 | | | | |
| 54 | A2 | 1 | 0 | 13, 14, 15, 29, 30, | 5 | 2 | 2 | 4 |
| | | | | 31, 37, 38, 39 | | | | |
| 55 | A2 | 1 | 0 | 3, 7, 11, 15, 19, | 5 | 1 | 2 | 4 |
| | | | | 23, 27, 31, 35, 39 | | | | |
| 56 | A2 | 1 | 0 | 3, 7, 11, 15, 19, | 0 | 1 | 3 | 4 |
| | | | | 23, 27, 31, 35, 39 | | | | |
| 57 | A2 | 1 | 0 | 1, 3, 5, 7, . . . , | 0 | 1 | 3 | 4 |
| | | | | 37, 39 | | | | |
| 58 | A2 | 1 | 0 | 0, 1, 2, . . . , 39 | 5 | 1 | 2 | 4 |
| 59 | A3 | 16 | 1 | 4, 9, 14, 19, 24, | 0 | 2 | 2 | 6 |
| | | | | 29, 34, 39 | | | | |
| 60 | A3 | 16 | 1 | 3, 7, 11, 15, 19, | 0 | 1 | 2 | 6 |
| | | | | 23, 27, 31, 35, 39 | | | | |
| 61 | A3 | 8 | 1 | 4, 9, 14, 19, 24, | 0 | 2 | 2 | 6 |
| | | | | 29, 34, 39 | | | | |
| 62 | A3 | 8 | 1 | 3, 7, 11, 15, 19, | 0 | 1 | 2 | 6 |
| | | | | 23, 27, 31, 35, 39 | | | | |
| 63 | A3 | 8 | 1, 2 | 9, 19, 29, 39 | 0 | 2 | 2 | 6 |
| 64 | A3 | 4 | 1 | 4, 9, 14, 19, 24, | 0 | 1 | 2 | 6 |
| | | | | 29, 34, 39 | | | | |
| 65 | A3 | 4 | 1 | 4, 9, 14, 19, 24, | 0 | 2 | 2 | 6 |
| | | | | 29, 34, 39 | | | | |
| 66 | A3 | 4 | 1 | 3, 7, 11, 15, 19, | 0 | 1 | 2 | 6 |
| | | | | 23, 27, 31, 35, 39 | | | | |
| 67 | A3 | 2 | 1 | 4, 9, 14, 19, 24, | 0 | 1 | 2 | 6 |
| | | | | 29, 34, 39 | | | | |
| 68 | A3 | 2 | 1 | 4, 9, 14, 19, 24, | 0 | 2 | 2 | 6 |
| | | | | 29, 34, 39 | | | | |
| 69 | A3 | 2 | 1 | 3, 7, 11, 15, 19, | 0 | 1 | 2 | 6 |
| | | | | 23, 27, 31, 35, 39 | | | | |
| 70 | A3 | 1 | 0 | 19, 39 | 7 | 1 | 1 | 6 |
| 71 | A3 | 1 | 0 | 3, 5, 7 | 0 | 1 | 2 | 6 |
| 72 | A3 | 1 | 0 | 9, 11, 13 | 2 | 1 | 2 | 6 |
| 73 | A3 | 1 | 0 | 24, 29, 34, 39 | 7 | 1 | 1 | 6 |
| 74 | A3 | 1 | 0 | 9, 19, 29, 39 | 7 | 2 | 1 | 6 |
| 75 | A3 | 1 | 0 | 17, 19, 37, 39 | 0 | 1 | 2 | 6 |
| 76 | A3 | 1 | 0 | 9, 19, 29, 39 | 0 | 2 | 2 | 6 |
| 77 | A3 | 1 | 0 | 7, 15, 23, | 0 | 1 | 2 | 6 |
| | | | | 31, 39 | | | | |
| 78 | A3 | 1 | 0 | 23, 27, 31, | 7 | 1 | 1 | 6 |
| | | | | 35, 39 | | | | |
| 79 | A3 | 1 | 0 | 23, 27, 31, | 0 | 1 | 2 | 6 |
| | | | | 35, 39 | | | | |
| 80 | A3 | 1 | 0 | 3, 5, 7, 9, | 0 | 1 | 2 | 6 |
| | | | | 11, 13 | | | | |
| 81 | A3 | 1 | 0 | 3, 5, 7, 9, | 7 | 1 | 1 | 6 |
| | | | | 11, 13 | | | | |
| 82 | A3 | 1 | 0 | 4, 9, 14, 19, 24, | 0 | 1 | 2 | 6 |
| | | | | 29, 34, 39 | | | | |
| 83 | A3 | 1 | 0 | 4, 9, 14, 19, 24, | 7 | 1 | 1 | 6 |
| | | | | 29, 34, 39 | | | | |
| 84 | A3 | 1 | 0 | 13, 14, 15, 29, 30, | 7 | 2 | 1 | 6 |
| | | | | 31, 37, 38, 39 | | | | |
| 85 | A3 | 1 | 0 | 3, 7, 11, 15, 19, | 7 | 1 | 1 | 6 |
| | | | | 23, 27, 31, 35, 39 | | | | |
| 86 | A3 | 1 | 0 | 3, 7, 11, 15, 19, | 0 | 1 | 2 | 6 |
| | | | | 23, 27, 31, 35, 39 | | | | |
| 87 | A3 | 1 | 0 | 1, 3, 5, 7, . . . , | 0 | 1 | 2 | 6 |
| | | | | 37, 39 | | | | |
| 88 | A3 | 1 | 0 | 0, 1, 2, . . . , 39 | 7 | 1 | 1 | 6 |
| 89 | B1 | 16 | 1 | 4, 9, 14, 19, 24, | 2 | 2 | 6 | 2 |
| | | | | 29, 34, 39 | | | | |
| 90 | B1 | 8 | 1 | 4, 9, 14, 19, 24, | 2 | 2 | 6 | 2 |
| | | | | 29, 34, 39 | | | | |
| 91 | B1 | 8 | 1, 2 | 9, 19, 29, 39 | 2 | 2 | 6 | 2 |
| 92 | B1 | 4 | 1 | 4, 9, 14, 19, 24, | 2 | 2 | 6 | 2 |
| | | | | 29, 34, 39 | | | | |
| 93 | B1 | 2 | 1 | 4, 9, 14, 19, 24, | 2 | 2 | 6 | 2 |
| | | | | 29, 34, 39 | | | | |
| 94 | B1 | 2 | 1 | 3, 7, 11, 15, 19, | 2 | 1 | 6 | 2 |
| | | | | 23, 27, 31, 35, 39 | | | | |
| 95 | B1 | 1 | 0 | 19, 39 | 8 | 1 | 3 | 2 |
| 96 | B1 | 1 | 0 | 3, 5, 7 | 2 | 1 | 6 | 2 |
| 97 | B1 | 1 | 0 | 24, 29, 34, 39 | 8 | 1 | 3 | 2 |
| 98 | B1 | 1 | 0 | 9, 19, 29, 39 | 8 | 2 | 3 | 2 |
| 99 | B1 | 1 | 0 | 17, 19, 37, 39 | 2 | 1 | 6 | 2 |
| 100 | B1 | 1 | 0 | 9, 19, 29, 39 | 2 | 2 | 6 | 2 |
| 101 | B1 | 1 | 0 | 7, 15, 23, | 2 | 1 | 6 | 2 |
| | | | | 31, 39 | | | | |
| 102 | B1 | 1 | 0 | 23, 27, 31, | 8 | 1 | 3 | 2 |
| | | | | 35, 39 | | | | |
| 103 | B1 | 1 | 0 | 23, 27, 31, | 2 | 1 | 6 | 2 |
| | | | | 35, 39 | | | | |
| 104 | B1 | 1 | 0 | 3, 5, 7, 9, | 8 | 1 | 3 | 2 |
| | | | | 11, 13 | | | | |
| 105 | B1 | 1 | 0 | 4, 9, 14, 19, 24, | 8 | 1 | 3 | 2 |
| | | | | 29, 34, 39 | | | | |
| 106 | B1 | 1 | 0 | 4, 9, 14, 19, 24, | 2 | 1 | 6 | 2 |
| | | | | 29, 34, 39 | | | | |
| 107 | B1 | 1 | 0 | 3, 7, 11, 15, 19, | 8 | 1 | 3 | 2 |
| | | | | 23, 27, 31, 35, 39 | | | | |
| 108 | B1 | 1 | 0 | 13, 14, 15, 29, 30, | 8 | 2 | 3 | 2 |
| | | | | 31, 37, 38, 39 | | | | |
| 109 | B1 | 1 | 0 | 3, 7, 11, 15, 19, | 2 | 1 | 6 | 2 |
| | | | | 23, 27, 31, 35, 39 | | | | |
| 110 | B1 | 1 | 0 | 1, 3, 5, 7, . . . , | 2 | 1 | 6 | 2 |
| | | | | 37, 39 | | | | |
| 111 | B1 | 1 | 0 | 0, 1, 2, . . . , 39 | 8 | 1 | 3 | 2 |
| 112 | B4 | 16 | 1, 2 | 4, 9, 14, 19, 24, | 0 | 2 | 1 | 12 |
| | | | | 29, 34, 39 | | | | |
| 113 | B4 | 16 | 1, 2 | 3, 7, 11, 15, 19, | 0 | 1 | 1 | 12 |
| | | | | 23, 27, 31, 35, 39 | | | | |
| 114 | B4 | 8 | 1, 2 | 4, 9, 14, 19, 24, | 0 | 2 | 1 | 12 |
| | | | | 29, 34, 39 | | | | |
| 115 | B4 | 8 | 1, 2 | 3, 7, 11, 15, 19, | 0 | 1 | 1 | 12 |
| | | | | 23, 27, 31, 35, 39 | | | | |
| 116 | B4 | 8 | 1, 2 | 9, 19, 29, 39 | 0 | 2 | 1 | 12 |
| 117 | B4 | 4 | 1 | 4, 9, 14, 19, 24, | 0 | 1 | 1 | 12 |
| | | | | 29, 34, 39 | | | | |
| 118 | B4 | 4 | 1 | 4, 9, 14, 19, 24, | 0 | 2 | 1 | 12 |
| | | | | 29, 34, 39 | | | | |
| 119 | B4 | 4 | 1, 2 | 3, 7, 11, 15, 19, | 0 | 1 | 1 | 12 |
| | | | | 23, 27, 31, 35, 39 | | | | |
| 120 | B4 | 2 | 1 | 7, 15, 23, | 2 | 2 | 1 | 12 |
| | | | | 31, 39 | | | | |
| 121 | B4 | 2 | 1 | 4, 9, 14, 19, 24, | 0 | 1 | 1 | 12 |
| | | | | 29, 34, 39 | | | | |
| 122 | B4 | 2 | 1 | 4, 9, 14, 19, 24, | 0 | 2 | 1 | 12 |
| | | | | 29, 34, 39 | | | | |
| 123 | B4 | 2 | 1 | 3, 7, 11, 15, 19, | 0 | 1 | 1 | 12 |
| | | | | 23, 27, 31, 35, 39 | | | | |
| 124 | B4 | 1 | 0 | 19, 39 | 2 | 2 | 1 | 12 |
| 125 | B4 | 1 | 0 | 17, 19, 37, 39 | 0 | 1 | 1 | 12 |
| 126 | B4 | 1 | 0 | 24, 29, 34, 39 | 2 | 1 | 1 | 12 |
| 127 | B4 | 1 | 0 | 9, 19, 29, 39 | 2 | 2 | 1 | 12 |
| 128 | B4 | 1 | 0 | 9, 19, 29, 39 | 0 | 2 | 1 | 12 |
| 129 | B4 | 1 | 0 | 7, 15, 23, | 0 | 1 | 1 | 12 |
| | | | | 31, 39 | | | | |
| 130 | B4 | 1 | 0 | 7, 15, 23, | 0 | 2 | 1 | 12 |
| | | | | 31, 39 | | | | |
| 131 | B4 | 1 | 0 | 23, 27, 31, | 0 | 1 | 1 | 12 |
| | | | | 35, 39 | | | | |
| 132 | B4 | 1 | 0 | 23, 27, 31, | 2 | 2 | 1 | 12 |
| | | | | 35, 39 | | | | |
| 133 | B4 | 1 | 0 | 9, 11, 13, 15, | 0 | 1 | 1 | 12 |
| | | | | 17, 19 | | | | |
| 134 | B4 | 1 | 0 | 3, 5, 7, 9, | 2 | 1 | 1 | 12 |
| | | | | 11, 13 | | | | |
| 135 | B4 | 1 | 0 | 4, 9, 14, 19, 24, | 0 | 1 | 1 | 12 |
| | | | | 29, 34, 39 | | | | |
| 136 | B4 | 1 | 0 | 4, 9, 14, 19, 24, | 2 | 2 | 1 | 12 |
| | | | | 29, 34, 39 | | | | |
| 137 | B4 | 1 | 0 | 13, 14, 15, 29, 30, | 2 | 2 | 1 | 12 |
| | | | | 31, 37, 38, 39 | | | | |
| 138 | B4 | 1 | 0 | 3, 7, 11, 15, 19, | 0 | 1 | 1 | 12 |
| | | | | 23, 27, 31, 35, 39 | | | | |
| 139 | B4 | 1 | 0 | 3, 7, 11, 15, 19, | 2 | 1 | 1 | 12 |
| | | | | 23, 27, 31, 35, 39 | | | | |
| 140 | B4 | 1 | 0 | 3, 5, 7, . . . , | 2 | 1 | 1 | 12 |
| | | | | 23, 25 | | | | |
| 141 | B4 | 1 | 0 | 3, 5, 7, . . . , | 0 | 2 | 1 | 12 |
| | | | | 23, 25 | | | | |
| 142 | B4 | 1 | 0 | 1, 3, 5, 7, . . . , | 0 | 1 | 1 | 12 |
| | | | | 37, 39 | | | | |
| 143 | B4 | 1 | 0 | 0, 1, 2, . . . , 39 | 2 | 1 | 1 | 12 |
| 144 | C0 | 16 | 1 | 4, 9, 14, 19, 24, | 0 | 2 | 7 | 2 |
| | | | | 29, 34, 39 | | | | |
| 145 | C0 | 16 | 1 | 3, 7, 11, 15, 19, | 0 | 1 | 7 | 2 |
| | | | | 23, 27, 31, 35, 39 | | | | |
| 146 | C0 | 8 | 1 | 4, 9, 14, 19, 24, | 0 | 1 | 7 | 2 |
| | | | | 29, 34, 39 | | | | |
| 147 | C0 | 8 | 1 | 3, 7, 11, 15, 19, | 0 | 1 | 7 | 2 |
| | | | | 23, 27, 31, 35, 39 | | | | |
| 148 | C0 | 8 | 1, 2 | 9, 19, 29, 39 | 0 | 2 | 7 | 2 |
| 149 | C0 | 4 | 1 | 4, 9, 14, 19, 24, | 0 | 1 | 7 | 2 |
| | | | | 29, 34, 39 | | | | |
| 150 | C0 | 4 | 1 | 4, 9, 14, 19, 24, | 0 | 2 | 7 | 2 |
| | | | | 29, 34, 39 | | | | |
| 151 | C0 | 4 | 1 | 3, 7, 11, 15, 19, | 0 | 1 | 7 | 2 |
| | | | | 23, 27, 31, 35, 39 | | | | |
| 152 | C0 | 2 | 1 | 7, 15, 23, | 0 | 2 | 7 | 2 |
| | | | | 31, 39 | | | | |
| 153 | C0 | 2 | 1 | 4, 9, 14, 19, 24, | 0 | 1 | 7 | 2 |
| | | | | 29, 34, 39 | | | | |
| 154 | C0 | 2 | 1 | 4, 9, 14, 19, 24, | 0 | 2 | 7 | 2 |
| | | | | 29, 34, 39 | | | | |
| 155 | C0 | 2 | 1 | 3, 7, 11, 15, 19, | 0 | 1 | 7 | 2 |
| | | | | 23, 27, 31, 35, 39 | | | | |
| 156 | C0 | 1 | 0 | 19, 39 | 8 | 1 | 3 | 2 |
| 157 | C0 | 1 | 0 | 3, 5, 7 | 0 | 1 | 7 | 2 |
| 158 | C0 | 1 | 0 | 24, 29, 34, 39 | 8 | 1 | 3 | 2 |
| 159 | C0 | 1 | 0 | 9, 19, 29, 39 | 8 | 2 | 3 | 2 |
| 160 | C0 | 1 | 0 | 17, 19, 37, 39 | 0 | 1 | 7 | 2 |
| 161 | C0 | 1 | 0 | 9, 19, 29, 39 | 0 | 2 | 7 | 2 |
| 162 | C0 | 1 | 0 | 23, 27, 31, | 8 | 1 | 3 | 2 |
| | | | | 35, 39 | | | | |
| 163 | C0 | 1 | 0 | 7, 15, 23, | 0 | 1 | 7 | 2 |
| | | | | 31, 39 | | | | |
| 164 | C0 | 1 | 0 | 23, 27, 31, | 0 | 1 | 7 | 2 |
| | | | | 35, 39 | | | | |
| 165 | C0 | 1 | 0 | 3, 5, 7, 9, | 8 | 1 | 3 | 2 |
| | | | | 11, 13 | | | | |
| 166 | C0 | 1 | 0 | 4, 9, 14, 19, 24, | 8 | 1 | 3 | 2 |
| | | | | 29, 34, 39 | | | | |
| 167 | C0 | 1 | 0 | 4, 9, 14, 19, 24, | 0 | 1 | 7 | 2 |
| | | | | 29, 34, 39 | | | | |
| 168 | C0 | 1 | 0 | 13, 14, 15, 29, 30, | 8 | 2 | 3 | 2 |
| | | | | 31, 37, 38, 39 | | | | |
| 169 | C0 | 1 | 0 | 3, 7, 11, 15, 19, | 8 | 1 | 3 | 2 |
| | | | | 23, 27, 31, 35, 39 | | | | |
| 170 | C0 | 1 | 0 | 3, 7, 11, 15, 19, | 0 | 1 | 7 | 2 |
| | | | | 23, 27, 31, 35, 39 | | | | |
| 171 | C0 | 1 | 0 | 1, 3, 5, 7, . . . , | 0 | 1 | 7 | 2 |
| | | | | 37, 39 | | | | |
| 172 | C0 | 1 | 0 | 0, 1, 2, . . . , 39 | 8 | 1 | 3 | 2 |
| 173 | C2 | 16 | 1 | 4, 9, 14, 19, 24, | 0 | 2 | 2 | 6 |
| | | | | 29, 34, 39 | | | | |
| 174 | C2 | 16 | 1 | 3, 7, 11, 15, 19, | 0 | 1 | 2 | 6 |
| | | | | 23, 27, 31, 35, 39 | | | | |
| 175 | C2 | 8 | 1 | 4, 9, 14, 19, 24, | 0 | 2 | 2 | 6 |
| | | | | 29, 34, 39 | | | | |
| 176 | C2 | 8 | 1 | 3, 7, 11, 15, 19, | 0 | 1 | 2 | 6 |
| | | | | 23, 27, 31, 35, 39 | | | | |
| 177 | C2 | 8 | 1, 2 | 9, 19, 29, 39 | 0 | 2 | 2 | 6 |
| 178 | C2 | 4 | 1 | 4, 9, 14, 19, 24, | 0 | 1 | 2 | 6 |
| | | | | 29, 34, 39 | | | | |
| 179 | C2 | 4 | 1 | 4, 9, 14, 19, 24, | 0 | 2 | 2 | 6 |
| | | | | 29, 34, 39 | | | | |
| 180 | C2 | 4 | 1 | 3, 7, 11, 15, 19, | 0 | 1 | 2 | 6 |
| | | | | 23, 27, 31, 35, 39 | | | | |
| 181 | C2 | 2 | 1 | 7, 15, 23, | 2 | 2 | 2 | 6 |
| | | | | 31, 39 | | | | |
| 182 | C2 | 2 | 1 | 4, 9, 14, 19, 24, | 0 | 1 | 2 | 6 |
| | | | | 29, 34, 39 | | | | |
| 183 | C2 | 2 | 1 | 4, 9, 14, 19, 24, | 0 | 2 | 2 | 6 |
| | | | | 29, 34, 39 | | | | |
| 184 | C2 | 2 | 1 | 3, 7, 11, 15, 19, | 0 | 1 | 2 | 6 |
| | | | | 23, 27, 31, 35, 39 | | | | |
| 185 | C2 | 1 | 0 | 19, 39 | 2 | 1 | 2 | 6 |
| 186 | C2 | 1 | 0 | 3, 5, 7 | 0 | 1 | 2 | 6 |
| 187 | C2 | 1 | 0 | 24, 29, 34, 39 | 7 | 1 | 1 | 6 |
| 188 | C2 | 1 | 0 | 9, 19, 29, 39 | 7 | 2 | 1 | 6 |
| 189 | C2 | 1 | 0 | 17, 19, 37, 39 | 0 | 1 | 2 | 6 |
| 190 | C2 | 1 | 0 | 9, 19, 29, 39 | 2 | 2 | 2 | 6 |
| 191 | C2 | 1 | 0 | 7, 15, 23, | 2 | 1 | 2 | 6 |
| | | | | 31, 39 | | | | |
| 192 | C2 | 1 | 0 | 3, 5, 7, 9, | 7 | 1 | 1 | 6 |
| | | | | 11, 13 | | | | |
| 193 | C2 | 1 | 0 | 23, 27, 31, | 7 | 2 | 1 | 6 |
| | | | | 35, 39 | | | | |
| 194 | C2 | 1 | 0 | 23, 27, 31, | 0 | 1 | 2 | 6 |
| | | | | 35, 39 | | | | |
| 195 | C2 | 1 | 0 | 4, 9, 14, 19, 24, | 7 | 2 | 1 | 6 |
| | | | | 29, 34, 39 | | | | |
| 196 | C2 | 1 | 0 | 4, 9, 14, 19, 24, | 2 | 1 | 2 | 6 |
| | | | | 29, 34, 39 | | | | |
| 197 | C2 | 1 | 0 | 13, 14, 15, 29, 30, | 7 | 2 | 1 | 6 |
| | | | | 31, 37, 38, 39 | | | | |
| 198 | C2 | 1 | 0 | 3, 7, 11, 15, 19, | 7 | 1 | 1 | 6 |
| | | | | 23, 27, 31, 35, 39 | | | | |
| 199 | C2 | 1 | 0 | 3, 7, 11, 15, 19, | 0 | 1 | 2 | 6 |
| | | | | 23, 27, 31, 35, 39 | | | | |
| 200 | C2 | 1 | 0 | 1, 3, 5, 7, . . . , | 0 | 1 | 2 | 6 |
| | | | | 37, 39 | | | | |
| 201 | C2 | 1 | 0 | 0, 1, 2, . . . , 39 | 7 | 1 | 1 | 6 |
| 202 | A1/B1 | 16 | 1 | 4, 9, 14, 19, 24, | 2 | 1 | 6 | 2 |
| | | | | 29, 34, 39 | | | | |
| 203 | A1/B1 | 16 | 1 | 3, 7, 11, 15, 19, | 2 | 1 | 6 | 2 |
| | | | | 23, 27, 31, 35, 39 | | | | |
| 204 | A1/B1 | 8 | 1 | 4, 9, 14, 19, 24, | 2 | 1 | 6 | 2 |
| | | | | 29, 34, 39 | | | | |
| 205 | A1/B1 | 8 | 1 | 3, 7, 11, 15, 19, | 2 | 1 | 6 | 2 |
| | | | | 23, 27, 31, 35, 39 | | | | |
| 206 | A1/B1 | 4 | 1 | 4, 9, 14, 19, 24, | 2 | 1 | 6 | 2 |
| | | | | 29, 34, 39 | | | | |
| 207 | A1/B1 | 4 | 1 | 3, 7, 11, 15, 19, | 2 | 1 | 6 | 2 |
| | | | | 23, 27, 31, 35, 39 | | | | |
| 208 | A1/B1 | 2 | 1 | 4, 9, 14, 19, 24, | 2 | 1 | 6 | 2 |
| | | | | 29, 34, 39 | | | | |
| 209 | A1/B1 | 1 | 0 | 19, 39 | 8 | 1 | 3 | 2 |
| 210 | A1/B1 | 1 | 0 | 9, 19, 29, 39 | 8 | 1 | 3 | 2 |
| 211 | A1/B1 | 1 | 0 | 17, 19, 37, 39 | 2 | 1 | 6 | 2 |
| 212 | A1/B1 | 1 | 0 | 9, 19, 29, 39 | 2 | 2 | 6 | 2 |
| 213 | A1/B1 | 1 | 0 | 23, 27, 31, | 8 | 1 | 3 | 2 |
| | | | | 35, 39 | | | | |
| 214 | A1/B1 | 1 | 0 | 7, 15, 23, | 2 | 1 | 6 | 2 |
| | | | | 31, 39 | | | | |
| 215 | A1/B1 | 1 | 0 | 23, 27, 31, | 2 | 1 | 6 | 2 |
| | | | | 35, 39 | | | | |
| 216 | A1/B1 | 1 | 0 | 4, 9, 14, 19, 24, | 8 | 1 | 3 | 2 |
| | | | | 29, 34, 39 | | | | |
| 217 | A1/B1 | 1 | 0 | 4, 9, 14, 19, 24, | 2 | 1 | 6 | 2 |
| | | | | 29, 34, 39 | | | | |
| 218 | A1/B1 | 1 | 0 | 3, 7, 11, 15, 19, | 2 | 1 | 6 | 2 |
| | | | | 23, 27, 31, 35, 39 | | | | |
| 219 | A1/B1 | 1 | 0 | 1, 3, 5, 7, . . . , | 2 | 1 | 6 | 2 |
| | | | | 37, 39 | | | | |
| 220 | A2/B2 | 16 | 1 | 4, 9, 14, 19, 24, | 2 | 1 | 3 | 4 |
| | | | | 29, 34, 39 | | | | |
| 221 | A2/B2 | 16 | 1 | 3, 7, 11, 15, 19, | 2 | 1 | 3 | 4 |
| | | | | 23, 27, 31, 35, 39 | | | | |
| 222 | A2/B2 | 8 | 1 | 4, 9, 14, 19, 24, | 2 | 1 | 3 | 4 |
| | | | | 29, 34, 39 | | | | |
| 223 | A2/B2 | 8 | 1 | 3, 7, 11, 15, 19, | 2 | 1 | 3 | 4 |
| | | | | 23, 27, 31, 35, 39 | | | | |
| 224 | A2/B2 | 4 | 1 | 4, 9, 14, 19, 24, | 2 | 1 | 3 | 4 |
| | | | | 29, 34, 39 | | | | |
| 225 | A2/B2 | 4 | 1 | 3, 7, 11, 15, 19, | 2 | 1 | 3 | 4 |
| | | | | 23, 27, 31, 35, 39 | | | | |
| 226 | A2/B2 | 2 | 1 | 4, 9, 14, 19, 24, | 2 | 1 | 3 | 4 |
| | | | | 29, 34, 39 | | | | |
| 227 | A2/B2 | 1 | 0 | 19, 39 | 6 | 1 | 2 | 4 |
| 228 | A2/B2 | 1 | 0 | 9, 19, 29, 39 | 6 | 1 | 2 | 4 |
| 229 | A2/B2 | 1 | 0 | 17, 19, 37, 39 | 2 | 1 | 3 | 4 |
| 230 | A2/B2 | 1 | 0 | 9, 19, 29, 39 | 2 | 2 | 3 | 4 |
| 231 | A2/B2 | 1 | 0 | 23, 27, 31, | 6 | 1 | 2 | 4 |
| | | | | 35, 39 | | | | |
| 232 | A2/B2 | 1 | 0 | 7, 15, 23, | 2 | 1 | 3 | 4 |
| | | | | 31, 39 | | | | |
| 233 | A2/B2 | 1 | 0 | 23, 27, 31, | 2 | 1 | 3 | 4 |
| | | | | 35, 39 | | | | |
| 234 | A2/B2 | 1 | 0 | 4, 9, 14, 19, 24, | 6 | 1 | 2 | 4 |
| | | | | 29, 34, 39 | | | | |
| 235 | A2/B2 | 1 | 0 | 4, 9, 14, 19, 24, | 2 | 1 | 3 | 4 |
| | | | | 29, 34, 39 | | | | |
| 236 | A2/B2 | 1 | 0 | 3, 7, 11, 15, 19, | 2 | 1 | 3 | 4 |
| | | | | 23, 27, 31, 35, 39 | | | | |
| 237 | A2/B2 | 1 | 0 | 1, 3, 5, 7, . . . , | 2 | 1 | 3 | 4 |
| | | | | 37, 39 | | | | |
| 238 | A3/B3 | 16 | 1 | 4, 9, 14, 19, 24, | 2 | 1 | 2 | 6 |
| | | | | 29, 34, 39 | | | | |
| 239 | A3/B3 | 16 | 1 | 3, 7, 11, 15, 19, | 2 | 1 | 2 | 6 |
| | | | | 23, 27, 31, 35, 39 | | | | |
| 240 | A3/B3 | 8 | 1 | 4, 9, 14, 19, 24, | 2 | 1 | 2 | 6 |
| | | | | 29, 34, 39 | | | | |
| 241 | A3/B3 | 8 | 1 | 3, 7, 11, 15, 19, | 2 | 1 | 2 | 6 |
| | | | | 23, 27, 31, 35, 39 | | | | |
| 242 | A3/B3 | 4 | 1 | 4, 9, 14, 19, 24, | 2 | 1 | 2 | 6 |
| | | | | 29, 34, 39 | | | | |
| 243 | A3/B3 | 4 | 1 | 3, 7, 11, 15, 19, | 2 | 1 | 2 | 6 |
| | | | | 23, 27, 31, 35, 39 | | | | |
| 244 | A3/B3 | 2 | 1 | 4, 9, 14, 19, 24, | 2 | 1 | 2 | 6 |
| | | | | 29, 34, 39 | | | | |
| 245 | A3/B3 | 1 | 0 | 19, 39 | 2 | 1 | 2 | 6 |
| 246 | A3/B3 | 1 | 0 | 9, 19, 29, 39 | 2 | 1 | 2 | 6 |
| 247 | A3/B3 | 1 | 0 | 17, 19, 37, 39 | 2 | 1 | 2 | 6 |
| 248 | A3/B3 | 1 | 0 | 9, 19, 29, 39 | 2 | 2 | 2 | 6 |
| 249 | A3/B3 | 1 | 0 | 7, 15, 23, | 2 | 1 | 2 | 6 |
| | | | | 31, 39 | | | | |
| 250 | A3/B3 | 1 | 0 | 23, 27, 31, | 2 | 1 | 2 | 6 |
| | | | | 35, 39 | | | | |
| 251 | A3/B3 | 1 | 0 | 23, 27, 31, | 2 | 2 | 2 | 6 |
| | | | | 35, 39 | | | | |
| 252 | A3/B3 | 1 | 0 | 4, 9, 14, 19, 24, | 2 | 1 | 2 | 6 |
| | | | | 29, 34, 39 | | | | |
| 253 | A3/B3 | 1 | 0 | 4, 9, 14, 19, 24, | 2 | 2 | 2 | 6 |
| | | | | 29, 34, 39 | | | | |
| 254 | A3/B3 | 1 | 0 | 3, 7, 11, 15, 19, | 2 | 1 | 2 | 6 |
| | | | | 23, 27, 31, 35, 39 | | | | |
| 255 | A3/B3 | 1 | 0 | 1, 3, 5, 7, . . . , | 2 | 1 | 2 | 6 |
| | | | | 37, 39 | | | | |

### 3. COMPOSITION AND METHOD OF THE INVENTION

The contents described above (NR frame structure, RACH, U-Band system, etc.) can be applied by being combined with methods according to the present disclosure described below, or can be supplemented to clarify technical features of methods described in the present disclosure.

In addition, methods related to configuration of a PRACH transmission occasion described below are related to uplink transmission and can be equally applied to an uplink signal transmission method in the NR system (licensed band) or U-Band system (unlicensed band) described above. The technical ideas described in the present disclosure can be modified or replaced to suit terms, expressions, structures, etc. defined in each system so that they can be implemented in the corresponding systems.

For example, the uplink transmission through the methods related to configuration of the PRACH transmission occasion described below can be performed in an L-cell and/or a U-cell defined in the NR system or the U-Band system.

NR supports multiple numerologies (or subcarrier spacing (SCS)) for supporting diverse 5G services. For example, if the SCS is 15 kHz, the NR supports a wide area in conventional cellular bands; if the SCS is 30 kHz/60 kHz, the NR supports a dense-urban, lower latency and wider carrier bandwidth; and if the SCS is 60 kHz or higher, the NR supports a bandwidth greater than 24.25 GHZ to overcome phase noise.

An NR frequency band is defined as two types of frequency ranges FR1 and FR2. FR1 and FR2 may be configured as shown in Table A6 below. FR2 may mean millimeter wave (mmW).

TABLE A6

| Frequency Range | Corresponding | Subcarrier |
|---|---|---|
| designation | frequency range | Spacing |
| FR1 | 410 MHz-7125 MHz | 15, 30, 60 kHz |
| FR2 | 24250 MHz-52600 MHz | 60, 120, 240 kHz |

Meanwhile, it is considered that the PRACH preamble is repeatedly transmitted for UL coverage enhancement of a legacy NR system. Meanwhile, an RA-RNTI equation and an MSGB-RNTI equation applied for a current FR1/2 region are defined in Sections 5.1.3 and 5.1.3a of the 38.321 spec, respectively as follows.

| | |
|---|---|
| 5.1.3 | Random Access Preamble transmission |

The RA-RNTI associated with the PRACH occasion in which the Random Access Preamble is transmitted, is
computed as:

RA-RNTI = 1 + s_id + 14 × t_id + 14 × 80 × f_id + 14 × 80 × 8 × ul_carrier_id

where s_id is the index of the first OFDM symbol of the PRACH occasion (0 ≤ s_id < 14), t_id is the index of the first
slot of the PRACH occasion in a system frame (0 ≤ t_id < 80), where the subcarrier spacing to determine t_id is based
on the value of i specified in clause 5.3.2 in TS 38.211 [8], f_id is the index of the PRACH occasion in the frequency
domain (0 ≤ f_id < 8), and ul_carrier_id is the UL carrier used for Random Access Preamble transmission (0 for NUL
carrier, and 1 for SUL carrier).

| | |
|---|---|
| 5.1.3a | MSGA transmission |

The MSGB-RNTI associated with the PRACH occasion in which the Random Access Preamble is transmitted, is
computed as:

MSGB-RNTI = 1 + s_id + 14 × t_id + 14 × 80 × f_id + 14 × 80 × 8 × ul_carrier_id + 14 × 80 × 8 × 2

where s_id is the index of the first OFDM symbol of the PRACH occasion (0 ≤ s_id < 14), t_id is the index of the first
slot of the PRACH occasion in a system frame (0 ≤ t_id < 80), where the subcarrier spacing to determine t_id is based
on the value of i specified in clause 5.3.2 in TS 38.211 [8], f_id is the index of the PRACH occasion in the frequency
domain (0 ≤ f_id < 8), and ul_carrier_id is the UL carrier used for Random Access Preamble transmission (0 for NUL
carrier, and 1 for SUL carrier). The RA-RNTI is calculated as specified in clause 5.1.3.

In this case, when an additional RACH configuration is allocated for PRACH repetition transmission, the corresponding RACH resource and the RACH resource allocated through the legacy RACH configuration may be frequency division multiplexed (FDMed) and allocated at the same time instance. This creates a problem where RA-RNTI values to be expected between the UE and the eNB may become identical. As a specific example, this may be illustrated as in FIG. 3-0.

Referring to FIG. 3-0, when a legacy RACH configuration (i.e., single PRACH TX) and an additional RACH configuration (i.e., multiple PRACH TX) are allocated to separated ROs (i.e., separated RACH configuration), a plurality of ROs corresponding to different RACH configurations may be FDMed and allocated at a same time instance. In this case, when it is assumed that UE1 performs PRACH repetition with a repetition factor of 4 by selecting RO I, RO J, RO K, and RO L and calculates the RA-RNTI based on RO L, and it is assumed that UE2 performs a single PRACH transmission using RO D and calculates the RA-RNTI based on RO D, UE1 and UE2 start RAR window monitoring at a same timing, and RA-RNTI values expected by UE1 and UE2 will be the same (assuming both configurations have msg1−FDM=2).

As a result, both UE1 and UE2 expect and operate under the assumption that the RAR forwarded based on the PDSCH scheduled based on DCI format 1_0 scrambled with the same RA-RNTI will be an appropriate RAR for each UE, so one of UE1 and UE2 fails to receive the appropriate RAR in time. This consequently results in increased latency of the RACH procedure. Therefore, in order to address this problem, the present disclosure proposes a method for resolving a problem in that RA-RNTIs overlap when a PRACH (Msg. A) preamble repetition operation is defined.

### 3.1. RA-RNTI Collision Handling for PRACH Repeated Transmission.

[Proposed Method 1] Method for Introducing a Frequency RO Index Offset within a Parameter for an Additional RACH Configuration of Higher Layer Signaling (e.g., SIB1)

As a first method, it may be considered that an offset parameter for changing a frequency index of an RO is additionally introduced into the parameter (e.g., AdditionalRACH-Config-r17) for the additional RACH configuration of the higher layer signaling (e.g., SIB1). As an example, the eNB may configure/indicate, to the UE, an FDMed RO index offset related parameter (e.g., msg1-FDM-index-offset) through the parameter for the additional RACH configuration of the higher layer signaling (e.g., SIB1). In this case, taking into account all RACH configurations provided within the cell, the eNB may be configured to indicate an offset value so that a maximum total number of ROs that may be FDMed in the same time instance does not exceed 8.

When the FDMed RO index offset related parameter (e.g., msg1-FDM-index-offset) is configured/indicated within a parameter for an additional RACH configuration (e.g., AdditionalRACH-Config-r17), the UE and the eNB may be configured to additionally apply the corresponding offset value when calculating the RA-RNTI. A specific UE operation will be described as follows. According to a legacy operation, if the UE uses a frequency index corresponding to an arbitrary RO selected at an MAC layer among the FDMed ROs allocated by the eNB as an f_id value, when the FDMed RO index offset related parameter (e.g., msg1-FDM-index-offset) is configured/indicated to the UE from the eNB, the UE may be configured to add an additionally indicated msg1-FDM-index-offset to an arbitrary RO selected at the MAC layer, and use the corresponding value as the f_id value (i.e., f_id=frequency index of RO+msg1-FDM-index-offset). In other words, the frequency index (i.e., f_id) may be defined/determined according to an order of the selected RO among the FDMed ROs based on the FDMed RO index offset related parameter (e.g., msg1-FDM-index-offset) configured/indicated by the eNB (starting from the value). Characteristically, an actual frequency position of the ROs allocated through the corresponding additional RACH configuration is determined through an msg1-FDM value and msg1-Frequency Start similarly to the legacy UE operation.

A specific example for the proposal method may be expressed as in FIG. 3-1. When the eNB assigns only two RACH configurations (i.e., legacy RACH configuration and one additional RACH configuration) to the corresponding cell, the msg1-FDM value of the legacy RACH configuration is 4, and the msg1-FDM value of the additional RACH configuration is 4, the value of the additional RACH configuration may be given as 4. Alternatively, the eNB may configure/indicate using the msg1-FDM value of the legacy RACH configuration as the msg1-FDM-index-offset of the additional RACH configuration. Alternatively, the eNB may configured/indicate whether to enable/disable the FDM offset using a separate parameter. If it is indicated by the eNB that the FDM offset is enabled, when the msg1-FDM-index-offset value is indicated, the UE may use the msg1-FDM-index-offset value, and when the msg1-FDM-index-offset is not indicated, the UE may be configured to use the msg1-FDM value of the legacy RACH configuration as the msg1-FDM-index-offset value. If the msg1-FDM-index-offset value is 4 and the frequency index value of the RO arbitrarily selected by the UE through the MAC layer is 2, the f_id value used for the RA-RNTI may be 6 when the UE and the eNB transmit and receive the PRACH based on the corresponding RO.

[Propoed Method 2] Method for configuring/indicating an OFDM symbol index value for calculation of s_id of RA-RNTI within a parameter for an additional RACH configuration of higher layer signaling (e.g., SIB1)

According to a current UE/eNB operation, when calculating the RA-RNTI, a first OFDM symbol index of the RO in which the preamble is transmitted/received is defined to be used as the s_id value. However, since PRACH formats defined in NR use at least two OFDM symbols per RO, some RA-RNTI values may remain unused within a specific cell depending on the RACH configuration. Therefore, the eNB may configure/indicate using remaining RA-RNTI values for the RO allocated by the additional RACH configuration.

Accordingly, as another solving method, a method may be considered in which the eNB indicates an s_id (i.e., OFDM symbol index) value to be used for RA-RNTI calculation within the higher layer signaling (e.g., SIB1) for the additional RACH configuration. Specifically, a method may be considered in which The eNB may select an appropriate value based on a total number of OFDM symbols within one RO for a PRACH format configured through a specific RACH configuration and indicate an N-th OFDM symbol within the RO to be used for the s_id. Characteristically, the eNB may indicate an OFDM symbol for the s_id to the UE in forms such as a 1st OFDM symbol of RO, a 2nd OFDM symbol of RO, a 3rd OFDM symbol of RO, a last OFDM symbol of RO, etc. When such a parameter is indicated, the UE and the eNB may be configured to use the s_id value as the OFDM symbol index value corresponding to the indicated OFDM symbol position of the corresponding RO when calculating the RA-RNTI. Characteristically, when the eNB does not separately indicate the parameter, the first OFDM symbol index of the corresponding RO may be configured to be used as the s_id when calculating the RA-RNTI, similar to the legacy UE/eNB operation.

Alternatively, when the PRACH is transmitted/received using an RO of an additional RACH configuration, a method for predefining a specific N-th OFDM symbol of the corresponding RO for the s_id value to be used when calculating the RA-RNTI may also be considered. Characteristically, the specific N-th OFDM symbol may be a last OFDM symbol of the corresponding RO, and the N value may be predefined as 2 or 3, etc., indicating which position OFDM symbol within the specific RO. When the s_id value is predefined for the RA-RNTI calculation for the additional RACH configuration as described above, the UE/eNB may use the OFDM symbol index corresponding to the predefined OFDM symbol position of the corresponding RO as the s_id value when calculating the RA-RNTI.

### [Proposed Method 3] Method for Additionally Providing Additional Information for Distinguishing RACH Configurations to Other Signals/Channels

As a third method, a method may be considered in which the eNB separately configures/indicates additional information for distinguishing legacy RACH configuration and an additional RACH configuration in a specific signal/channel. Among them, as a first alternative, a method for distinguishing a legacy RACH configuration and an additional RACH configuration by using a reserved 1 bit field of an MAC payload within an RAR that schedules an Msg. 3 PUSCH may be considered. In other words, if the reserved 1-bit field value in the MAC payload within the RAR is set to 0, the corresponding RAR may be used as the RAR for the legacy RACH configuration, and set to 1, and configured to be used as the RAR for the additional RACH configuration. However, since the corresponding reserved field has only 1 bit, when a plurality of additional RACH configurations are allocated, and allocated to overlap with the legacy RACH configuration at a specific timing, it may be difficult to distinguish all different configurations.

Accordingly, as another method, a method may be considered in which when DCI format 1_0 is scrambled with the RA-RNTI, some of reserved fields of the corresponding DCI format 1_0 are used as an RACH configuration indication field to distinguish the legacy RACH configuration or the additional RACH configuration. That is, the legacy RACH configuration from k additional RACH configurations may be configured to be distinguished by using an N bit field(s) of the reserved field. In this case, the N value may be determined as N=ceil (log 2 (1+k)), and N MSB bits (or LSB bits) of the reserved field may be used as the RACH configuration indication field. As an example, subsequently to k=3, if N=2 bits, {00, 01, 10, 11}={legacy RACH configuration, additional RACH configuration #1, additional RACH configuration #2, additional RACH configuration #3} may be expressed. As another example, since k=2, {00, 01, 10, 11}={legacy RACH configuration, additional RACH configuration #1, additional RACH configuration #2, reserved} may be expressed. Characteristically, as the additional RACH configuration, all additional RACH configurations which the eNB configures in the corresponding cell may be considered, and only additional RACH configurations which may be placed with the legacy RACH configuration by FDM at any time instance may be considered.

The UE confirms an RA-RNTI value scrambled to DCI format 1_0 and additionally confirms the additional information, and then, when the RACH configuration is an RACH configuration corresponding to the RO selected by the UE, the UE may be configured to interpret the corresponding RAR. However, since UEs prior to Rel-17 may not interpret the additional information, the UEs will attempt to interpret the RAR if only the RA-RNTI scrambled to DCI format 1_0 matches. Accordingly, it may be preferable that the eNB may transmit the RAR for the legacy RACH configuration (i.e., DCI format 1_0 with RA-RNTI that schedules the corresponding RAR) before the RAR for the additional RACH configuration.

### [Proposed Method 3] Method for Configuring Different RA-RNTIs to be Used According to RACH Configuration

Since the aforementioned problem is caused by identical RA-RNTIs, a method for configuring the RA-RNTI for the additional RACH configuration independently from the RA-RNTI for the legacy RACH configuration may also be considered. Alternatively, a method for independently RA-RNTIs for multiple PRACHs among the additional RACH configurations may be considered. That is, an RA-RNTI calculation equation may be defined and used as in Equation 3-1.

$$Equation 3 - 1$$

$$Enhanced RA - RNTI = 1 + s\_id + 14 \times t\_id + 14 \times 80 \times f\_id + 14 \times 80 \times 8 \times ul\_carrier \_id + 14 \times 80 \times 8 \times 2 \times additional RACH configuration index$$

In this case, the additional RACH configuration index may be an index that considers all additional RACH configurations allocated within the corresponding cell or an index that considers only the additional RACH configurations where ROs are allocated in an FDM form with a single PRACH at a specific time instance. Characteristically, the eNB may configure/indicate the index values of the additional RACH configurations corresponding to the consideration target to not overlap each other using sequentially increasing positive integers starting from 1. As an example, when a number of additional RACH configurations is 3, additional RACH configuration #1 may be represented as Index 1, additional RACH configuration #2 may be represented as Index 2, and additional RACH configuration #3 may be represented as Index 3.

Alternatively, the index for the RACH configuration may be configured by mapping in ascending (or descending) order of repetition number values configured/indicated in the RACH configuration, with the index incrementally assigned starting from 1. As an example, when the number of additional RACH configurations is 3, and repetition numbers 2, 4, and 8 are allocated to additional RACH configuration #1, additional RACH configuration #2, and additional RACH configuration #3, respectively, additional RACH configuration #1 may be represented as index 1, additional RACH configuration #2 may be represented as index 2, and additional RACH configuration #3 may be represented as index 3.

### [Proposed Method 4] Method for Configuring Different DL BWPs to be Used According to RACH Configuration

According to a current specification, the legacy RACH configuration and/or additional RACH configurations configured by the eNB are allocated within an initial UL BWP. Thereafter, when the UE transmits a preamble to any RO, the UE is configured to monitor the RAR using a same initial DL BWP regardless of which RACH configuration is selected. Therefore, a method for distinguishing DL BWPs on which the UE monitors the RAR for different RACH configurations may be considered to resolve a case where RA-RNTIs overlap for different RACH configurations.

As a specific method, it may be considered that an additional DL BWP which may monitor the RAR window is configured/indicated within the additional RACH configuration. That is, when the eNB configures the additional DL BWP, the UE may be configured to monitor the RAR in the DL BWP based on the corresponding configuration, and when the eNB does not separately configure the additional DL BWP, the UE may be configured to monitor the RAR using the initial DL BWP as in the legacy operation. Characteristically, when the eNB configures the additional DL BWP within the additional RACH configuration, the transmission and reception of DL signals/channels of the RACH procedure performed by the UE/eNB may be naturally configured to be performed through the additional DL BWP, and when there is no BWP switching instruction from the eNB after the UE enters an RRC connected state, the UE may be configured to continue using the additional DL BWP as the active DL BWP.

Additionally, it may be considered that the eNB configures/indicates an additional (initial) UL BWP that is independent of the initial UL BWP. In this case, the eNB may configure the legacy RACH configuration to be allocated within the initial UL BWP, and separately configure/indicate whether the additional RACH configuration is allocated to a specific UL BWP among the initial UL BWP and/or the additional (initial) UL BWP. That is, in the absence of the separate configuration/indication information, the UE may operate by interpreting that the additional RACH configuration is allocated to the initial UL BWP. When the eNB configures the additional RACH configuration to be allocated to the additional (initial) UL BWP, the UE may interpret and operate under the assumption that the corresponding RACH resources are allocated to the additional (initial) UL BWP. Thereafter, the initial DL BWP may also be separately configured/indicated as in the proposed method above.

Meanwhile, when ROs corresponding to a plurality of RACH configurations are configured in an FDMed form, the eNB may appropriately distinguish and configure preamble index sets available for each RACH configuration so that the preamble index sets may be distinguished through the RAPID even if RA-RNTIs are identical. As an example, 32 RAPIDs 0 to 31 may be configured to be used in the RO of the legacy RACH configuration, and 32 RAPIDs 32 to 63 may be configured to be used in the RO of the additional RACH configuration.

Although the proposed method is primarily proposed considering the calculation of the RA-RNTI, the proposed method may be applied in the same/similar manner when calculating the MSGB-RNTI. Further, the proposed method may be configured/applied to another UL signal/channel such as PUSCH/PUCCH, etc. Since examples of the above-described proposed methods can also be included as one of the implementation methods of the present disclosure, it is obvious that the examples can be considered as a kind of proposed methods. Further, the above-described proposed methods may be independently implemented, but may be implemented in the form of a combination (or merge) of some proposed methods. A rule may be defined so that a base station informs a UE of information about whether to apply the proposed methods (or information on rules of the proposed methods) via pre-defined signaling (e.g., physical layer signaling or higher layer signaling). For example, the higher layer may include one or more of functional layers such as MAC, RLC, PDCP, RRC, and SDAP.

Methods, embodiments, or descriptions for implementing the methods proposed in the present disclosure may be individually applied, or one or more methods (or embodiments or descriptions) may be combined and applied.

As mentioned above, the above-described BS/UE signaling and operation (e.g., method, etc.) can be implemented by a device (e.g., X1 to X9) described below. For example, the BS may correspond to a first wireless device, and the UE may correspond to a second wireless device. In some case, the opposite case can also be considered.

For example, the above-described BS/UE signaling and operation (e.g., method, etc.) can be processed by one or more processors 102 and 202 of FIGS. X1 to X9, and the above-described BS/UE signaling and operation (e.g., method, etc.) can be can be stored in a memory (e.g., one or more memories 104 and 204 of FIG. X1) in the form of commands/programs (e.g., instructions, executable codes) for running at least one processor (e.g., processors 102 and 202) of FIGS. X1 to X9.

1. Example of Communication System to which the Present Disclosure is Applied

The various descriptions, functions, procedures, proposals, methods, and/or operational flowcharts of the present disclosure described in this document may be applied to, without being limited to, a variety of fields requiring wireless communication/connection (e.g., 5G) between devices.

Hereinafter, a description will be given in more detail with reference to the drawings. In the following drawings/description, the same reference symbols may denote the same or corresponding hardware blocks, software blocks, or functional blocks unless described otherwise. FIG. W1 illustrates a communication system 1 applied to the present disclosure.

Referring to FIG. W1, a communication system 1 applied to the present disclosure includes wireless devices, Base Stations (BSs), and a network. Herein, the wireless devices represent devices performing communication using Radio Access Technology (RAT) (e.g., 5G New RAT (NR)) or Long-Term Evolution (LTE)) and may be referred to as communication/radio/5G devices. The wireless devices may include, without being limited to, a robot 100a, vehicles 100b-1 and 100b-2, an extended Reality (XR) device 100c, a hand-held device 100d, a home appliance 100e, an Internet of Things (IoT) device 100f, and an Artificial Intelligence (AI) device/server 400. For example, the vehicles may include a vehicle having a wireless communication function, an autonomous driving vehicle, and a vehicle capable of performing communication between vehicles. Herein, the vehicles may include an Unmanned Aerial Vehicle (UAV) (e.g., a drone). The XR device may include an Augmented Reality (AR)/Virtual Reality (VR)/Mixed Reality (MR) device and may be implemented in the form of a Head-Mounted Device (HMD), a Head-Up Display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter. For example, the BSs and the network may be implemented as wireless devices and a specific wireless device 200a may operate as a BS/network node with respect to other wireless devices.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, or a 5G (e.g., NR) network. Although the wireless devices 100a to 100f may communicate with each other through the BSs 200/network 300, the wireless devices 100a to 100f may perform direct communication (e.g., sidelink communication) with each other without passing through the BSs/network. For example, the vehicles 100b-1 and 100b-2 may perform direct communication (e.g. Vehicle-to-Vehicle (V2V)/Vehicle-to-everything (V2X) communication). The IoT device (e.g., a sensor) may perform direct communication with other IoT devices (e.g., sensors) or other wireless devices 100a to 100f.

Wireless communication/connections 150a, 150b, or 150c may be established between the wireless devices 100a to 100f/BS 200, or BS 200/BS 200. Herein, the wireless communication/connections may be established through various RATs (e.g., 5G NR) such as uplink/downlink communication 150a, sidelink communication 150b (or, D2D communication), or inter BS communication (e.g. relay, Integrated Access Backhaul (IAB)). The wireless devices and the BSs/the wireless devices may transmit/receive radio signals to/from each other through the wireless communication/connections 150a and 150b. For example, the wireless communication/connections 150a and 150b may transmit/receive signals through various physical channels. To this end, at least a part of various configuration information configuring processes, various signal processing processes (e.g., channel encoding/decoding, modulation/demodulation, and resource mapping/demapping), and resource allocating processes, for transmitting/receiving radio signals, may be performed based on the various proposals of the present disclosure.

2. Example of Wireless Devices to which the Present Disclosure is Applied

FIG. X1 illustrates wireless devices applicable to the present disclosure.

Referring to FIG. X1, a first wireless device 100 and a second wireless device 200 may transmit radio signals through a variety of RATs (e.g., LTE and NR). Herein, {the first wireless device 100 and the second wireless device 200} may correspond to {the wireless device 100x and the BS 200} and/or {the wireless device 100x and the wireless device 100x} of FIG. W1.

The first wireless device 100 may include one or more processors 102 and one or more memories 104 and additionally further include one or more transceivers 106 and/or one or more antennas 108. The processor(s) 102 may control the memory(s) 104 and/or the transceiver(s) 106 and may be configured to implement the descriptions, functions, procedures, proposals, methods, and/or operational flowcharts disclosed in this document. For example, the processor(s) 102 may process information within the memory(s) 104 to generate first information/signals and then transmit radio signals including the first information/signals through the transceiver(s) 106. The processor(s) 102 may receive radio signals including second information/signals through the transceiver 106 and then store information obtained by processing the second information/signals in the memory(s) 104. The memory(s) 104 may be connected to the processor(s) 102 and may store a variety of information related to operations of the processor(s) 102. For example, the memory(s) 104 may store software code including commands for performing a part or the entirety of processes controlled by the processor(s) 102 or for performing the descriptions, functions, procedures, proposals, methods, and/or operational flowcharts disclosed in this document. Herein, the processor(s) 102 and the memory(s) 104 may be a part of a communication modem/circuit/chip designed to implement RAT (e.g., LTE or NR). The transceiver(s) 106 may be connected to the processor(s) 102 and transmit and/or receive radio signals through one or more antennas 108. Each of the transceiver(s) 106 may include a transmitter and/or a receiver. The transceiver(s) 106 may be interchangeably used with Radio Frequency (RF) unit(s). In the present disclosure, the wireless device may represent a communication modem/circuit/chip.

The second wireless device 200 may include one or more processors 202 and one or more memories 204 and additionally further include one or more transceivers 206 and/or one or more antennas 208. The processor(s) 202 may control the memory(s) 204 and/or the transceiver(s) 206 and may be configured to implement the descriptions, functions, procedures, proposals, methods, and/or operational flowcharts disclosed in this document. For example, the processor(s) 202 may process information within the memory(s) 204 to generate third information/signals and then transmit radio signals including the third information/signals through the transceiver(s) 206. The processor(s) 202 may receive radio signals including fourth information/signals through the transceiver(s) 106 and then store information obtained by processing the fourth information/signals in the memory(s) 204. The memory(s) 204 may be connected to the processor(s) 202 and may store a variety of information related to operations of the processor(s) 202. For example, the memory(s) 204 may store software code including commands for performing a part or the entirety of processes controlled by the processor(s) 202 or for performing the descriptions, functions, procedures, proposals, methods, and/or operational flowcharts disclosed in this document. Herein, the processor(s) 202 and the memory(s) 204 may be a part of a communication modem/circuit/chip designed to implement RAT (e.g., LTE or NR). The transceiver(s) 206 may be connected to the processor(s) 202 and transmit and/or receive radio signals through one or more antennas 208. Each of the transceiver(s) 206 may include a transmitter and/or a receiver. The transceiver(s) 206 may be interchangeably used with RF unit(s). In the present disclosure, the wireless device may represent a communication modem/circuit/chip.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as PHY, MAC, RLC, PDCP, RRC, and SDAP). The one or more processors 102 and 202 may generate one or more Protocol Data Units (PDUs) and/or one or more Service Data Unit (SDUs) according to the descriptions, functions, procedures, proposals, methods, and/or operational flowcharts disclosed in this document. The one or more processors 102 and 202 may generate messages, control information, data, or information according to the descriptions, functions, procedures, proposals, methods, and/or operational flowcharts disclosed in this document. The one or more processors 102 and 202 may generate signals (e.g., baseband signals) including PDUs, SDUs, messages, control information, data, or information according to the descriptions, functions, procedures, proposals, methods, and/or operational flowcharts disclosed in this document and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, proposals, methods, and/or operational flowcharts disclosed in this document.

The one or more processors 102 and 202 may be referred to as controllers, microcontrollers, microprocessors, or microcomputers. The one or more processors 102 and 202 may be implemented by hardware, firmware, software, or a combination thereof. As an example, one or more Application Specific Integrated Circuits (ASICs), one or more Digital Signal Processors (DSPs), one or more Digital Signal Processing Devices (DSPDs), one or more Programmable Logic Devices (PLDs), or one or more Field Programmable Gate Arrays (FPGAs) may be included in the one or more processors 102 and 202. The descriptions, functions, procedures, proposals, methods, and/or operational flowcharts disclosed in this document may be implemented using firmware or software and the firmware or software may be configured to include the modules, procedures, or functions. Firmware or software configured to perform the descriptions, functions, procedures, proposals, methods, and/or operational flowcharts disclosed in this document may be included in the one or more processors 102 and 202 or stored in the one or more memories 104 and 204 so as to be driven by the one or more processors 102 and 202. The descriptions, functions, procedures, proposals, methods, and/or operational flowcharts disclosed in this document may be implemented using firmware or software in the form of code, commands, and/or a set of commands.

The one or more memories 104 and 204 may be connected to the one or more processors 102 and 202 and store various types of data, signals, messages, information, programs, code, instructions, and/or commands. The one or more memories 104 and 204 may be configured by Read-Only Memories (ROMs), Random Access Memories (RAMs), Electrically Erasable Programmable Read-Only Memories (EPROMs), flash memories, hard drives, registers, cash memories, computer-readable storage media, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the methods and/or operational flowcharts of this document, to one or more other devices. The one or more transceivers 106 and 206 may receive user data, control information, and/or radio signals/channels, mentioned in the descriptions, functions, procedures, proposals, methods, and/or operational flowcharts disclosed in this document, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices. The one or more transceivers 106 and 206 may be connected to the one or more antennas 108 and 208 and the one or more transceivers 106 and 206 may be configured to transmit and receive user data, control information, and/or radio signals/channels, mentioned in the descriptions, functions, procedures, proposals, methods, and/or operational flowcharts disclosed in this document, through the one or more antennas 108 and 208. In this document, the one or more antennas may be a plurality of physical antennas or a plurality of logical antennas (e.g., antenna ports). The one or more transceivers 106 and 206 may convert received radio signals/channels etc. from RF band signals into baseband signals in order to process received user data, control information, radio signals/channels, etc. using the one or more processors 102 and 202. The one or more transceivers 106 and 206 may convert the user data, control information, radio signals/channels, etc. processed using the one or more processors 102 and 202 from the base band signals into the RF band signals. To this end, the one or more transceivers 106 and 206 may include (analog) oscillators and/or filters.

3. Example of a Signal Process Circuit to which the Present Disclosure is Applied

FIG. X2 illustrates a signal process circuit for a transmission signal.

Referring to FIG. X2, a signal processing circuit 1000 may include scramblers 1010, modulators 1020, a layer mapper 1030, a precoder 1040, resource mappers 1050, and signal generators 1060. An operation/function of FIG. X2 may be performed, without being limited to, the processors 102 and 202 and/or the transceivers 106 and 206 of FIG. X1. Hardware elements of FIG. X2 may be implemented by the processors 102 and 202 and/or the transceivers 106 and 206 of FIG. X1. For example, blocks 1010 to 1060 may be implemented by the processors 102 and 202 of FIG. X1. Alternatively, the blocks 1010 to 1050 may be implemented by the processors 102 and 202 of FIG. X1 and the block 1060 may be implemented by the transceivers 106 and 206 of FIG. X1.

Codewords may be converted into radio signals via the signal processing circuit 1000 of FIG. X2. Herein, the codewords are encoded bit sequences of information blocks. The information blocks may include transport blocks (e.g., a UL-SCH transport block, a DL-SCH transport block). The radio signals may be transmitted through various physical channels (e.g., a PUSCH and a PDSCH).

Specifically, the codewords may be converted into scrambled bit sequences by the scramblers 1010. Scramble sequences used for scrambling may be generated based on an initialization value, and the initialization value may include ID information of a wireless device. The scrambled bit sequences may be modulated to modulation symbol sequences by the modulators 1020. A modulation scheme may include pi/2-Binary Phase Shift Keying (pi/2-BPSK), m-Phase Shift Keying (m-PSK), and m-Quadrature Amplitude Modulation (m-QAM). Complex modulation symbol sequences may be mapped to one or more transport layers by the layer mapper 1030. Modulation symbols of each transport layer may be mapped (precoded) to corresponding antenna port(s) by the precoder 1040. Outputs z of the precoder 1040 may be obtained by multiplying outputs y of the layer mapper 1030 by an N*M precoding matrix W. Herein, N is the number of antenna ports and M is the number of transport layers. The precoder 1040 may perform precoding after performing transform precoding (e.g., DFT) for complex modulation symbols. Alternatively, the precoder 1040 may perform precoding without performing transform precoding.

The resource mappers 1050 may map modulation symbols of each antenna port to time-frequency resources. The time-frequency resources may include a plurality of symbols (e.g., a CP-OFDMA symbols and DFT-s-OFDMA symbols) in the time domain and a plurality of subcarriers in the frequency domain. The signal generators 1060 may generate radio signals from the mapped modulation symbols and the generated radio signals may be transmitted to other devices through each antenna. For this purpose, the signal generators 1060 may include Inverse Fast Fourier Transform (IFFT) modules, Cyclic Prefix (CP) inserters, Digital-to-Analog Converters (DACs), and frequency up-converters.

Signal processing procedures for a signal received in the wireless device may be configured in a reverse manner of the signal processing procedures 1010 to 1060 of FIG. X2. For example, the wireless devices (e.g., 100 and 200 of FIG. X1) may receive radio signals from the exterior through the antenna ports/transceivers. The received radio signals may be converted into baseband signals through signal restorers. To this end, the signal restorers may include frequency downlink converters, Analog-to-Digital Converters (ADCs), CP remover, and Fast Fourier Transform (FFT) modules. Next, the baseband signals may be restored to codewords through a resource demapping procedure, a postcoding procedure, a demodulation processor, and a descrambling procedure. The codewords may be restored to original information blocks through decoding. Therefore, a signal processing circuit (not illustrated) for a reception signal may include signal restorers, resource demappers, a postcoder, demodulators, descramblers, and decoders.

4. Example of an Application of a Wireless Device to which the Present Disclosure is Applied

FIG. X3 illustrates another example of a wireless device applied to the present disclosure. The wireless device may be implemented in various forms according to a use-case/service (refer to FIG. W1 and FIGS. X4 to X9).

Referring to FIG. X3, wireless devices 100 and 200 may correspond to the wireless devices 100 and 200 of FIG. X1 and may be configured by various elements, components, units/portions, and/or modules. For example, each of the wireless devices 100 and 200 may include a communication unit 110, a control unit 120, a memory unit 130, and additional components 140. The communication unit may include a communication circuit 112 and transceiver(s) 114. For example, the communication circuit 112 may include the one or more processors 102 and 202 and/or the one or more memories 104 and 204 of FIG. X1. For example, the transceiver(s) 114 may include the one or more transceivers 106 and 206 and/or the one or more antennas 108 and 208 of FIG. X1. The control unit 120 is electrically connected to the communication unit 110, the memory 130, and the additional components 140 and controls overall operation of the wireless devices. For example, the control unit 120 may control an electric/mechanical operation of the wireless device based on programs/code/commands/information stored in the memory unit 130. The control unit 120 may transmit the information stored in the memory unit 130 to the exterior (e.g., other communication devices) via the communication unit 110 through a wireless/wired interface or store, in the memory unit 130, information received through the wireless/wired interface from the exterior (e.g., other communication devices) via the communication unit 110.

The additional components 140 may be variously configured according to types of wireless devices. For example, the additional components 140 may include at least one of a power unit/battery, input/output (I/O) unit, a driving unit, and a computing unit. The wireless device may be implemented in the form of, without being limited to, the robot (100a of FIG. W1), the vehicles (100b-1 and 100b-2 of FIG. W1), the XR device (100c of FIG. W1), the hand-held device (100d of FIG. W1), the home appliance (100e of FIG. W1), the IoT device (100f of FIG. W1), a digital broadcast terminal, a hologram device, a public safety device, an MTC device, a medicine device, a fintech device (or a finance device), a security device, a climate/environment device, the AI server/device (400 of FIG. W1), the BSs (200 of FIG. W1), a network node, etc. The wireless device may be used in a mobile or fixed place according to a use-example/service.

In FIG. X3, the entirety of the various elements, components, units/portions, and/or modules in the wireless devices 100 and 200 may be connected to each other through a wired interface or at least a part thereof may be wirelessly connected through the communication unit 110. For example, in each of the wireless devices 100 and 200, the control unit 120 and the communication unit 110 may be connected by wire and the control unit 120 and first units (e.g., 130 and 140) may be wirelessly connected through the communication unit 110. Each element, component, unit/portion, and/or module within the wireless devices 100 and 200 may further include one or more elements. For example, the control unit 120 may be configured by a set of one or more processors. As an example, the control unit 120 may be configured by a set of a communication control processor, an application processor, an Electronic Control Unit (ECU), a graphical processing unit, and a memory control processor. As another example, the memory 130 may be configured by a Random Access Memory (RAM), a Dynamic RAM (DRAM), a Read Only Memory (ROM)), a flash memory, a volatile memory, a non-volatile memory, and/or a combination thereof.

Hereinafter, an example of implementing FIG. X3 will be described in detail with reference to the drawings.

5. Example of a Hand-Held Device to which the Present Disclosure is Applied

FIG. X4 illustrates a hand-held device applied to the present disclosure. The hand-held device may include a smartphone, a smartpad, a wearable device (e.g., a smartwatch or a smartglasses), or a portable computer (e.g., a notebook). The hand-held device may be referred to as a mobile station (MS), a user terminal (UT), a Mobile Subscriber Station (MSS), a Subscriber Station (SS), an Advanced Mobile Station (AMS), or a Wireless Terminal (WT).

Referring to FIG. X4, a hand-held device 100 may include an antenna unit 108, a communication unit 110, a control unit 120, a memory unit 130, a power supply unit 140a, an interface unit 140b, and an I/O unit 140c. The antenna unit 108 may be configured as a part of the communication unit 110. Blocks 110 to 130/140a to 140c correspond to the blocks 110 to 130/140 of FIG. X3, respectively.

The communication unit 110 may transmit and receive signals (e.g., data and control signals) to and from other wireless devices or BSs. The control unit 120 may perform various operations by controlling constituent elements of the hand-held device 100. The control unit 120 may include an Application Processor (AP). The memory unit 130 may store data/parameters/programs/code/commands needed to drive the hand-held device 100. The memory unit 130 may store input/output data/information. The power supply unit 140a may supply power to the hand-held device 100 and include a wired/wireless charging circuit, a battery, etc. The interface unit 140b may support connection of the hand-held device 100 to other external devices. The interface unit 140b may include various ports (e.g., an audio I/O port and a video I/O port) for connection with external devices. The I/O unit 140c may input or output video information/signals, audio information/signals, data, and/or information input by a user. The I/O unit 140c may include a camera, a microphone, a user input unit, a display unit 140d, a speaker, and/or a haptic module.

As an example, in the case of data communication, the I/O unit 140c may acquire information/signals (e.g., touch, text, voice, images, or video) input by a user and the acquired information/signals may be stored in the memory unit 130. The communication unit 110 may convert the information/signals stored in the memory into radio signals and transmit the converted radio signals to other wireless devices directly or to a BS. The communication unit 110 may receive radio signals from other wireless devices or the BS and then restore the received radio signals into original information/signals. The restored information/signals may be stored in the memory unit 130 and may be output as various types (e.g., text, voice, images, video, or haptic) through the I/O unit 140c.

6. Example of a Vehicle or an Autonomous Driving Vehicle to which the Present Disclosure is Applied

FIG. X5 illustrates a vehicle or an autonomous driving vehicle applied to the present disclosure. The vehicle or autonomous driving vehicle may be implemented by a mobile robot, a car, a train, a manned/unmanned Aerial Vehicle (AV), a ship, etc.

Referring to FIG. X5, a vehicle or autonomous driving vehicle 100 may include an antenna unit 108, a communication unit 110, a control unit 120, a driving unit 140a, a power supply unit 140b, a sensor unit 140c, and an autonomous driving unit 140d. The antenna unit 108 may be configured as a part of the communication unit 110. The blocks 110/130/140a to 140d correspond to the blocks 110/130/140 of FIG. X3, respectively.

The communication unit 110 may transmit and receive signals (e.g., data and control signals) to and from external devices such as other vehicles, BSs (e.g., gNBs and road side units), and servers. The control unit 120 may perform various operations by controlling elements of the vehicle or the autonomous driving vehicle 100. The control unit 120 may include an Electronic Control Unit (ECU). The driving unit 140a may cause the vehicle or the autonomous driving vehicle 100 to drive on a road. The driving unit 140a may include an engine, a motor, a powertrain, a wheel, a brake, a steering device, etc. The power supply unit 140b may supply power to the vehicle or the autonomous driving vehicle 100 and include a wired/wireless charging circuit, a battery, etc. The sensor unit 140c may acquire a vehicle state, ambient environment information, user information, etc. The sensor unit 140c may include an Inertial Measurement Unit (IMU) sensor, a collision sensor, a wheel sensor, a speed sensor, a slope sensor, a weight sensor, a heading sensor, a position module, a vehicle forward/backward sensor, a battery sensor, a fuel sensor, a tire sensor, a steering sensor, a temperature sensor, a humidity sensor, an ultrasonic sensor, an illumination sensor, a pedal position sensor, etc. The autonomous driving unit 140d may implement technology for maintaining a lane on which a vehicle is driving, technology for automatically adjusting speed, such as adaptive cruise control, technology for autonomously driving along a determined path, technology for driving by automatically setting a path if a destination is set, and the like.

For example, the communication unit 110 may receive map data, traffic information data, etc. from an external server. The autonomous driving unit 140d may generate an autonomous driving path and a driving plan from the obtained data. The control unit 120 may control the driving unit 140a such that the vehicle or the autonomous driving vehicle 100 may move along the autonomous driving path according to the driving plan (e.g., speed/direction control). In the middle of autonomous driving, the communication unit 110 may aperiodically/periodically acquire recent traffic information data from the external server and acquire surrounding traffic information data from neighboring vehicles. In the middle of autonomous driving, the sensor unit 140c may obtain a vehicle state and/or surrounding environment information. The autonomous driving unit 140d may update the autonomous driving path and the driving plan based on the newly obtained data/information. The communication unit 110 may transfer information about a vehicle position, the autonomous driving path, and/or the driving plan to the external server. The external server may predict traffic information data using AI technology, etc., based on the information collected from vehicles or autonomous driving vehicles and provide the predicted traffic information data to the vehicles or the autonomous driving vehicles.

7. Example of AR/VR and Vehicle to which the Present Disclosure is Applied

FIG. X6 illustrates a vehicle applied to the present disclosure. The vehicle may be implemented as a transport means, an aerial vehicle, a ship, etc.

Referring to FIG. X6, a vehicle 100 may include a communication unit 110, a control unit 120, a memory unit 130, an I/O unit 140a, and a positioning unit 140b. Herein, the blocks 110 to 130/140a and 140b correspond to blocks 110 to 130/140 of FIG. X3.

The communication unit 110 may transmit and receive signals (e.g., data and control signals) to and from external devices such as other vehicles or BSs. The control unit 120 may perform various operations by controlling constituent elements of the vehicle 100. The memory unit 130 may store data/parameters/programs/code/commands for supporting various functions of the vehicle 100. The I/O unit 140a may output an AR/VR object based on information within the memory unit 130. The I/O unit 140a may include an HUD. The positioning unit 140b may acquire information about the position of the vehicle 100. The position information may include information about an absolute position of the vehicle 100, information about the position of the vehicle 100 within a traveling lane, acceleration information, and information about the position of the vehicle 100 from a neighboring vehicle. The positioning unit 140b may include a GPS and various sensors.

As an example, the communication unit 110 of the vehicle 100 may receive map information and traffic information from an external server and store the received information in the memory unit 130. The positioning unit 140b may obtain the vehicle position information through the GPS and various sensors and store the obtained information in the memory unit 130. The control unit 120 may generate a virtual object based on the map information, traffic information, and vehicle position information and the I/O unit 140a may display the generated virtual object in a window in the vehicle (1410 and 1420). The control unit 120 may determine whether the vehicle 100 normally drives within a traveling lane, based on the vehicle position information. If the vehicle 100 abnormally exits from the traveling lane, the control unit 120 may display a warning on the window in the vehicle through the I/O unit 140a. In addition, the control unit 120 may broadcast a warning message regarding driving abnormity to neighboring vehicles through the communication unit 110. According to situation, the control unit 120 may transmit the vehicle position information and the information about driving/vehicle abnormality to related organizations.

8. Example of an XR Device to which the Present Disclosure is Applied

FIG. X7 illustrates an XR device applied to the present disclosure. The XR device may be implemented by an HMD, an HUD mounted in a vehicle, a television, a smartphone, a computer, a wearable device, a home appliance, a digital signage, a vehicle, a robot, etc.

Referring to FIG. X7, an XR device 100a may include a communication unit 110, a control unit 120, a memory unit 130, an I/O unit 140a, a sensor unit 140b, and a power supply unit 140c. Herein, the blocks 110 to 130/140a to 140c correspond to the blocks 110 to 130/140 of FIG. X3, respectively.

The communication unit 110 may transmit and receive signals (e.g., media data and control signals) to and from external devices such as other wireless devices, hand-held devices, or media servers. The media data may include video, images, and sound. The control unit 120 may perform various operations by controlling constituent elements of the XR device 100a. For example, the control unit 120 may be configured to control and/or perform procedures such as video/image acquisition, (video/image) encoding, and metadata generation and processing. The memory unit 130 may store data/parameters/programs/code/commands needed to drive the XR device 100a/generate XR object. The I/O unit 140a may obtain control information and data from the exterior and output the generated XR object. The I/O unit 140a may include a camera, a microphone, a user input unit, a display unit, a speaker, and/or a haptic module. The sensor unit 140b may obtain an XR device state, surrounding environment information, user information, etc. The sensor unit 140b may include a proximity sensor, an illumination sensor, an acceleration sensor, a magnetic sensor, a gyro sensor, an inertial sensor, an RGB sensor, an IR sensor, a fingerprint recognition sensor, an ultrasonic sensor, a light sensor, a microphone and/or a radar. The power supply unit 140c may supply power to the XR device 100a and include a wired/wireless charging circuit, a battery, etc.

For example, the memory unit 130 of the XR device 100a may include information (e.g., data) needed to generate the XR object (e.g., an AR/VR/MR object). The I/O unit 140a may receive a command for manipulating the XR device 100a from a user and the control unit 120 may drive the XR device 100a according to a driving command of a user. For example, when a user desires to watch a film or news through the XR device 100a, the control unit 120 transmits content request information to another device (e.g., a hand-held device 100b) or a media server through the communication unit 130. The communication unit 130 may download/stream content such as films or news from another device (e.g., the hand-held device 100b) or the media server to the memory unit 130. The control unit 120 may control and/or perform procedures such as video/image acquisition, (video/image) encoding, and metadata generation/processing with respect to the content and generate/output the XR object based on information about a surrounding space or a real object obtained through the I/O unit 140a/sensor unit 140b.

The XR device 100a may be wirelessly connected to the hand-held device 100b through the communication unit 110 and the operation of the XR device 100a may be controlled by the hand-held device 100b. For example, the hand-held device 100b may operate as a controller of the XR device 100a. To this end, the XR device 100a may obtain information about a 3D position of the hand-held device 100b and generate and output an XR object corresponding to the hand-held device 100b.

9. Example of a Robot to which the Present Disclosure is Applied

FIG. X8 illustrates a robot applied to the present disclosure. The robot may be categorized into an industrial robot, a medical robot, a household robot, a military robot, etc., according to a used purpose or field.

Referring to FIG. X8, a robot 100 may include a communication unit 110, a control unit 120, a memory unit 130, an I/O unit 140a, a sensor unit 140b, and a driving unit 140c. Herein, the blocks 110 to 130/140a to 140c correspond to the blocks 110 to 130/140 of FIG. X3, respectively.

The communication unit 110 may transmit and receive signals (e.g., driving information and control signals) to and from external devices such as other wireless devices, other robots, or control servers. The control unit 120 may perform various operations by controlling constituent elements of the robot 100. The memory unit 130 may store data/parameters/programs/code/commands for supporting various functions of the robot 100. The I/O unit 140a may obtain information from the exterior of the robot 100 and output information to the exterior of the robot 100. The I/O unit 140a may include a camera, a microphone, a user input unit, a display unit, a speaker, and/or a haptic module. The sensor unit 140b may obtain internal information of the robot 100, surrounding environment information, user information, etc. The sensor unit 140b may include a proximity sensor, an illumination sensor, an acceleration sensor, a magnetic sensor, a gyro sensor, an inertial sensor, an IR sensor, a fingerprint recognition sensor, an ultrasonic sensor, a light sensor, a microphone, a radar, etc. The driving unit 140c may perform various physical operations such as movement of robot joints. In addition, the driving unit 140c may cause the robot 100 to travel on the road or to fly. The driving unit 140c may include an actuator, a motor, a wheel, a brake, a propeller, etc.

10. Example of an AI Device to which the Present Disclosure is Applied

FIG. X9 illustrates an AI device applied to the present disclosure. The AI device may be implemented by a fixed device or a mobile device, such as a TV, a projector, a smartphone, a PC, a notebook, a digital broadcast terminal, a tablet PC, a wearable device, a Set Top Box (STB), a radio, a washing machine, a refrigerator, a digital signage, a robot, a vehicle, etc.

Referring to FIG. X9, an AI device 100 may include a communication unit 110, a control unit 120, a memory unit 130, an I/O unit 140a/140b, a learning processor unit 140c, and a sensor unit 140d. The blocks 110 to 130/140a to 140d correspond to blocks 110 to 130/140 of FIG. X3, respectively.

The communication unit 110 may transmit and receive wired/radio signals (e.g., sensor information, user input, learning models, or control signals) to and from external devices such as other AI devices (e.g., 100x, 200, or 400 of FIG. W1) or an AI server (e.g., 400 of FIG. W1) using wired/wireless communication technology. To this end, the communication unit 110 may transmit information within the memory unit 130 to an external device and transmit a signal received from the external device to the memory unit 130.

The control unit 120 may determine at least one feasible operation of the AI device 100, based on information which is determined or generated using a data analysis algorithm or a machine learning algorithm. The control unit 120 may perform an operation determined by controlling constituent elements of the AI device 100. For example, the control unit 120 may request, search, receive, or use data of the learning processor unit 140c or the memory unit 130 and control the constituent elements of the AI device 100 to perform a predicted operation or an operation determined to be preferred among at least one feasible operation. The control unit 120 may collect history information including the operation contents of the AI device 100 and operation feedback by a user and store the collected information in the memory unit 130 or the learning processor unit 140c or transmit the collected information to an external device such as an AI server (400 of FIG. W1). The collected history information may be used to update a learning model.

The memory unit 130 may store data for supporting various functions of the AI device 100. For example, the memory unit 130 may store data obtained from the input unit 140a, data obtained from the communication unit 110, output data of the learning processor unit 140c, and data obtained from the sensor unit 140. The memory unit 130 may store control information and/or software code needed to operate/drive the control unit 120.

The input unit 140a may acquire various types of data from the exterior of the AI device 100. For example, the input unit 140a may acquire learning data for model learning, and input data to which the learning model is to be applied. The input unit 140a may include a camera, a microphone, and/or a user input unit. The output unit 140b may generate output related to a visual, auditory, or tactile sense. The output unit 140b may include a display unit, a speaker, and/or a haptic module. The sensing unit 140 may obtain at least one of internal information of the AI device 100, surrounding environment information of the AI device 100, and user information, using various sensors. The sensor unit 140 may include a proximity sensor, an illumination sensor, an acceleration sensor, a magnetic sensor, a gyro sensor, an inertial sensor, an RGB sensor, an IR sensor, a fingerprint recognition sensor, an ultrasonic sensor, a light sensor, a microphone, and/or a radar.

The learning processor unit 140c may learn a model consisting of artificial neural networks, using learning data. The learning processor unit 140c may perform AI processing together with the learning processor unit of the AI server (400 of FIG. W1). The learning processor unit 140c may process information received from an external device through the communication unit 110 and/or information stored in the memory unit 130. In addition, an output value of the learning processor unit 140c may be transmitted to the external device through the communication unit 110 and may be stored in the memory unit 130.

It is obvious to those skilled in the art that the present specification can be embodied in other specific forms without departing from the characteristics of the present specification. Accordingly, the above detailed description should not be construed as restrictive in all respects and should be considered illustrative. The scope of this specification should be determined by reasonable interpretation of the appended claims, and all changes within the equivalent scope of this specification are included in the scope of this specification.

1. A method comprising:
receiving, by a user equipment (UE), a Random Access CHannel (RACH) configuration; and
transmitting, by the UE, a random access preamble based on a Random Access (RA)-Radio Network Temporary Identifier (RNTI),
wherein the RA-RNTI is determined based on i) a first index related to a time domain of a Physical Random Access CHannel (PRACH) occasion, and ii) a second index related to a frequency domain of the PRACH occasion,
wherein the RACH configuration is based on an additional RACH configuration, and
wherein the first index or the second index is determined based on the additional RACH configuration.

2. The method of claim 1, wherein the first index is related to an Orthogonal Frequency Division Multiplexing (OFDM) symbol index and the second index is related to an index of the PRACH occasion in the frequency domain.

3. The method of claim 2, wherein the additional RACH configuration includes information for an offset.

4. The method of claim 3, wherein the second index is determined based on (i) the index of the PRACH occasion and (ii) the offset.

5. The method of claim 3, wherein the index of the PRACH occasion is determined based on the offset.

6. The method of claim 2, wherein the information for the OFDM symbol index is configured based on the additional RACH configuration or a System Information Block (SIB).

7. The method of claim 2, wherein the OFDM symbol index is predefined for the additional RACH configuration.

8. The method of claim 7, wherein the OFDM symbol index is based on a defined symbol among symbols based on the PRACH occasion.

9. The method of claim 8, wherein the defined symbol is an N-th symbol or a last symbol among the symbols based on the PRACH occasion.

10. The method of claim 1, wherein the PRACH occasion is a last PRACH occasion among PRACH occasions based on a repetition number.

11. The method of claim 1, further comprising:
receiving Downlink Control Information (DCI) related to a Random Access Response (RAR),
wherein a Cyclic Redundancy Check (CRC) related to the DCI is scrambled by the RA-RNTI.

12. A user equipment (UE) comprising:
one or more transceivers;
one or more processors; and
one or more memories connected to the one or more processors and storing instructions,
wherein the instructions, based on being executed by the one or more processors, configure the one or more processors to perform operations comprising:
receiving a Random Access CHannel (RACH) configuration; and
transmitting a random access preamble based on a Random Access (RA)-Radio Network Temporary Identifier (RNTI),
wherein the RA-RNTI is determined based on i) a first index related to a time domain of a Physical Random Access CHannel (PRACH) occasion, and ii) a second index related to a frequency domain of the PRACH occasion,
wherein the RACH configuration is based on an additional RACH configuration, and
wherein the first index or the second index is determined based on the additional RACH configuration.

13. (canceled)

14. (canceled)

15. (canceled)

16. A base station comprising:
one or more transceivers;
one or more processors; and
one or more memories connected to the one or more processors and storing instructions,
wherein the instructions, based on being executed by the one or more processors, configure the one or more processors to perform operations comprising:
transmitting a Random Access CHannel (RACH) configuration; and
receiving a random access preamble based on a Random Access (RA)-Radio Network Temporary Identifier (RNTI),
wherein the RA-RNTI is determined based on i) a first index related to a time domain of a Physical Random Access CHannel (PRACH) occasion, and ii) a second index related to a frequency domain of the PRACH occasion,
wherein the RACH configuration is based on an additional RACH configuration, and
wherein the first index or the second index is determined based on the additional RACH configuration.
